(19) United States
(12) Patent Application Publication
(10) Pub. No.: US 2010/0320086 A1
(43) Pub. Date: Dec. 23, 2010

(54) FLEXIBLE BIOSENSOR AND MANUFACTURING METHOD FOR THE SAME

(75) Inventors: Keonjae LEE, Daejeon (KR); Sang Yong LEE, Daejeon (KR); Seung Jun KIM, Daejeon (KR); Hyeon Kyun YOO, Daejeon (KR); Seok Jae LEE, Daejeon (KR); Chi Won AHN, Daejeon (KR); Jae Hong PARK, Daejeon (KR); Tae Jung PARK, Daejeon (KR); Sang Yup LEE, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: KAIST (Korea Advanced Institute of Science and Technology), Daejeon (KR)

(21) Appl. No.: 12/779,705

(22) Filed: May 13, 2010

(30) Foreign Application Priority Data
May 13, 2009 (KR) 10-2009-0041469
Apr. 21, 2010 (KR) 10-2010-0036649
Apr. 21, 2010 (KR) 10-2010-0036650
Apr. 21, 2010 (KR) 10-2010-0036651

(51) Int. Cl. G01N 27/26; B05D 5/12

(52) U.S. Cl. 204/403.01; 427/2.13

(57) ABSTRACT

Provided are a flexible biosensor using a gold binding substance and a method for manufacturing the same.

The flexible biosensor includes: a flexible substrate; a silicon substrate which is formed on the flexible substrate and on which source and drain regions doped with a first type impurity are formed with a predetermined gap; and source, drain and gate electrodes which are formed on the silicon substrate and comprise gold, wherein, on the gate electrode, a fused protein which is formed by fusion with a gold binding substance specifically binding to gold is immobilized. Since the biosensor is embodied on a flexible substrate, it may effectively overcome the limitation of the existing biosensor embodied on a silicon substrate.

### CROSS-REFERENCE TO RELATED APPLICATIONS

This application claims priority under 35 U.S.C. §119 to Korean Patent Application No. 10-2009-0041469 (filed on May 13, 2009), Korean Patent Application No. 10-2010-0036649 (filed on Apr. 21, 2010) Korean Patent Application No. 10-2010-0036650 (filed on Apr. 21, 2010) and Korean Patent Application No. 10-2010-0036651 (filed on Apr. 21, 2010)in the Korean Intellectual Property Office, the disclosure of which is incorporated herein by reference in its entirety.

### TECHNICAL FIELD

The following disclosure relates to a flexible biosensor and a method for manufacturing the same. More particularly, the following disclosure relates to a flexible biosensor which is embodied on a flexible substrate, thus being capable of effectively overcoming the limitation of existing biosensor embodied on a silicon substrate, and is capable of specifically binding a desired biologically active substance to an electrode pad without special pretreatment of the electrode pad, thus being superior in economy and applicability, and a method for manufacturing the same.

### BACKGROUND

Living organisms including human have various sense organs to sense a variety of stimulations from outside, including pain and heat, as well as sight, hearing, touch, smell and taste. The sensed stimulation is compared in the brain with the previously experienced stimulation information to recognize change in taste, flavor, or the like. Such a function performed by the sense organs in living organisms is covered by sensors in machines or apparatuses. An electronic biodevice capable of detecting physicochemical stimuli from outside by simulating the biological function is commonly called a biosensor.

However, since the existing biosensor is prepared on a microarray or a microfluidic channel formed on a hard substrate such as a silicon substrate, it is difficult to manufacture sensors with various structures. To overcome this limitation, Lieber et al. proposed the so-called bottom-up type sensing device manufacture method, whereby silicon nanowire is grown on a substrate using a catalyst. However, the bottom-up sensing device is associated with the problems of degraded semiconductor device performance and uniformity because the nanowire has to be grown directly on the substrate [Nature Biotechnology, Vol. 23, 1294, 2005].

In order to resolve the shortcoming of the bottom-up type sensing device manufacture method, McAlpine et al. disclosed a chemical sensor wherein a nanowire is formed on a plastic substrate by a top-down process utilizing a microstructure semiconductor (μ-Sc) technique [Nature Materials, Vol. 6, May 2007) . However, this method relates to detection of gas components and is difficult to be applied as a biosensor for detect in water or other solvents. Further, a plurality of sensors have to be provided to detect more than one substance.

Hence, a new-concept, flexible, highly sensitive biosensor, particularly a semiconductor sensor, which is embodied on a flexible substrate and capable of very effectively sensing a plurality of substances using a high-performance semiconductor device, needs to be developed. It is considered that the harsh condition of the semiconductor manufacture process is hardly compatible with the weak heat resistance, chemical resistance, etc. of the flexible substrate (usually made of polymer material) and biomaterials. As such, a biodevice embodied on a flexible substrate, particularly one using a semiconductor, is not disclosed as yet. In addition, a biosensor using various metals requires a chemical pretreatment process for binding active substances (e.g., protein or peptide) onto a chip electrode. However, the associated process is difficult to be put into practical use for protein-protein interaction assay because it is complicated, nonspecific binding with proteins may occur, the binding to the electrode is weak, and the process may be influenced by various chemical substances. Moreover, if the chemical process is performed on a flexible substrate such as plastic, the substrate itself may be badly affected.

### SUMMARY

Accordingly, an embodiment of the present invention is directed to providing a flexible biosensor capable of effectively detecting a desired biologically active substance without a special pretreatment process.

Another embodiment of the present invention is directed to providing a method for preparing a flexible biosensor in an economical way, without a pretreatment process.

In one general aspect, the present invention provides a flexible biosensor including: a flexible substrate; and a biosensor which is provided on the flexible substrate and on which a biologically active substance is immobilized, wherein the biosensor comprises source, gate and drain electrodes and the biologically active substance is immobilized on the gate electrode.

The biosensor the biosensor may include: a flexible substrate; a silicon substrate formed on the flexible substrate; source, gate and drain electrodes formed on the silicon substrate; and a biologically active substance immobilized on the gate electrode, wherein the silicon substrate is transferred onto the flexible substrate, after source and drain regions corresponding to the source and drain electrodes are formed, and then the source and gate electrodes are formed on the transferred silicon substrate, and the biologically active substance is immobilized on the gate electrode.

The biosensor may include: a flexible substrate; and a biosensor pad provided on the flexible substrate, wherein the biosensor includes a silicon substrate provided on the flexible substrate; source and drain regions which are formed by injecting a p-type or n-type impurity to the silicon substrate and are spaced with a predetermined gap; source and drain electrodes which are respectively connected to the source and drain regions; a gate oxide film and a gate electrode which are formed sequentially on the silicon substrate between the source and drain regions; and a current detecting pad which extends from the source and drain electrodes and detects change of electrical current. The flexible biosensor may further include a flexible polymer layer formed on one or more of the biosensor, wherein the flexible polymer layer is provided with a microfluidic channel, so that a substance to be detected flows to the gate electrode through the microfluidic channel. The flexible polymer layer may be formed of polydimethylsiloxane (PDMS).

In another embodiment of the present invention, the biosensor may include: a flexible substrate; a silicon substrate which is formed on the flexible substrate and on which source and drain regions doped with a first type impurity are formed with a predetermined gap; and source, drain and gate electrodes which are formed on the silicon substrate and formed of gold, wherein, on the gate electrode, a fused protein which is formed by fusion with a gold binding substance specifically binding to gold is immobilized. Further, there is provided a flexible biosensor including: a flexible substrate; a silicon substrate which is formed on the flexible substrate; source, gate and drain electrodes formed on the silicon substrate; and a biologically active substance immobilized on the gate electrode, wherein the silicon substrate is transferred onto the flexible substrate, after source and drain regions corresponding to the source and drain electrodes are formed, and then the source, gate and drain electrodes are formed on the transferred silicon substrate, and the biologically active substance is immobilized on the gate electrode which comprises gold, wherein the biologically active substance is a fused protein which is formed by fusion with a gold binding substance specifically binding to gold.

Further, there is provided a flexible biosensor including: a flexible substrate; and a biosensor provided on the flexible substrate, wherein the biosensor includes a silicon substrate provided on the flexible substrate; source and drain regions which are formed by injecting a p-type or n-type impurity to the silicon substrate and are spaced with a predetermined gap; source and drain electrodes which are respectively connected to the source and drain regions; a gate oxide film and a gate electrode which are formed sequentially on the silicon substrate between the source and drain regions; and a current detecting pad which extends from the source and drain electrodes and detects change of electrical current, wherein the gate electrode is formed of gold and the biologically active substance is a fused protein which is formed by fusion with a gold binding substance specifically binding to gold. In an embodiment of the present invention, the gold binding substance is gold binding protein (GBP), and the fused protein is pulverized and then isolated after being expressed in a transformed cell. The biologically active substance may be an antibody or an antigen. The flexible biosensor may further include a flexible polymer layer formed on one or more of the biosensor, wherein the flexible polymer layer is provided with a microfluidic channel, so that a substance to be detected flows to the gate electrode through the microfluidic channel. The flexible polymer layer may be formed of PDMS.

In another embodiment of the present invention, there is provided a flexible biosensor including: a flexible lower substrate; a silicon upper substrate which is in contact with the upper portion of the flexible lower substrate and on which source and drain regions are formed with a predetermined gap; and a microfluidic channel which passes through the silicon substrate between the source and drain regions, wherein, a target substance is detected by flowing a biologically active substance through the microfluidic channel. The flexible lower substrate may include: a flexible substrate; a gate electrode provided on the flexible substrate; and an insulating layer formed on the gate electrode, wherein the gate electrode faces the silicon substrate between the source and drain regions. The source and drain regions of the silicon upper substrate are respectively connected to source and drain electrodes. The flexible biosensor may further include: a passivation layer which is formed on the silicon upper substrate and the source and drain electrodes and partly exposes the substrate between the source and drain regions; and a cover layer which is formed on the passivation layer. On the silicon substrate through which the microfluidic channel passes, a detecting substance formed by fusion with a protein specifically binding to silicon is bound. The target substance may be an antigen or an antibody. The silicon substrate is manufactured on a silicon on insulator (SOI) substrate and then transferred onto the flexible substrate.

The present invention also provides a flexible biosensor wherein a biologically active substance is immobilized on the substrate between the source and drain regions. The biologically active substance may include a silicon binding substance.

The biosensor may be manufactured by a process including: forming a gate oxide film on the silicon substrate transferred onto the flexible substrate, and then performing patterning; depositing a metal layer on thus patterned gate oxide film and the silicon substrate; patterning the deposited metal layer to form source, gate and drain electrodes; forming a first microfluidic channel that passes through the gate electrode of silicon substrate; flowing a biologically active substance through the microfluidic channel to immobilize the biologically active substance on the gate electrode; and preparing a polymer layer provided with a second microfluidic channel that passes through the gate electrode and then forming it on the gate electrode, wherein the gate electrode is formed of gold and the biologically active substance is a fused protein formed by fusion with a gold binding substance.

One or more of the biosensor may be provided on the flexible substrate. The second microfluidic channel passes through the gate electrode of the one or more of the biosensor at the same time. The fused protein is expressed in a transformed cell, and then pulverized and isolated.

The present invention further provides a method for manufacturing a flexible biosensor, including: forming a biodevice region including source and drain regions spaced with a predetermined gap on a silicon upper substrate of an SOI substrate including a bulk silicon layer, an oxide layer and the silicon upper substrate; separating the biodevice region from the bulk silicon layer by removing the oxide layer below the biodevice region; and transferring the separated biodevice onto a flexible substrate. The flexible biosensor may include: a flexible lower substrate; agate electrode provided on the flexible substrate; and an adhesion layer formed on the gate electrode and the flexible substrate, wherein the gate electrode faces the biodevice region between the source and drain regions. The method for manufacturing a flexible biosensor may further include, following the transfer: forming source and gate electrodes connected to the source and drain regions of the silicon substrate; forming a passivation layer with a trench structure exposing the silicon substrate regions between the source and gate electrodes on the source and gate electrodes; and forming a cover layer on the passivation layer.

The trench structure may be a microfluidic channel extending over a predetermined length.

In another general aspect, the present invention provides a method for manufacturing a biosensor, including: forming source and drain regions on a region of a silicon substrate where a biosensor is to be manufactured; forming an insulating film on the silicon substrate, and then masking the region of the silicon substrate where a biosensor is to be manufactured with the insulating film by patterning; separating the silicon substrate at the region where a biosensor is to be manufactured from a silicon substrate therebelow; and manufacturing a biosensor including a gate electrode formed of gold on the separated silicon substrate.

The present invention further provides a method for manufacturing a biosensor, including: forming source and drain regions on a region of a silicon substrate where a biosensor is to be manufactured; forming an insulating film on the silicon substrate, and then masking the region of the silicon substrate where a biosensor is to be manufactured with the insulating film by patterning; performing first etching of the silicon substrate exposed between the insulating film; forming a spacer on the side surface of the silicon substrate exposed by the first etching; performing second etching of the silicon substrate exposed between the spacer; transferring the silicon substrate at the region where a biosensor is to be manufactured onto a flexible substrate; and manufacturing a biosensor on the transferred biosensor region. The biosensor may include a gate electrode formed of gold. The transfer may be selective transfer of all or part of the region of the silicon substrate where the biosensor is to be manufactured, and the second etching may be anisotropic etching.

In another embodiment of the present invention, there is provided a flexible biosensor including: a flexible lower substrate; a silicon substrate which is formed on the flexible lower substrate and on which source and drain regions doped with a first type impurity are formed with a predetermined gap; and source, drain and gate electrodes which are formed on the silicon substrate, wherein, on the gate electrode, a detecting substance which detects a biologically active substance is immobilized, and the silicon substrate is crystallized with laser. In another embodiment of the present invention, there is provided a flexible biosensor including: a flexible lower substrate; a silicon upper substrate which is in contact with the upper portion of the flexible lower substrate and on which source and drain regions are formed with a predetermined gap; and a microfluidic channel which passes through the silicon substrate between the source and drain regions, wherein, on the silicon substrate between the source and drain regions, a detecting substance which detects a biologically active substance is immobilized, and the silicon substrate is crystallized with laser. The source and drain regions are formed on the silicon substrate as the laser is irradiated to a doping layer doped with the first type impurity and then the first type impurity is diffused to the silicon substrate. The gate electrode may be formed of gold and the detecting substance may be a fused protein formed as a gold binding protein and a detecting protein are fused. The flexible biosensor may further include a microfluidic channel that passes through the gate electrode, and the detecting substance may be immobilized on the gate electrode by flowing the detecting substance through the microfluidic channel. The laser may be excimer laser and the first type impurity may be an n-type impurity. Detection using the biosensor may be performed by: flowing the target substance through the microfluidic channel which passes through the gate electrode on the silicon substrate; and detecting change of current in the biosensor caused by the binding between the target substance and the detecting substance. In another embodiment of the present invention, the detection using the biosensor may be performed by: flowing the target substance through the microfluidic channel between the source and drain regions; and detecting change of current in the biosensor caused by the binding between the target substance and the detecting substance. The microfluidic channel may pass through one or more of the gate electrode at the same time.

In another general aspect, the present invention provides a method for manufacturing a biosensor using laser, including: forming an amorphous first silicon layer on a flexible substrate; forming a doping layer doped with a first type impurity on the amorphous first silicon layer; forming a source and drain region doping layer spaced with a predetermined gap by patterning the doping layer; crystallizing the first silicon layer by irradiating laser to the first silicon layer and the source and drain region doping layer, and, at the same time, forming source and drain regions on the first silicon layer by diffusing an impurity of the doping layer to the first silicon layer threbelow; forming a silicon device substrate comprising the source and drain regions by patterning the first silicon layer; forming a gate oxide layer on the device substrate and exposing the source and drain regions by patterning; forming a metal layer on the gate oxide layer and forming source, gate and drain electrodes by patterning; and forming a microfluidic channel which passes through a gate electrode pad that extends from the gate electrode.

The present invention further provides a method for manufacturing a biosensor using laser, including: forming a lower gate electrode on a flexible substrate; forming an insulating layer on the lower gate electrode and the flexible substrate; forming an amorphous first silicon layer on the insulating layer; forming a doping layer doped with a first type impurity on the amorphous first silicon layer; forming a source and drain region doping layer spaced with a predetermined gap by patterning the doping layer; crystallizing the first silicon layer by irradiating laser to the first silicon layer and the source and drain region doping layer, and, at the same time, forming source and drain regions on the first silicon layer by diffusing an impurity of the doping layer to the first silicon layer threbelow; forming source and drain electrodes on the source and drain regions; and forming a microfluidic channel which passes through a silicon substrate between the source and drain regions.

A method for manufacturing a biosensor according to an embodiment of the present invention may further include: immobilizing a biologically active substance capable of specifically binding to the gate electrode on the gate electrode pad by flowing the biologically active substance through the microfluidic channel that passes through the gate electrode pad.

A method for manufacturing a biosensor according to another embodiment of the present invention may further include: immobilizing a biologically active substance capable of specifically binding to the silicon substrate on the silicon substrate by flowing the biologically active substance through the microfluidic channel that passes through the silicon substrate between the source and drain regions.

The first type impurity may be an n-type impurity, and the microfluidic channel may be formed by: forming a passivation layer on the silicon substrate and the source and drain electrodes, which exposes the silicon substrate between the source and drain electrodes; and forming a cover layer on the passivation layer. The cover layer may be provided with a hole which allows injection or discharge of a sample through the microfluidic channel.

Since the biosensor according to the present invention is embodied on a flexible substrate, it may effectively overcome the limitation of the existing biosensor embodied on a silicon substrate. And, the method for manufacturing a biosensor according to the present invention allows manufacturing of multiple biosensors using a large-area silicon substrate since only source and drain regions of a biosensor are on a silicon substrate and then separated from the silicon substrate. Further, by performing high-temperature doping, which is necessary for the manufacture of a high-performance semiconductor device, prior to transfer onto a plastic substrate, the high-performance semiconductor device can be embodied on a plastic biochip. And, the selective transfer allows easy manufacture of the wanted biosensor at low cost and in large scale. Moreover, since the basic structure of the biosensor is defined on the silicon substrate and then transferred to the flexible substrate, the resulting biosensor device has superior alignment. Since the biosensor according to the present invention detects a biomaterial on the plastic substrate using a high-performance microstructure semiconductor, it has a better sensitivity than the existing biosensor. Further, the biosensor according to the present invention is superior in economy and applicability since it allows specific binding of the wanted biologically active substance on an electrode pad without special pretreatment of the electrode pad. That is, when compared with the existing self-assembled monolayer (SAM)-based biomaterial immobilization technique, the present invention enables effective functionalization of the surface with a desired bioreceptor through a simple process without surface modification, while maintaining the alignment of the bioreceptor. In addition, the electrical detection-based, highly sensitive biosensor embodied on a transparent plastic substrate will allow conversion of biosignals into digital electrical signals, thereby improving compatibility with other data-processing devices, and provide many other advantages, including good portability, optical detection as well as electrical detection, reduction of production cost, or the like.

Other features and aspects will be apparent from the following detailed description, the drawings, and the claims.

### BRIEF DESCRIPTION OF THE DRAWINGS

### Detailed Description of Embodiments

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. All the attached drawings are plan views or partial cross-sectional views along line A-A′.

Hereinafter, exemplary embodiments will be described in detail with reference to the accompanying drawings.

As described above, the present invention provides a method for manufacturing a flexible biosensor comprising forming source and drain electrodes on a silicon substrate to define a biosensor region and then transferring the region to a flexible substrate, and a flexible biosensor manufactured thereby. The biosensor region (biosentor pad) may be separated from an Si (111) substrate and then transferred, or may be separated from a silicon on insulator (SOI) substrate and then transferred. In the present invention, the term “flexible substrate” refers to a substrate distinguished from a rigid substrate, e.g. a silicon substrate, and includes a bendable or foldable substrate, e.g. a plastic substrate.

Once the silicon substrate on which the source and drain regions formed thereon is transferred to the flexible substrate, the following process is performed on the flexible substrate. In particular, in the present invention, a microfluidic channel is formed on a gate electrode of the biosensor so as to immobilize a biologically active substance such as antibody. Further, by flowing a substance to be detected through another microfluidic channel, the voltage of the gate electrode on which the biologically active substance is immobilized is changed. In an embodiment of the present invention, the gate electrode is made of gold, and a specific protein such as antibody, antigen, etc. is fused with a gold binding protein (GBP), which specifically binds to gold, so that the resulting GBP-fused protein is specifically bound to the gold surface of the gate electrode. Subsequently, voltage change resulting from the specific binding between the gate electrode and the target substance via the GBP-fused protein is detected. In particular, in the present invention, high-temperature doping is first performed on the silicon substrate, and thus formed doping region is selectively transferred onto the flexible substrate. This allows fabrication of the flexible biosensor under a milder condition. As a result, the limitation of the existing technology, i.e. semiconductor process on the flexible substrate under a harsh condition, is effectively overcome.

### Examples

The method for manufacturing a flexible biosensor according to the present invention and the flexible biosensor manufactured thereby will be described in detail with reference to the attached drawings. Although the following description is made for manufacturing of a flexible biosensor on a (1,1,1) silicon substrate, as an example, the scope of the present invention is not limited thereto.

### Example 1

Fabrication of Biosensor

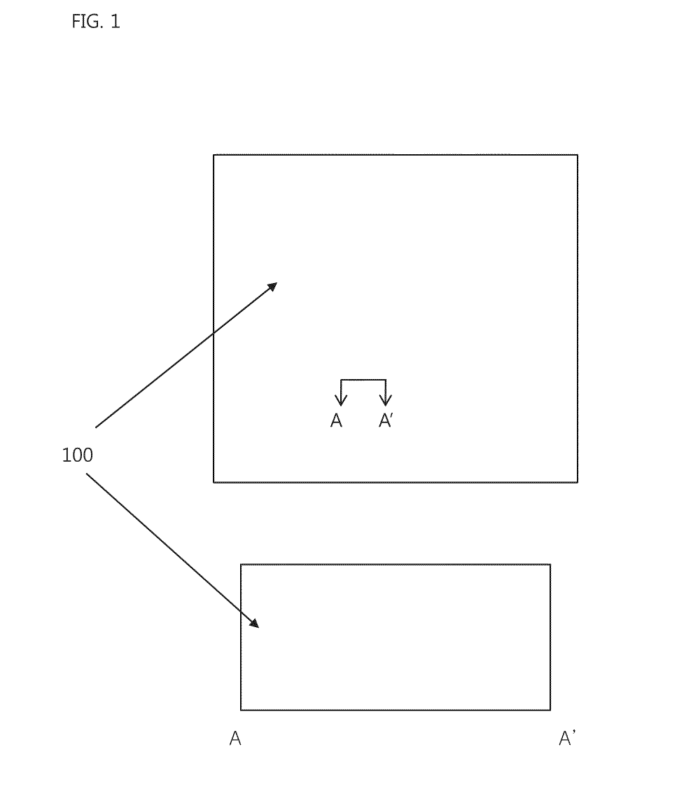

FIGS. 1 to 15 show a method for preparing a biosensor according to an embodiment of the present invention.

FIG. 1 shows a (1,1,1) silicon substrate 100 on which a biosensor is embodied in the present invention. In particular, in the present invention, in order to improve device alignment, which is particularly important in large-area applications, a basic region of a biosensor is defined on the silicon substrate, and transferred onto a flexible substrate. Then, the biosensor is manufactured on the defined silicon substrate. The processes of transfer and immobilization will be described in detail below.

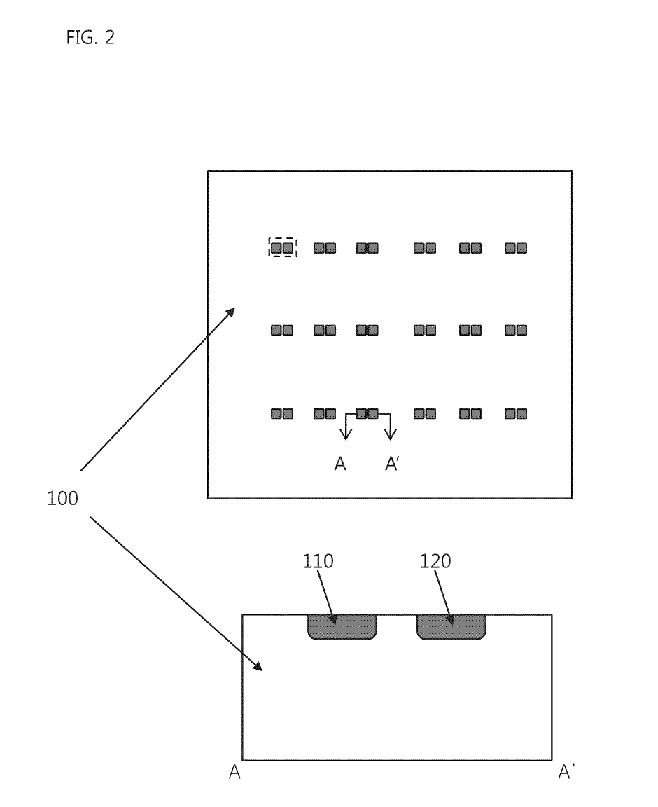

Referring to FIG. 2, in order to form source and drain regions 110, 120 on the silicon substrate 100, an impurity is injected to the silicon substrate 100. This process maybe performed by any method commonly used in the art. For example, it may be performed by ion implantation followed by rapid thermal processing (RTP) diffusion. As a result, a silicon substrate region on which the biosensor is manufactured (biosensor region) and other silicon substrate region (peripheral region) are defined.

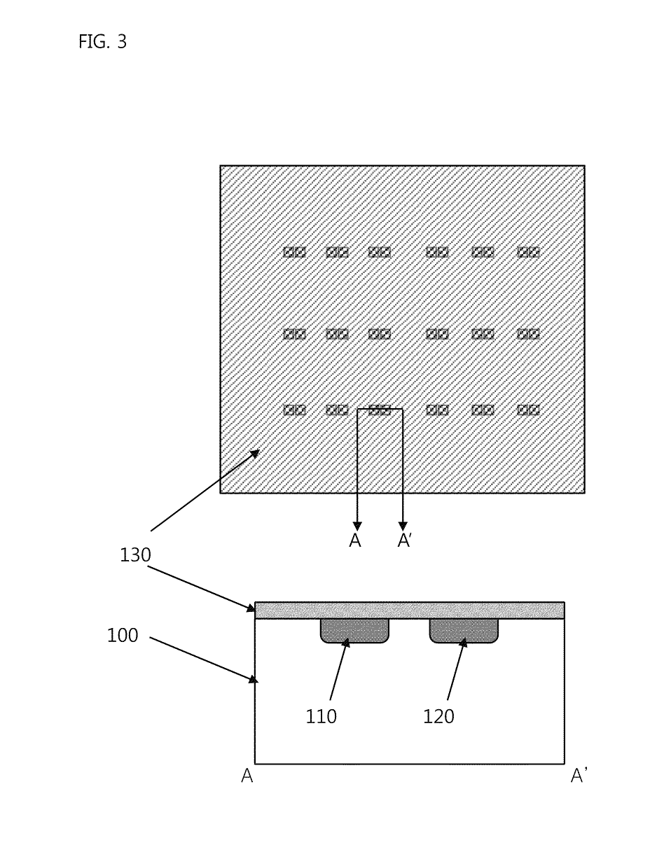

Referring to FIG. 3, after the biosensor region is defined, an insulating film 130 such as SiN is formed on the substrate by a chemical vapor deposition (CVD) process.

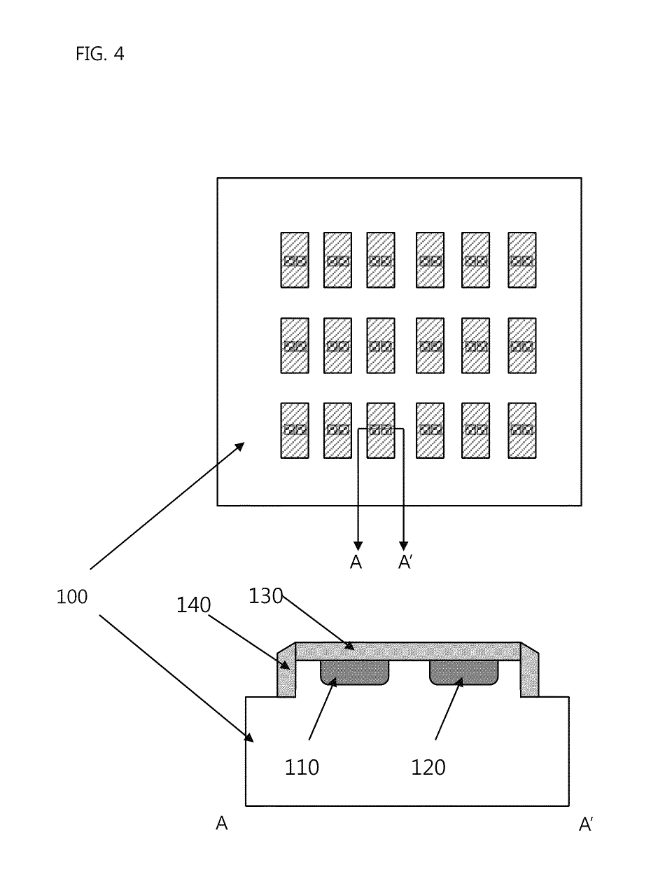

Referring to FIG. 4, the insulating film is patterned and the exposed silicon substrate is etched. Asa result, the peripheral region of the silicon substrate excluding the biosensor region including a source-gate region is etched to a predetermined depth (first etching), and a trench structure with the predetermined depth is formed in between the biosensor region.

Thereafter, a spacer 140 is formed on the side surface of the exposed biosensor region by a CVD process, in order to protect the substrate during the following etching process. The spacer 140 needs not be made of the same material as the insulating film 130, and may be selected freely considering process conditions. In an embodiment of the present invention, SiN may be used.

In an embodiment of the present invention, if the side surface of the biosensor substrate is protected (masked) by the spacer 140, the side surface may be effectively protected even in case of a trench structure having a wider width than the depth, as compared to an energy gradient ion beam deposition process. Accordingly, in accordance with the present invention, by using the spacer, the biosensor may be manufactured on and then separated from the silicon substrate without limitation in width.

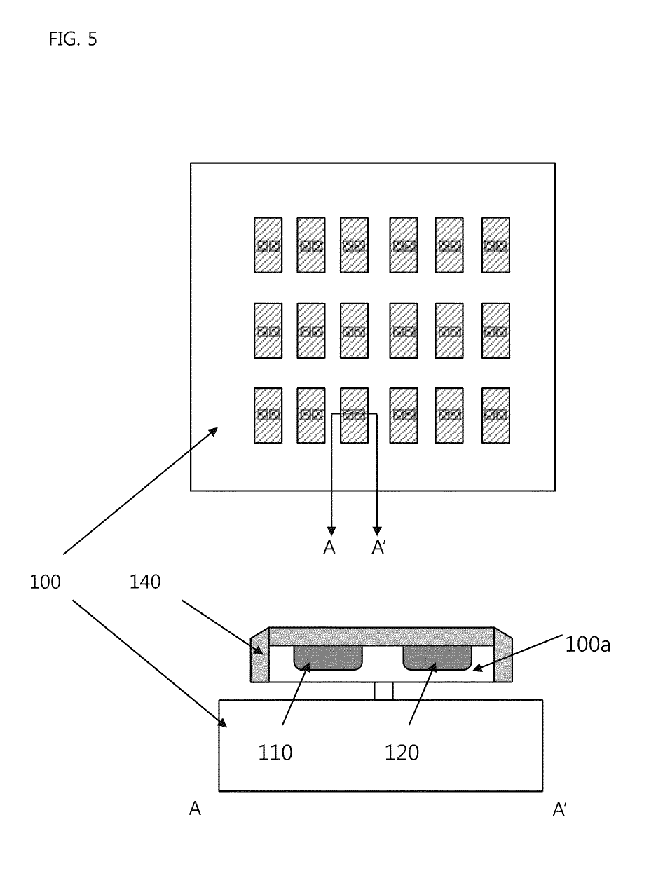

Referring to FIG. 5, the exposed silicon substrate is anisotropically etched (second etching). According to an embodiment of the present invention, an exposed peripheral region excluding a biosensor region 100a protected by the spacer 140 and the mask 130 is etched. In particular, in accordance with the present invention, a (1,1,1) silicon substrate may be anisotropically etched along (1,1,0) direction by wet etching. As a result, etching occurs predominantly at the side surface (i.e., horizontally), and the biosensor region 100a protected by the mask layer 130 and the spacer 140 may be separated from the silicon substrate 100 therebelow. In an embodiment of the present invention, tetramethylammonium hydroxide (TMAH), potassium hydroxide (KOH), etc. may be used for the etching. Use of such etching solution results in different etching rates in different crystallographic directions ((1,0,1):(1,0,0):(1,1,1)=300:600:1) and, thus, ensures an anisotropic etching predominantly in the (1,1,0) direction. To accomplish a more effective etching of the side surface, prior to the second etching, the silicon substrate may be etched vertically to a predetermined depth below the spacer (third etching) to expose the side surface of the silicon substrate and thereby specify the position of side surface etching. Also, in this case, the biosensor region 100a is separated from the silicon substrate 100 therebelow by the anisotropic etching.

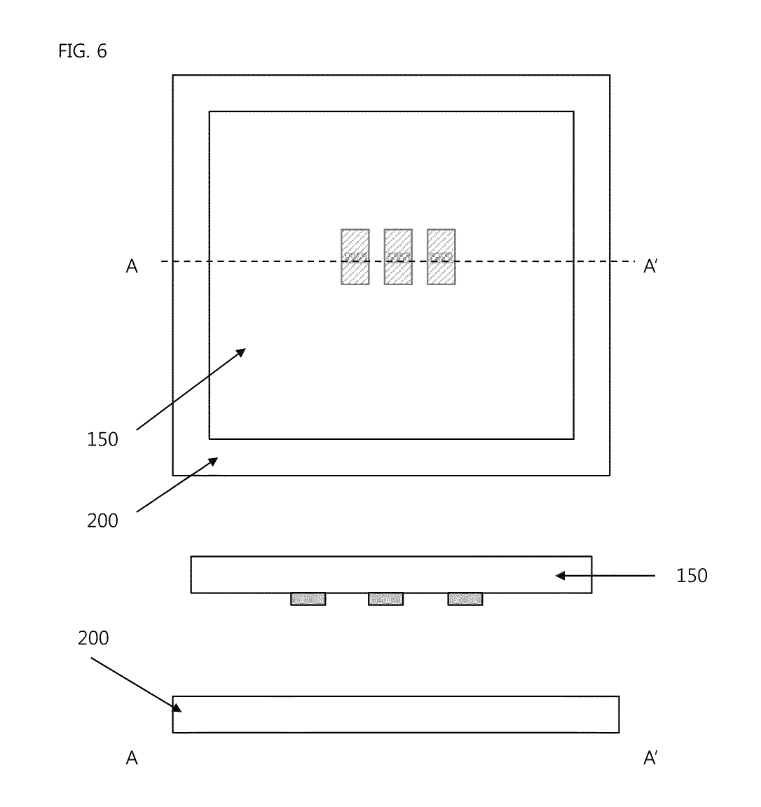

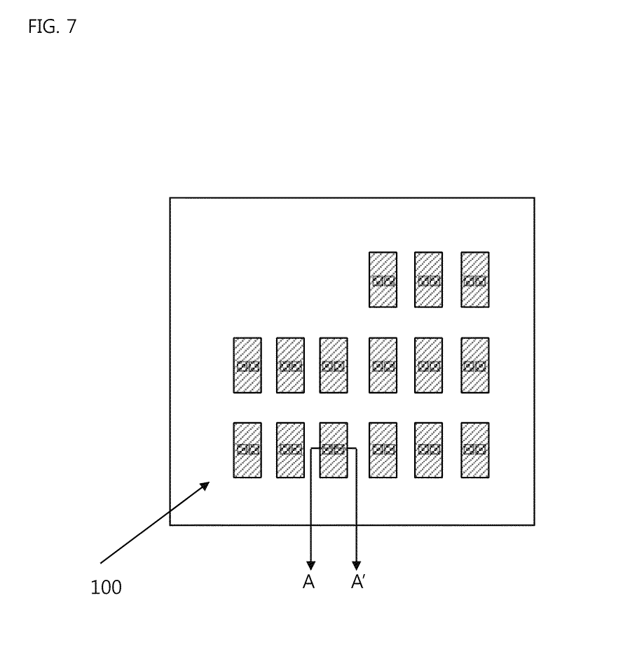

Referring to FIG. 6, using a flexible polydimethylsiloxane (PDMS) transfer layer 150 on which an adhesion layer of, for example, polyimide is formed, the biosensor region 100a is separated from the silicon substrate 100 and transferred onto a flexible substrate 160, e.g. a plastic substrate. FIG. 7 is a plan view of the silicon substrate after some of the biosensor device region is removed from the silicon substrate. Referring to FIG. 7, there still remains on the silicon substrate a biosensor region with source and drain regions, which may be used afterwards. Accordingly, the present invention allows manufacturing of a lot of biosensor regions on a large-area silicon substrate and allows transfer of the effectively aligned biosensor regions onto a flexible substrate via selective contact of the transfer layer.

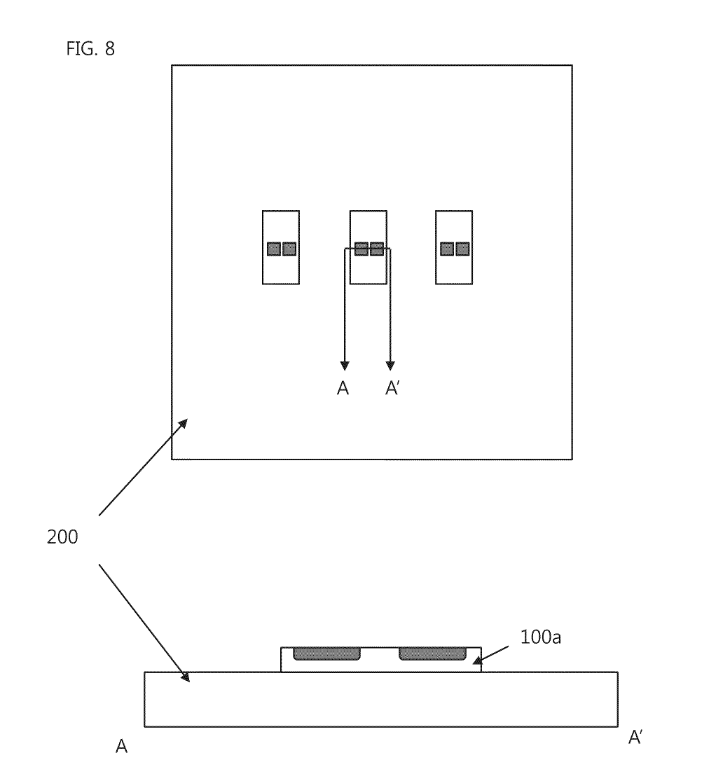

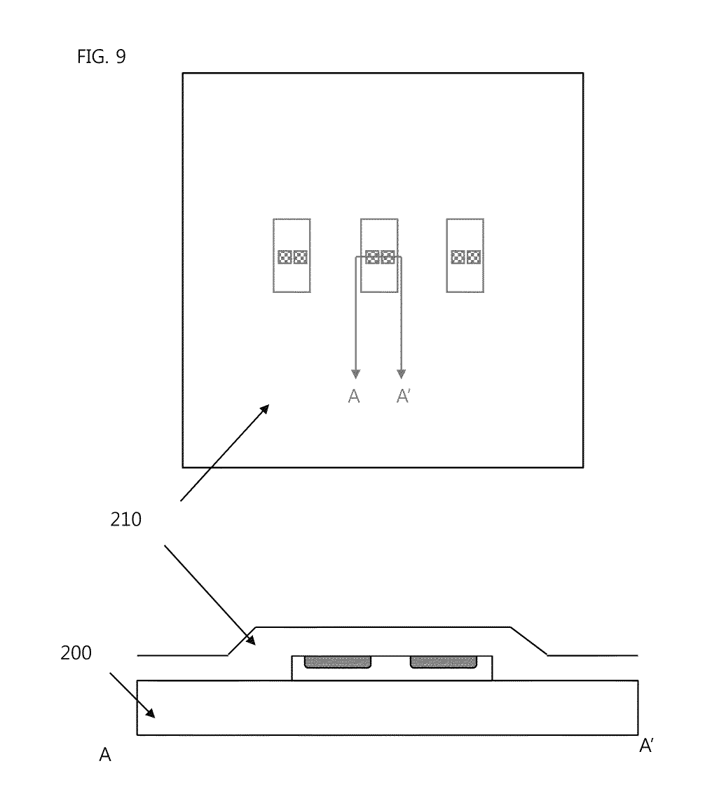

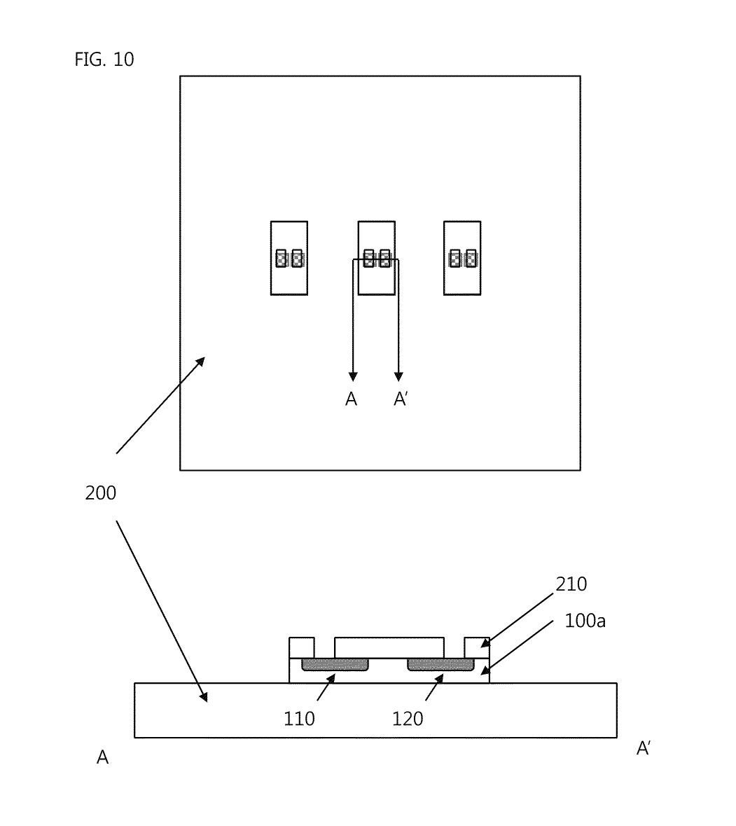

Referring to FIG. 8, following the transfer, the biosensor device region 100a with the source and drain regions formed thereon is provided on the flexible substrate 160. Then, as seen in FIGS. 9 and 10, a gate oxide film 210 is formed (FIG. 9) on the silicon substrate 100a and the flexible substrate 160, and then patterned (FIG. 10). Through the patterning, contact holes where source and drain electrodes will be formed are formed on the source and drain regions 110, 120.

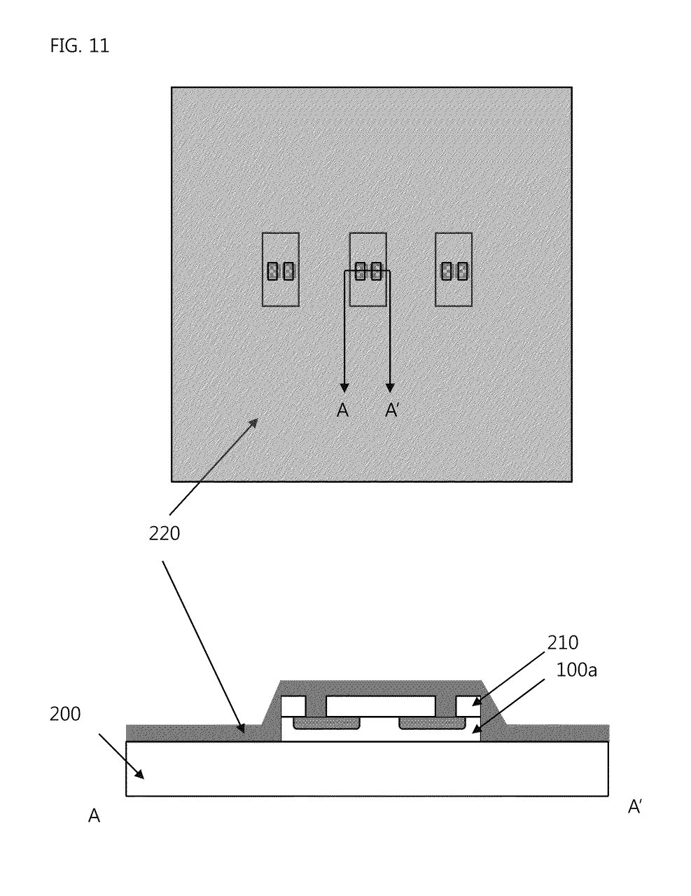

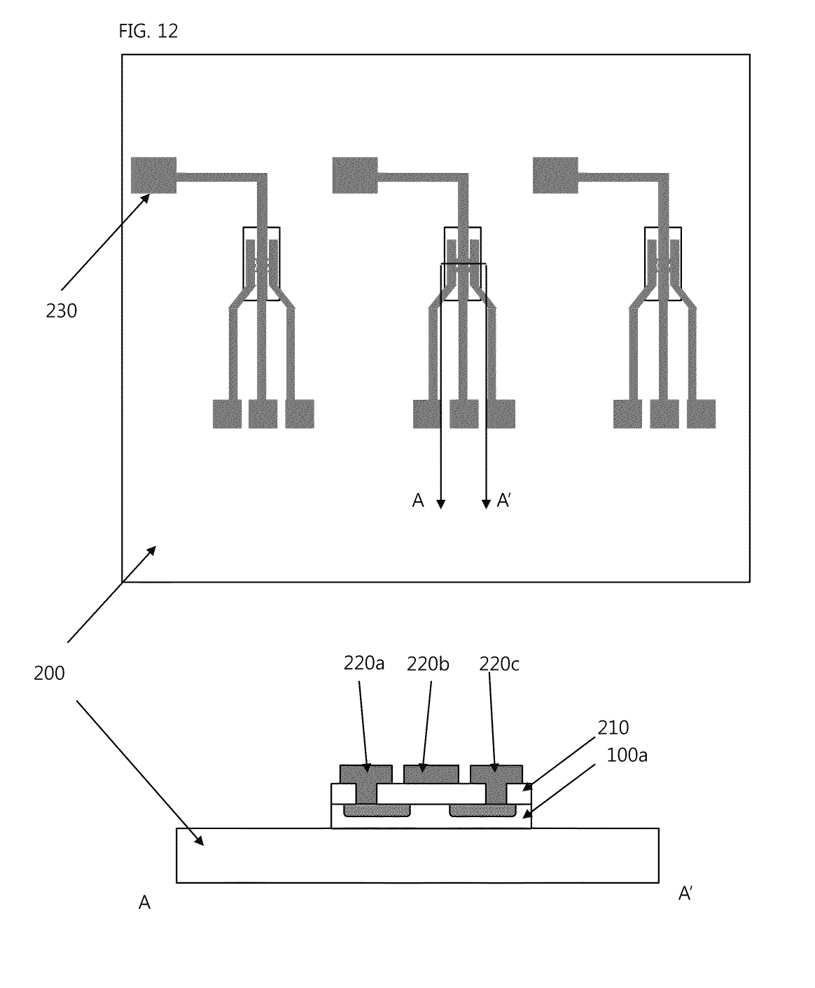

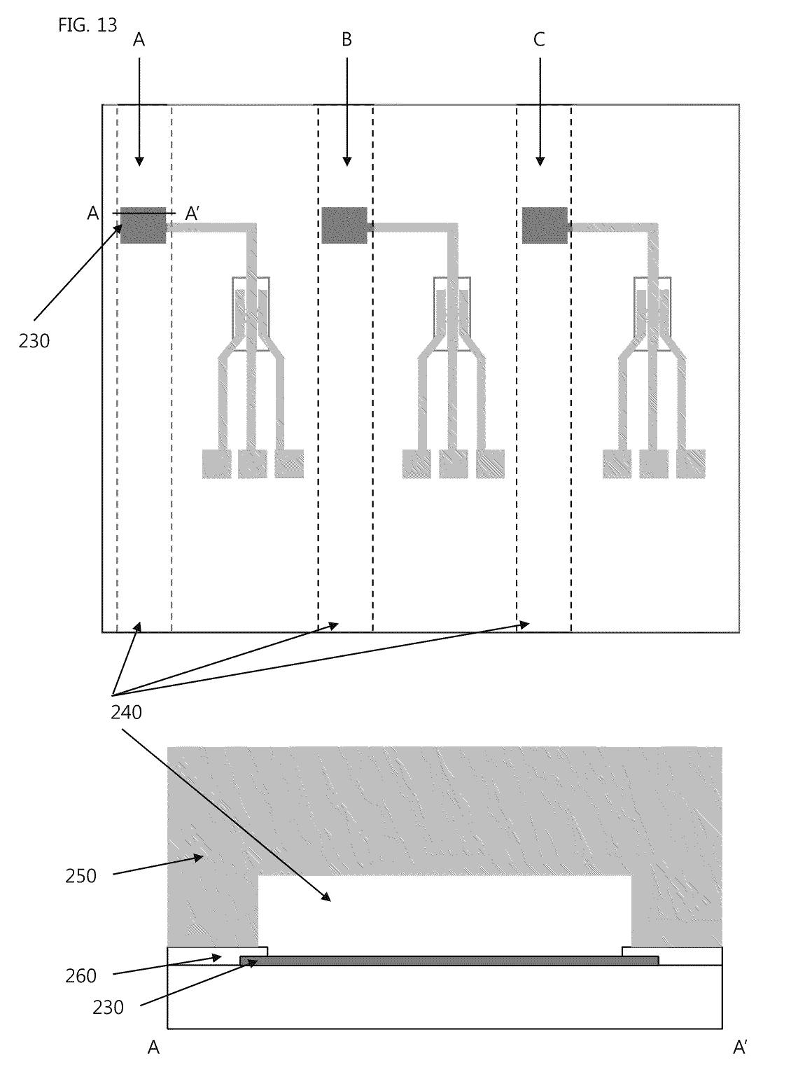

Referring to FIGS. 11 and 12, a metal layer 220 is formed on the patterned gate oxide film 210 and the silicon substrate 100a, and then patterned. Through the patterning, source and drain electrodes 220a, 220c and a gate electrode 220b are formed. In particular, in an embodiment of the present invention, a gate electrode pad 230 is provided which extends from the gate electrode 220b and has a width wider than that of the gate electrode. The gate electrode pad 230 is a region where a biologically active substance is immobilized and a biological reaction occurs. However, the gate electrode pad 230 is only a part of the gate electrode, and the biologically active substance may be immobilized on any part of the gate electrode. Further, in an embodiment of the present invention, a sensing pad is provided which extends from the source and drain electrodes and detects current. In an embodiment of the present invention, the gate electrode pad 230 may comprise gold, and the biologically active substance may be immobilized on the gate electrode pad without pretreatment of the pad using a detecting protein formed by fusion with a gold binding protein (GBP) that specifically binds to gold. The method of immobilization and the biologically active substance will be described in further detail. First, a microfluidic channel 240 formed on PDMS 250 is provided on the gate electrode pad 230 (see FIG. 13). The microfluidic channel 240 is provided for each of the one or more unit biosensors, and a photoresist (PR) layer 260 of, for example, SU-8 may be formed around the gate electrode pad 230 for sealing and adhesion of PDMS with the substrate therebelow. By means of the microfluidic channel 240 that passes through the gate electrode pad 230, a substance that passes through the microfluidic channel comes in direct contact with the gate electrode pad 230. As a result, a detecting substance such as antibody, which results in voltage change of the gate electrode through a biological reaction, may be immobilized on the gate electrode pad 230. If different detecting substances are flown through microfluidic channels A, B, C of the biosensor according to an embodiment of the present invention, different biologically active substances may be immobilized on each of the electrode pads.

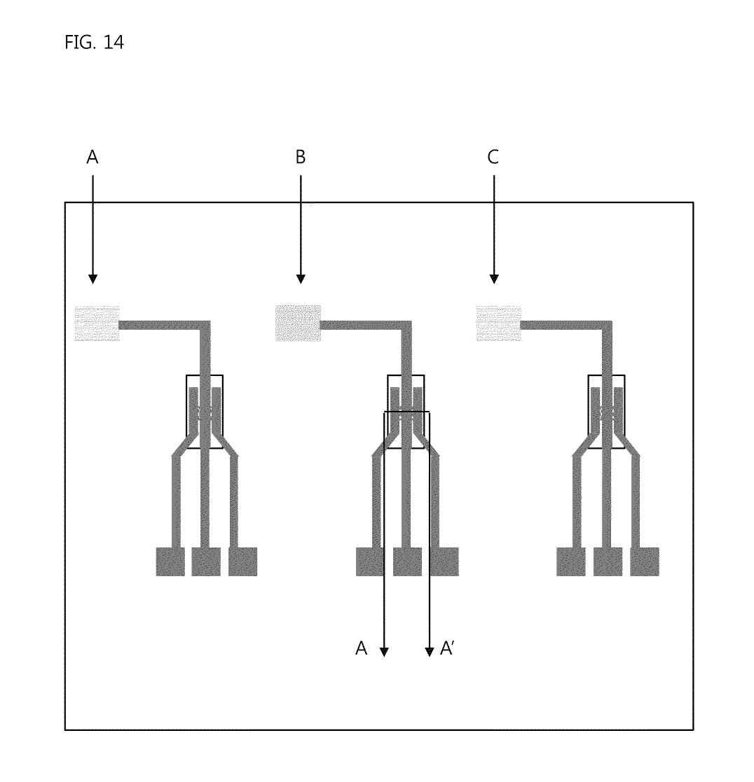

Referring again to FIG. 14, in an embodiment of the present invention, a biologically active substance comprising GBP is flown through the microfluidic channel 240. The GBP specifically binds to the gate electrode pad 230 which comprises gold. In particular, the present invention allows immobilization of the wanted biologically active substance on the device surface without any pretreatment of the biologically active substance by using the GBP which specifically binds to gold. This is a very important feature for a flexible substrate. The flowing and of immobilization the GBP will be described in further detail later. If different antibodies or antigens are immobilized by flowing them through different microfluidic channels of different biosensors, the biosensors are capable of detecting the target antigens or antibodies at the same time. That is to say, although the biosensors are embodied on a single flexible substrate, they allow effective detection of one or more antigens or antibodies through a single process. In addition to antibody, various biological substances (e.g. immune factors) may be used in the present invention depending on purposes.

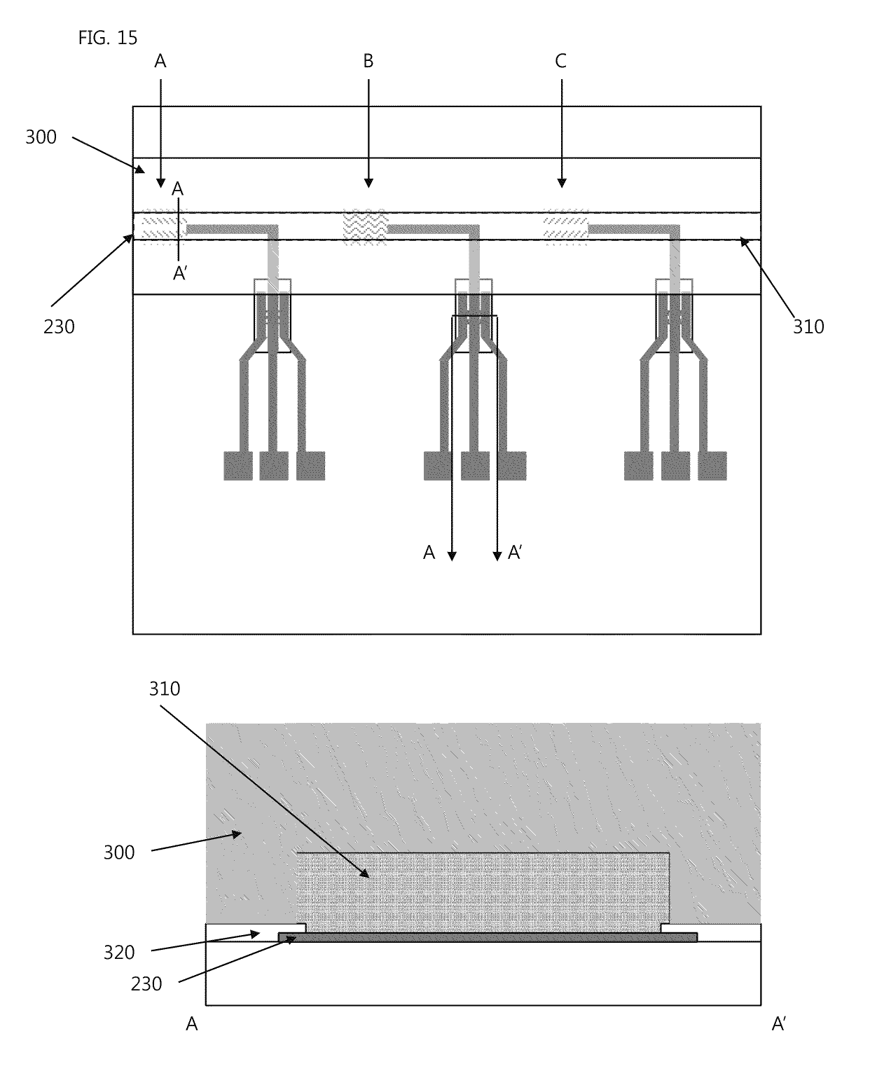

FIG. 15 illustrates a method of flowing another biologically active substance at the same time to a plurality of gate electrode pads 230 on which a biologically active substance is immobilized. Referring to FIG. 15, a polymer layer 300 comprising a polymer such as PDMS which is provided with another microfluidic channel 310 is brought into contact with the biosensor, particularly the gate electrode on which the biologically active substance such as antibody is immobilized. The microfluidic channel 310 of the polymer layer 300 passes through a region of the gate electrode pad 230 on which the antibody is immobilized. By using a flexible polymer such as PDMS, the microfluidic channel 310 may be sealed enough even when there is a level difference (difference in height of the flexible substrate and the biosensor), and the biologically active substance may be flown satisfactorily flown through the microfluidic channel 310 without leakage of the substance to be detected (e.g. antigen) flowing through the microfluidic channel 310. Besides, the biosensor may have various heights depending on the process condition and time of the third etching process. Accordingly, by adequately selecting the condition of the third etching process, a biosensor having a low height may be manufactured. In this case, the flexible PDMS provided with the microfluidic channel may effectively prevent leakage of antigen or the like from the microfluidic channel.

### Example 2

### Example 2-1

Antibody Binding

Preparation of GBP-Fused Protein and Specific Antigen Binding

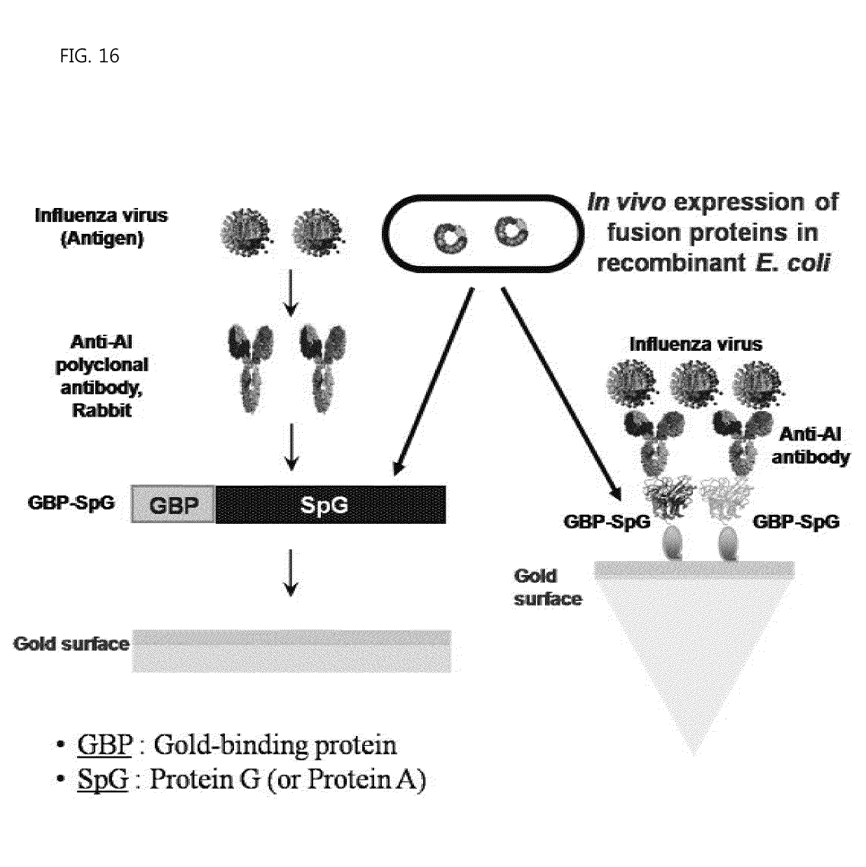

FIG. 16 schematically shows a process of antigen detection according to an embodiment of the present invention.

Referring to FIG. 16, a fused protein (GBP-SpA or GBP-SpG) of Protein A (or G), which specifically binds to immunoglobulin antibody, and GBP is prepared to detect antigen. The amino acid sequence of Protein A or G is as follows.

Protein A
H₂N-AQHDEAQQNAFYQVLNMPNLNADQRNGFIQSLKDDPSQSANVLGEA
QKLNDSQAPKADAQQNNFNKDQQSAFYEILNMPNLNEAQRNGFIQSLKDD
PSQSTNVLGEAKKLNESQAPKADNNFNKEQQNAFYEILNMPNLNEEQRNG
FIQSLKDDPSQSANLLSEAKKLNESQAPKADNKFNKEQQNAFYEILHLPN
LNEEQRNGFIQSLKDDPSVSKEILAEAKKLNDAQAPKEEDNKKPGKEDGN
KPGKEDGNKPGKEDNKKPGKEDGNKPGKEDNNKPGKEDGNKPGKEDNNKP
GKEDGNKPGKEDGNKPGKEDGNGVHVVKPGDTVNDIAKANGTTADKIAAD
NKLADKNMIKPGQELVVDKKQPANHADANKAQALPETGEENPFIGTTVFG
GLSLALGAALLAGRRREL-COOH
Protein G
H₂N-LKGETTTEAVDAATAEKVFKQYANDNGVDGEWTYDDATKTFTVTEK
PEVIDASELTPAVTTYKLVINGKTLKGETTTEAVDAATAEKVFKQYANDN
GVDGEWTYDDATKTFTVTEKPEVIDASELTPAVTTYKLVINGKTLKGETT
TKAVDAETAEKAFKQYANDNGVDGVWTYDDATKTFTVTE-COOH

The fused protein is synthesized as follows. A recombinant vector including a gene that encodes GBP and a gene that encodes Protein G and designed such that the two genes are expressed in fused form is inserted into E. coli to transform them. The transformed microorganisms are cultured to express the fused protein of GBP and Protein G (GBP-SpG). Then, the cells in which the fused protein is expressed are recovered and pulverized. The aqueous fraction containing the fused protein is isolated.

Then, antibody (rabbit polyclonal antibody) is flown through the microfluidic channel of FIG. 13, so that the antibody is immobilized on the electrode pad. Then, voltage change caused by specific antibody-antigen binding is detected while flowing the antigen again.

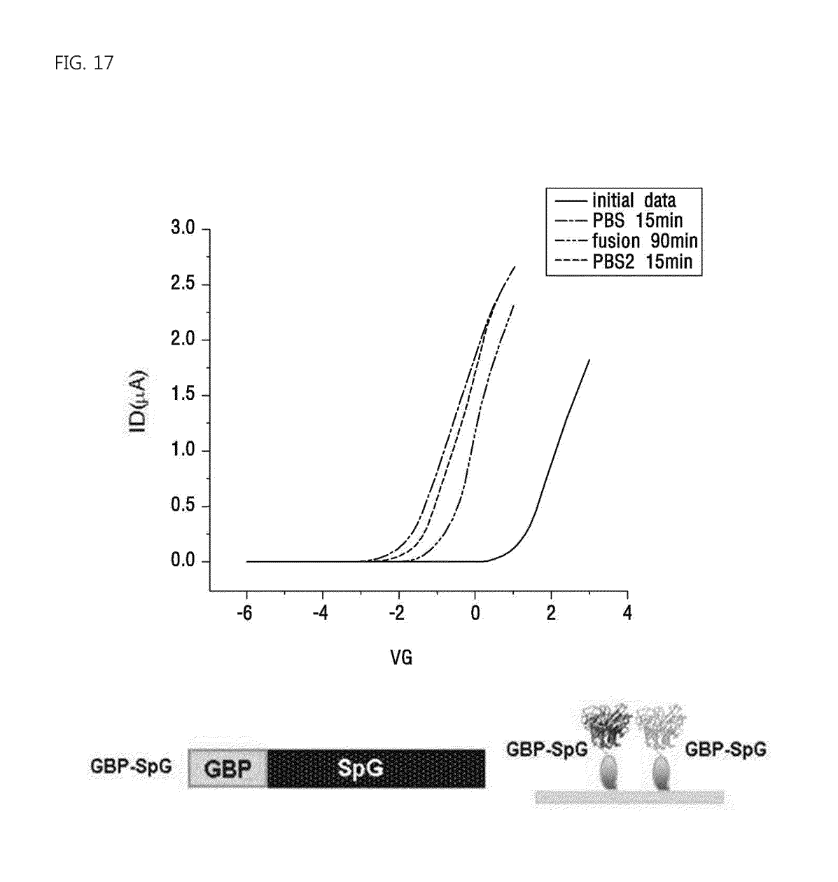

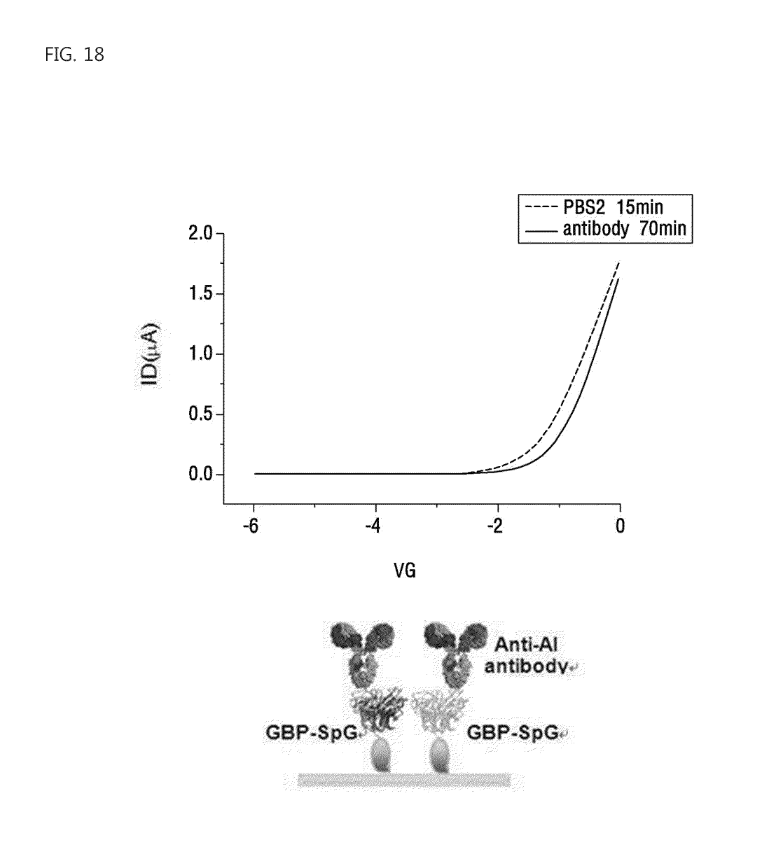

Before flowing thus prepared antigen through the microfluidic channel of FIG. 13, the microfluidic channel is sufficiently washed with a washing buffer (phosphate-buffered saline (PBS), pH 7.4) while flowing the washing buffer at 5 μL/min using a syringe pump. Then, after selectively immobilizing purified GBP-SpG fused protein at a concentration of 50 μg/mL on the gate electrode of the biosensor for 90 minutes, the microfluidic channel is sufficiently washed with a washing buffer (PBS) at 5 μL/min. As a result, as seen in FIG. 17, as GBP-SpG is selectively immobilized on the gate electrode, gate voltage V_{G} shifts leftwards with the progress of reaction. The presence of the negatively charged GBP-SpG fused protein on the gold surface of the gate electrode, which results from the selective immobilization of the GBP-SpG fused protein, leads to charge deficiency in silicon between the source and drain electrodes and decreased electron density. Accordingly, current and gate voltage decrease. The decrease of the current and gate voltage is dependent on the density of the GBP-SpG fused protein on the surface of the gate electrode. Therefore, the concentration of the GBP-SpG fused protein can be quantitatively measured. The biosensor is reacted with anti-AIa antibody at concentration 100 μg/mL for 70 minutes, so that the GBP-SpG fused protein selectively immobilized on the gate electrode of the biosensor specifically binds to the Fc region of the anti-AIa antibody via protein-protein interaction. Thereafter, the biosensor is sufficiently washed with a washing buffer (PBS) at a flow rate of 5 μL/min. As a result, as seen in FIG. 18, gate voltage V_{G} shifts leftwards by about 0.5 V as the anti-AIa antibody is immobilized.

### Example 2-2

Antigen Binding

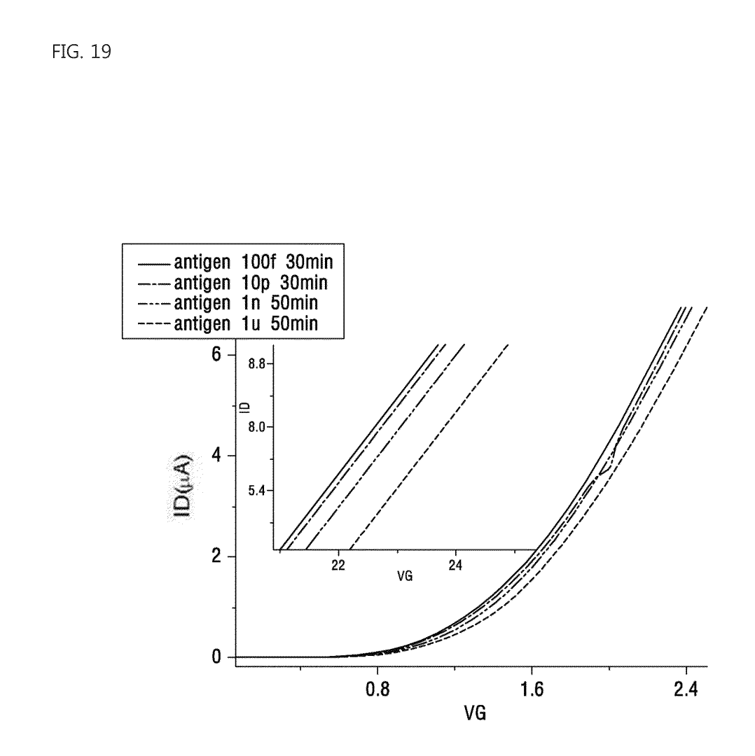

Using the biosensor device chip of Example 2-1 on which anti-AIa antibody is immobilized at concentration 100 μg/mL, minimum detectable antigen concentration is determined using AIa antigen at concentrations 1 μg/mL, 1 ng/mL, 10 pg/mL and 100 fg/mL. For this, to the biosensor device on which anti-AIa antibody is immobilized at concentration 100 μg/mL, the prepared antigen solutions are flown sequentially at a flow rate of 5 μL/min. Reaction is carried out for 30 minutes for 10 pg/mL and 100 fg/mL solutions and for 50 minutes for 1 μg/mL and 1 ng/mL solutions. Then, electrical properties of the biosensor are examined. FIG. 19 shows a voltage-current curve of the biosensor on which the antigen is bound. Referring to FIG. 19, it can be seen that various changes in current are detected depending on antibody-antigen binding and binding time thereof. Accordingly, the quantity of antigen can be detected using the biosensor according to the present invention.

### Example 2-3

Antibody Detection

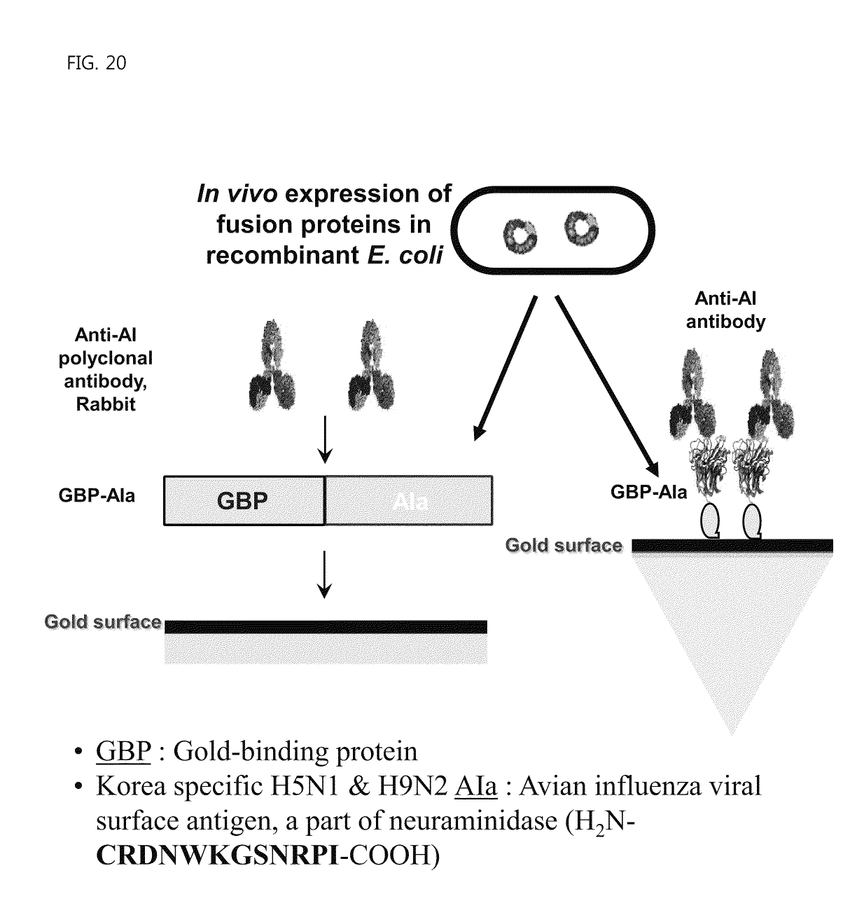

Referring to FIG. 20, a fused protein (GBP-AIa) formed by fusion of GBP and an antigen (avian influenza viral surface antigen, Korea specific H5N1 & H9N2 AIa) is flown through the microfluidic channel of FIG. 13, so that the fused protein is specifically bound on the gold surface of the gate electrode pad 230. The amino acid sequence of the GBP is as follows.

1. GBP1
H₂N-MHGKTQATSGTIQS-COOH
2. GBP3
H₂N-MGKTQATSGTIQSMHGKTQATSGTIQSMHGKTQATSGTIQS-COOH
3. GBP10
H₂N-SKTSLGQSGASLQGSEKLTNG-COOH

Before flowing the antigen through the microfluidic channel of FIG. 13, the microfluidic channel is sufficiently washed with a washing buffer (PBS) while flowing the washing buffer at 5 μL/min using a syringe pump. Then, after selectively immobilizing purified GBP-AIa fused protein at a concentration of 50 μg/mL on the gate electrode pad 230 of the biosensor of FIG. 13 for 90 minutes, the microfluidic channel is sufficiently washed with a washing buffer (PBS) at 5 μL/min. Asa result, as GBP-AIa is selectively immobilized on the gate electrode, gate voltage V_{G} shifts leftwards with the progress of reaction. The presence of the negatively charged GBP-AIa fused protein on the gold surface of the gate electrode pad, which results from the selective immobilization of the GBP-AIa fused protein, leads to charge deficiency in silicon between the source and drain electrodes and decreased electron density. Accordingly, current and gate voltage decrease. The decrease of the current and gate voltage is dependent on the density of the GBP-AIa fused protein on the surface of the gate electrode. Therefore, the concentration of the GBP-AIa fused protein can be quantitatively measured. Anti-AIa antibody specifically binds to the gate electrode pad via antigen-antibody interaction of the GBP-AIa fused protein selectively immobilized on the gate electrode of the biosensor and the anti-AIa antibody. Thereafter, the biosensor is sufficiently washed with a washing buffer (PBS) at a flow rate of 5 μL/min. As a result, as seen in FIG. 18, gate voltage V_{G} shifts as the anti-AIa antibody is immobilized. Therefore, the anti-AIa antibody can be detected.

In another embodiment of the present invention, there is provided a biosensor wherein a biologically active substance is immobilized on a silicon substrate and a method for manufacturing the same, which will be described in detail with reference to the attached drawings.

### Example 3

Manufacture of Biosensor

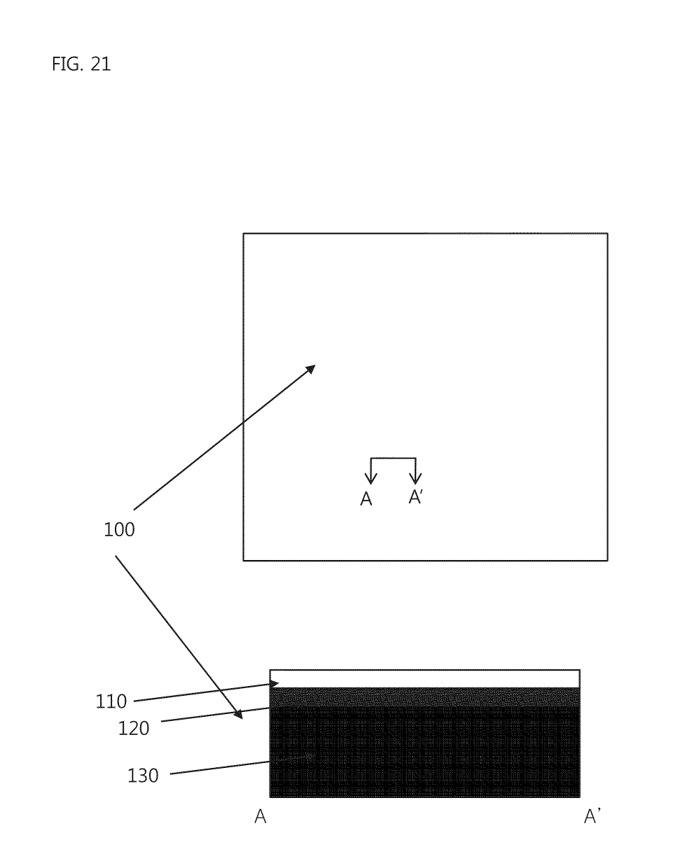

FIGS. 21 to 34 show a process of manufacturing a flexible biosensor according to the present invention.

Referring to FIG. 21, a silicon on insulator (SOI) substrate wherein a silicon layer 100 is provided on a bulk silicon substrate 130 is provided. In accordance with the present invention, an insulating layer 120 is artificially formed between two silicon layers to remove effect from the bulk silicon and significantly improve processability, efficiency and property of the highly pure silicon layer 100 formed on the insulator.

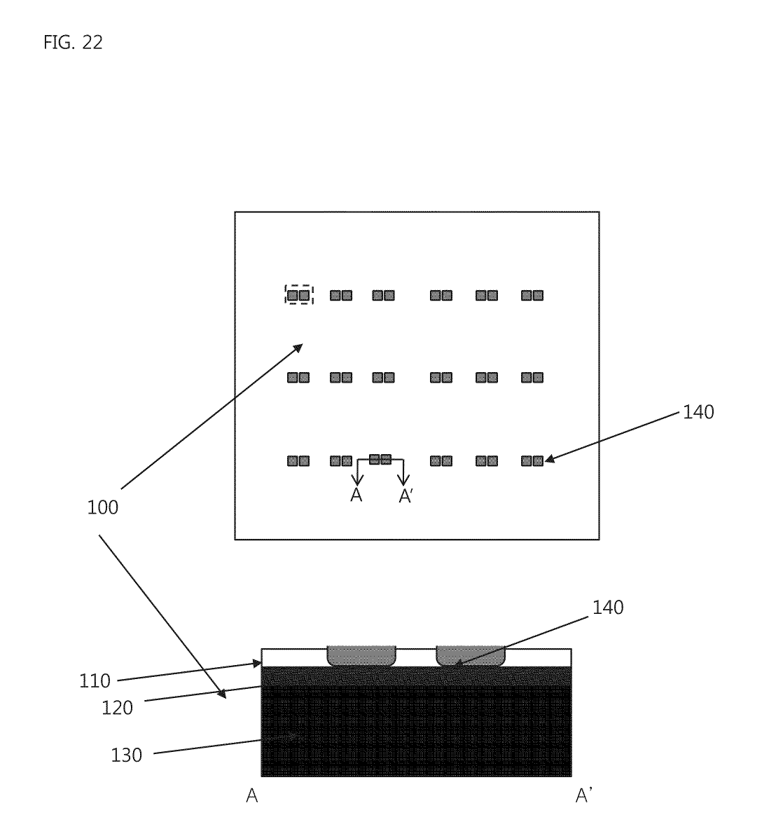

Referring to FIG. 22, in order to form source and drain regions 140 in the upper silicon layer 100, an impurity is injected to the silicon substrate 100 with a predetermined gap. This may be performed by any process commonly used in the art. For example, it may be performed by ion implantation followed by rapid thermal processing (RTP) diffusion. As a result, a silicon substrate region on which the biosensor is manufactured (biosensor region) and other silicon substrate region (peripheral region) are defined.

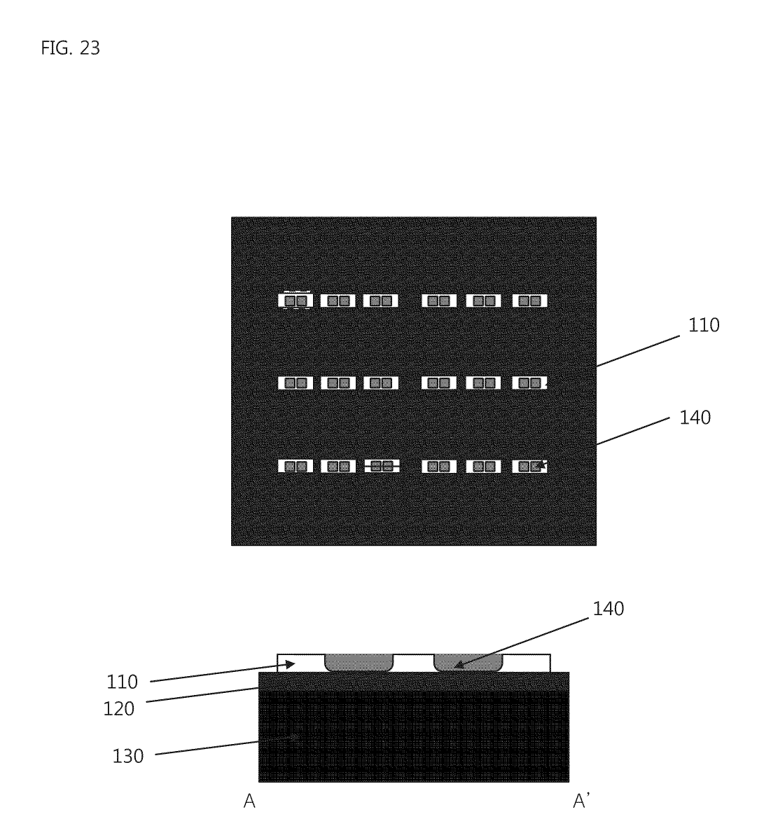

Referring to FIG. 23, the silicon layer is removed except for the substrate region including the source and drain regions 140 (hereinafter, biosensor region 110), and the insulating layer (oxide film layer) below the biosensor region 110 is exposed. As a result, one or more of the biosensor region with the source and drain regions 140 is formed on the insulating layer 120 with a predetermined length and spaced apart from each other.

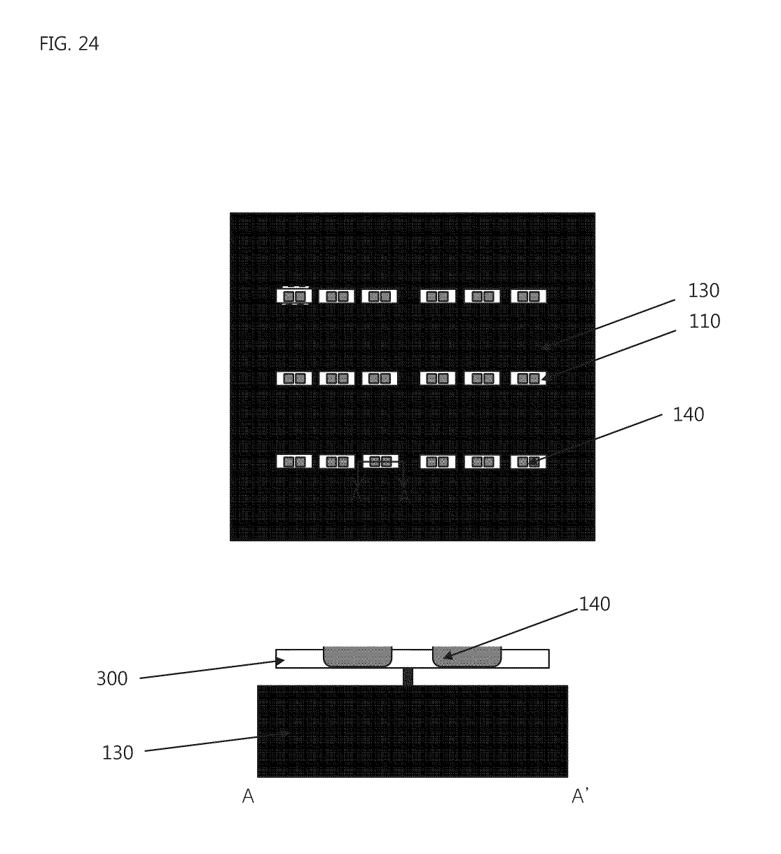

Referring to FIG. 24, the insulating layer 120 below the biosensor region is etched. By the etching process, a biosensor region substrate 300 is separated from the bulk silicon substrate 130 therebelow. In an embodiment of the present invention, the biosensor region substrate 300 is separated from the bulk silicon substrate 130 therebelow by immersing the insulating layer 120 in hydrofluoric acid solution. The immersion time increases in proportion to the transfer area.

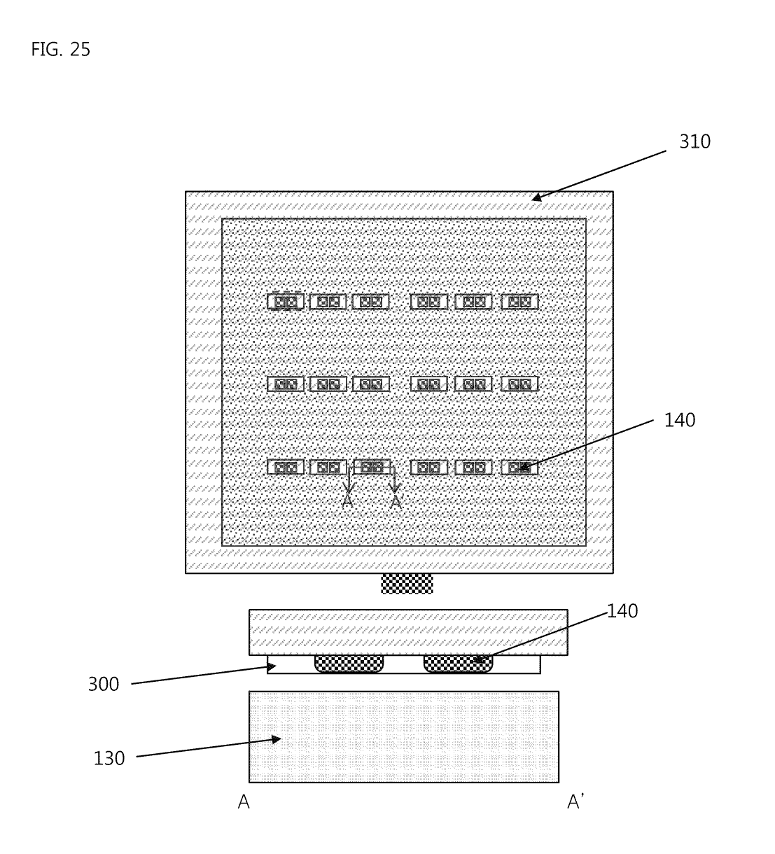

Referring to FIG. 25, the biosensor region substrate 300 with the source and drain regions formed thereon and separated from the bulk silicon substrate 130 is brought into contact with an adhesible transfer layer 310 comprising, for example, PDMS.

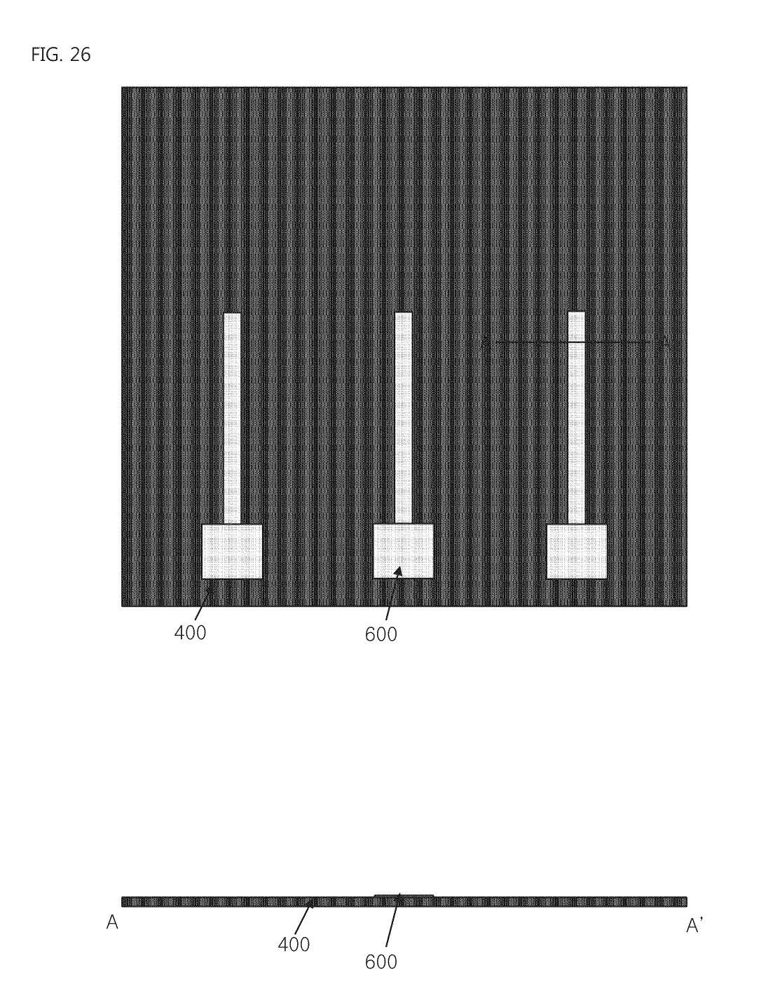

Referring to FIG. 26, separately from the silicon substrate, a lower gate electrode 600 is formed on a plastic substrate 400. The lower gate electrode 600 comprises metal consisting of chromium (Cr) and gold (Au).

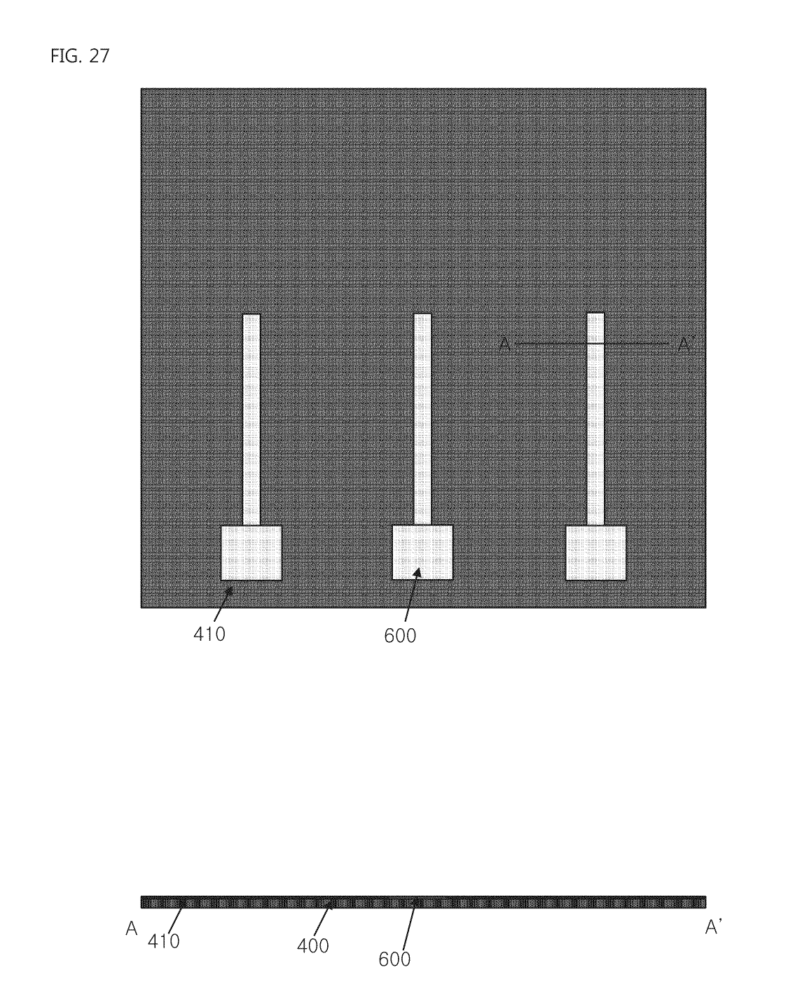

Referring to FIG. 27, a gate insulating layer 410 is formed at apredetermined level on the gate electrode 600 and the plastic substrate 400. As a result, the gate electrode 600 is maintained electrically insulated from a device thereabove. The gate insulating layer 410 may comprise silicon oxide (SiO₂) and may be formed, for example, by a chemical vapor deposition (CVD) process.

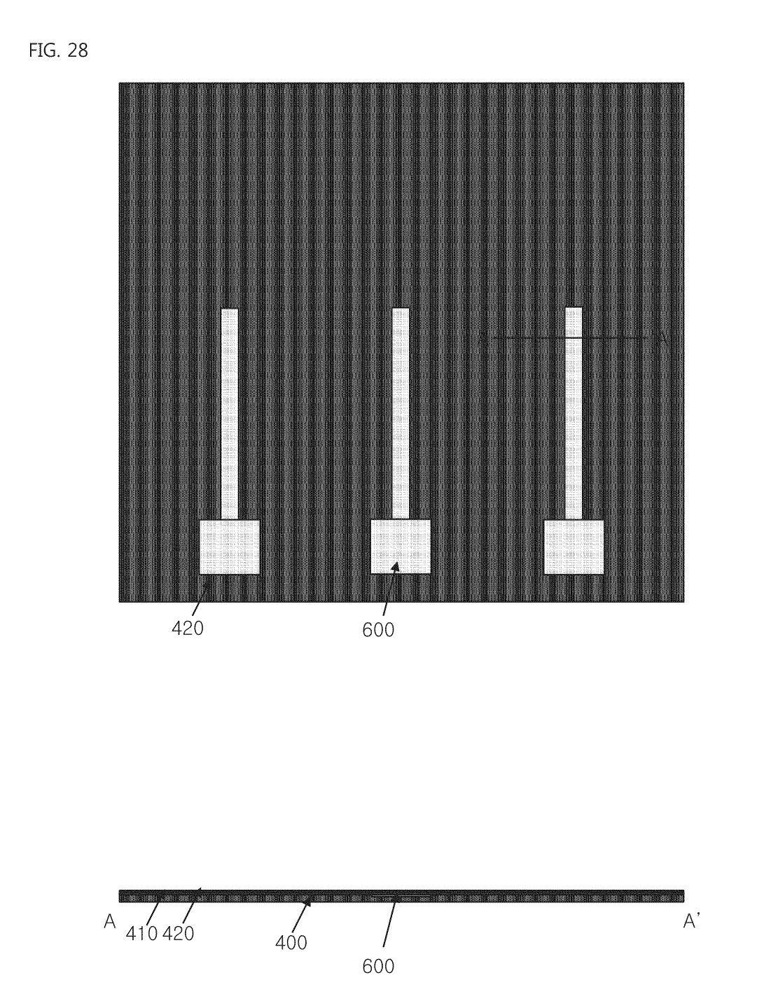

Referring to FIG. 28, an adhesion layer 420 of, for example, polyimide is formed on the gate insulating layer 410. In an embodiment of the present invention, the polyimide adhesion layer 420 may be formed on the gate insulating layer 410 by spin coating polyamic acid on the gate insulating layer 410 and then curing it at high temperature. As a result, a lower plastic substrate which is provided with the gate electrode and is electrically isolated from an upper device that will be provided later is completed.

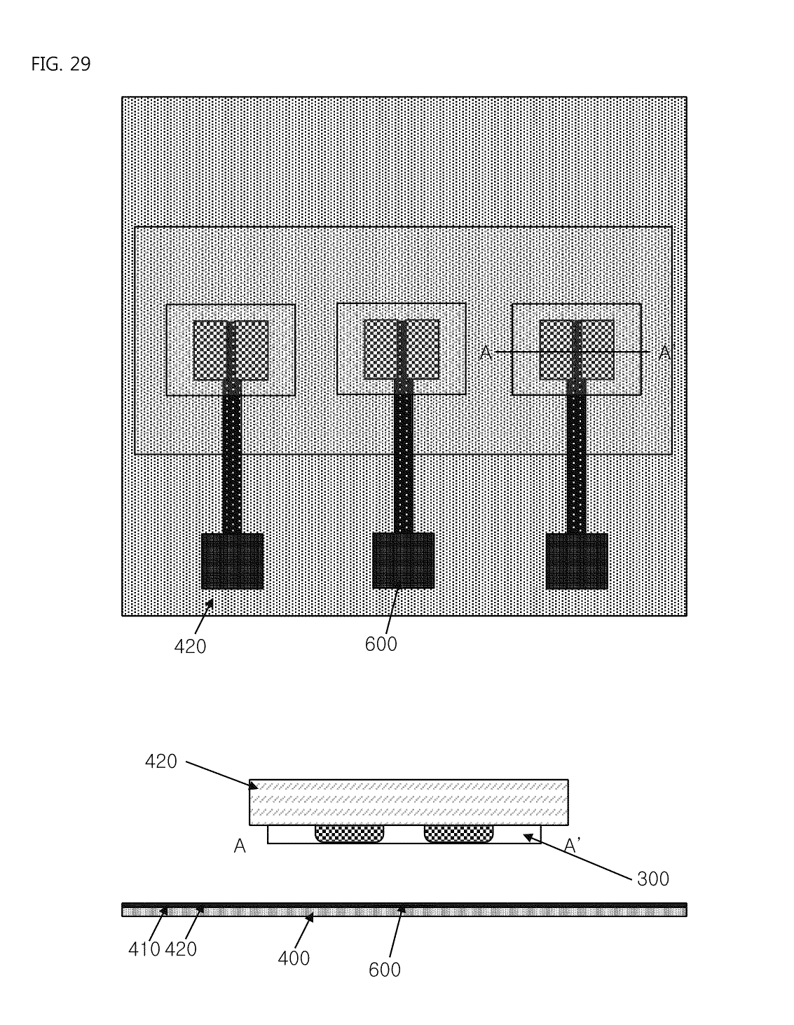

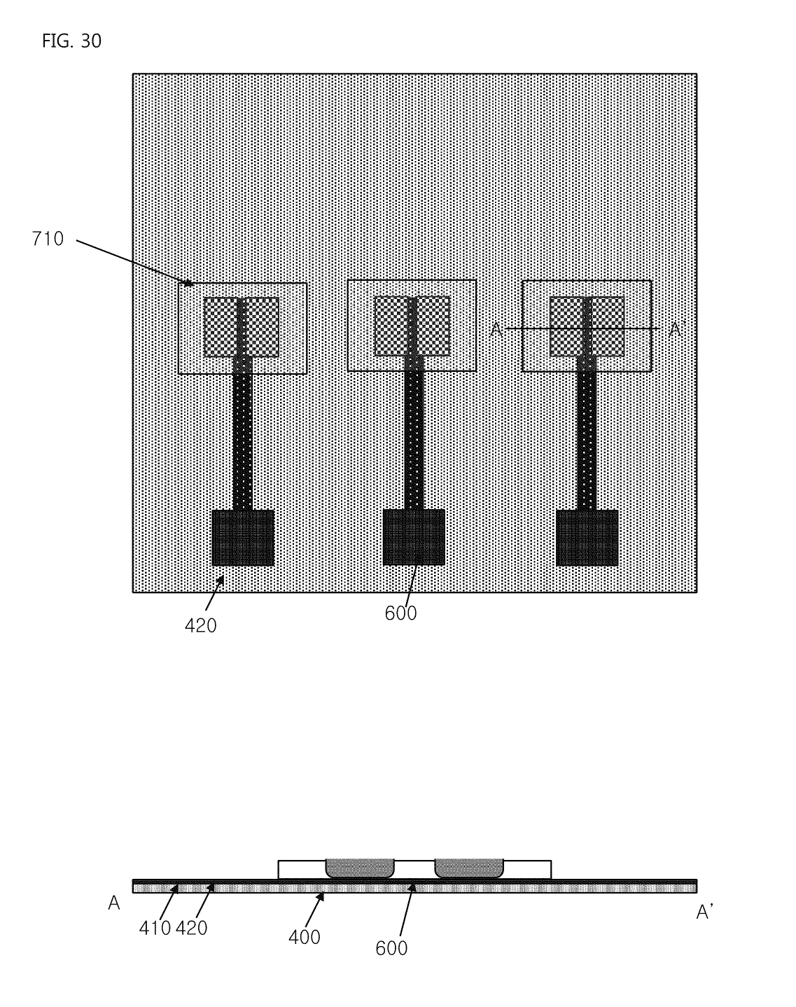

Referring to FIGS. 29 and 30, the biosensor region substrate 300 (FIG. 25) adhered on a transfer layer 420 of, for example, PDMS is adhered to the plastic substrate (FIG. 28) provided with the adhesion layer 420. The gate electrode 600 of the lower plastic substrate 400 is provided between the source and drain regions of the upper biosensor region. As a result, a transistor device having a source-gate-drain structure is completed. The resulting silicon-based device has a flexible property, with the lower flexible plastic substrate 400 and a small thickness. In an embodiment of the present invention, the plastic substrate has a thickness of 125 μm and the adhesion layer has a thickness of about 100 nm. And, in an embodiment of the present invention, the silicon substrate has a thickness of 60 to 70 nm. As such, the silicon substrate exhibits a flexible property similar to that of the lower plastic substrate. However, the present invention is not limited thereto, and any thickness range exhibiting a flexible property of the transferred silicon substrate is included in the scope of the present invention.

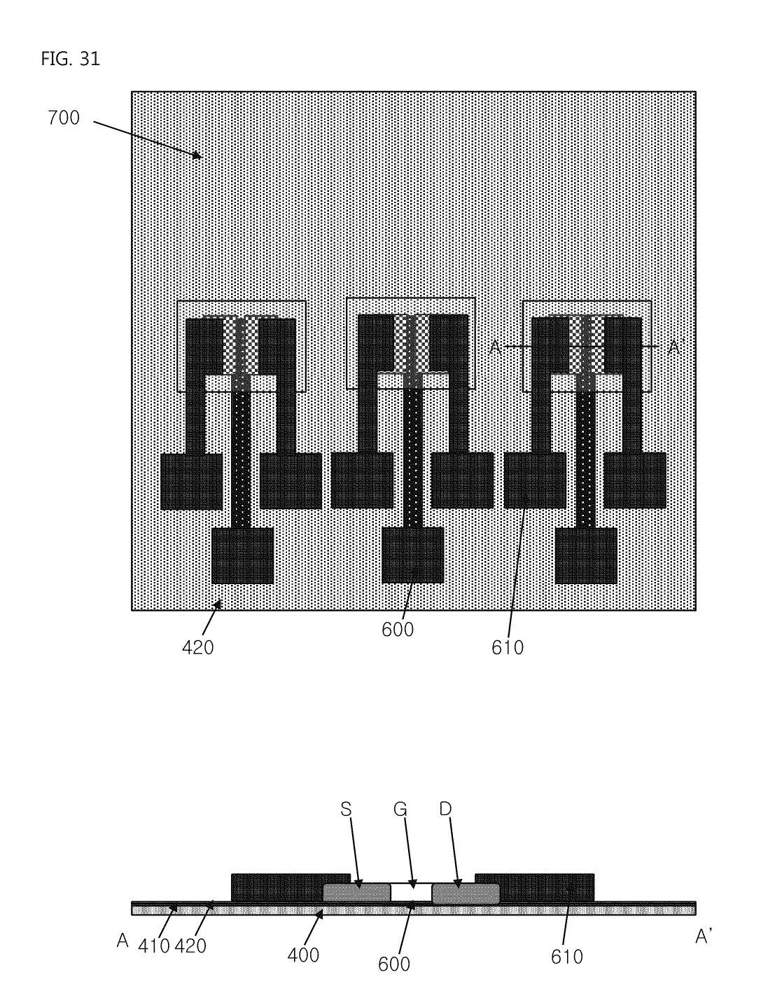

Referring to FIG. 31, source and drain electrodes 610 which are formed at the side surface of the biosensor region substrate 300 and come indirect contact with the source (S) and drain (D) regions formed at the biodevice region substrate 300 are provided. As a result, a transistor device having a structure of source electrode 610-source (S)-gate (G)-drain (D)-drain electrode 610 is completed.

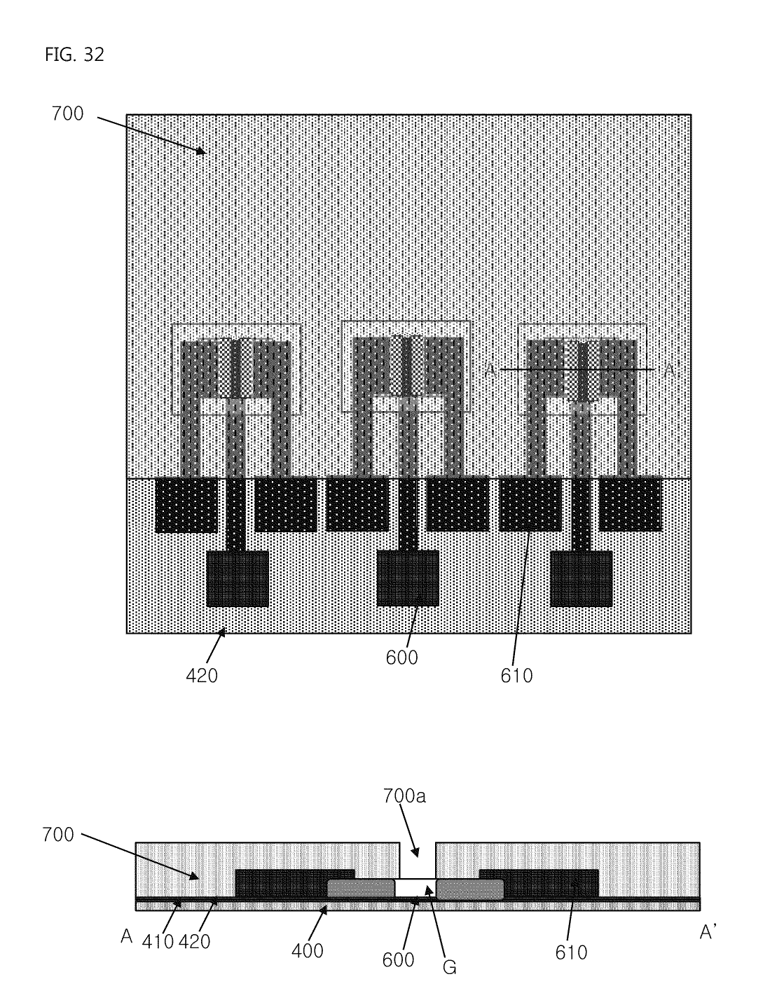

Referring to FIG. 32, a passivation layer 700 is provided to physically and electrically protect the exposed plastic substrate, source electrode and drain electrode therebelow. At this time, a trench structure 700a exposing the biodevice region substrate 300 between the source and drain regions is formed. The exposed biodevice region substrate 300 corresponds to a gate region of the device. As a result, a lower portion 700a of a microfluidic channel passing through the gate region G is formed. By flowing a wanted biomaterial through the microfluidic channel which passes through the gate region of the silicon substrate, the biomaterial may be detected. In an embodiment of the present invention, the passivation layer 700 comprises an insulating polymer material such as SU-8, but the present invention is not limited thereto.

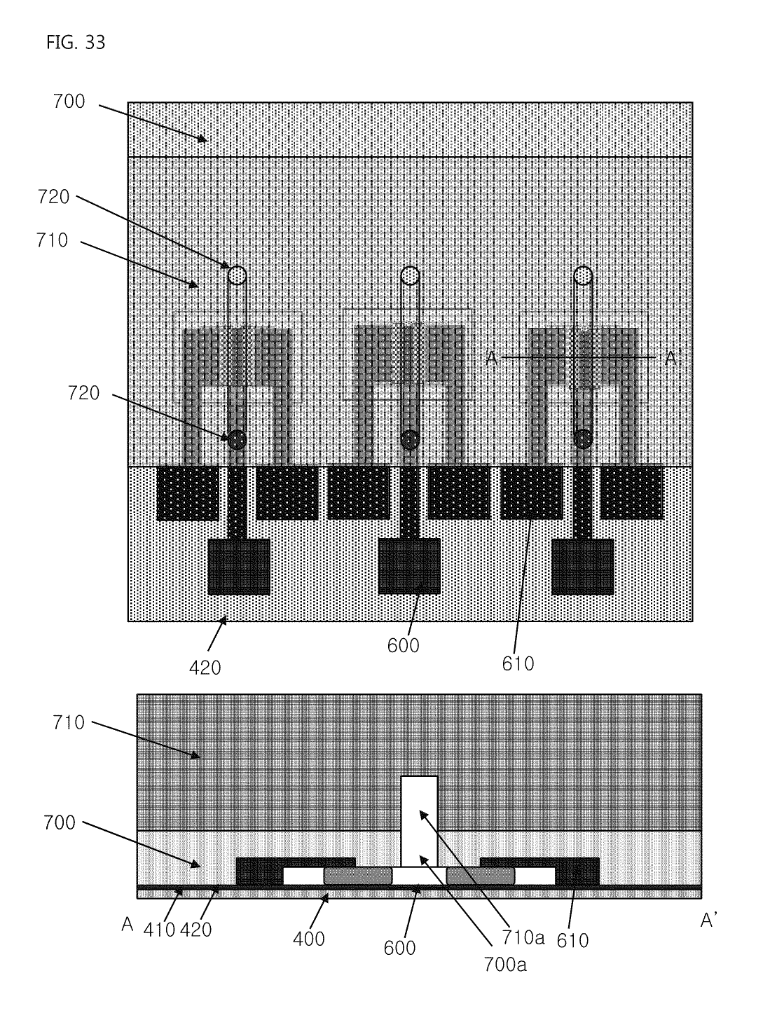

Referring to FIG. 33, an upper cover layer 710 is provided on the passivation layer 700. The upper cover layer 710 is provided with a trench structure 710a of a predetermined depth corresponding to the lower portion 700a of the microfluidic channel. Thus, a complete microfluidic channel 700a-710a is formed inside the device. At the ends of the microfluidic channel, holes 720 of a predetermined size are formed to allow introduction and discharge of a sample. In accordance with the present invention, by flowing a biologically active substance which specifically binds to the gate region through the microfluidic channel that passes through the gate region of the silicon substrate, the detecting substance is bound to the gate substrate. For this, a fused protein formed by fusion of a silica binding protein (SBP), which binds specifically to silicon, and a target substance is used.

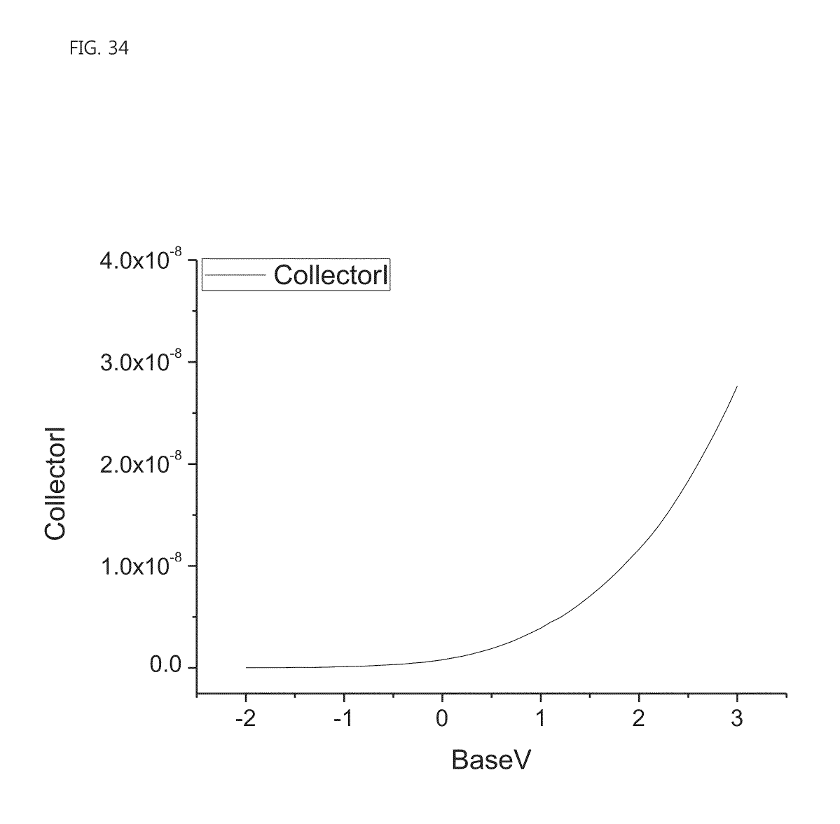

FIG. 34 shows a transistor effect of the biosensor according to the present invention illustrated in FIG. 33.

Referring to FIG. 34, collector current increases as base voltage increases. This shows that the biosensor manufactured on the plastic substrate according to the present invention exhibits a typical transistor characteristic.

Hereinafter, a method of using the biosensor manufactured according to the present invention will be described in detail referring to the attached drawings.

### Example 4

Antigen Detection

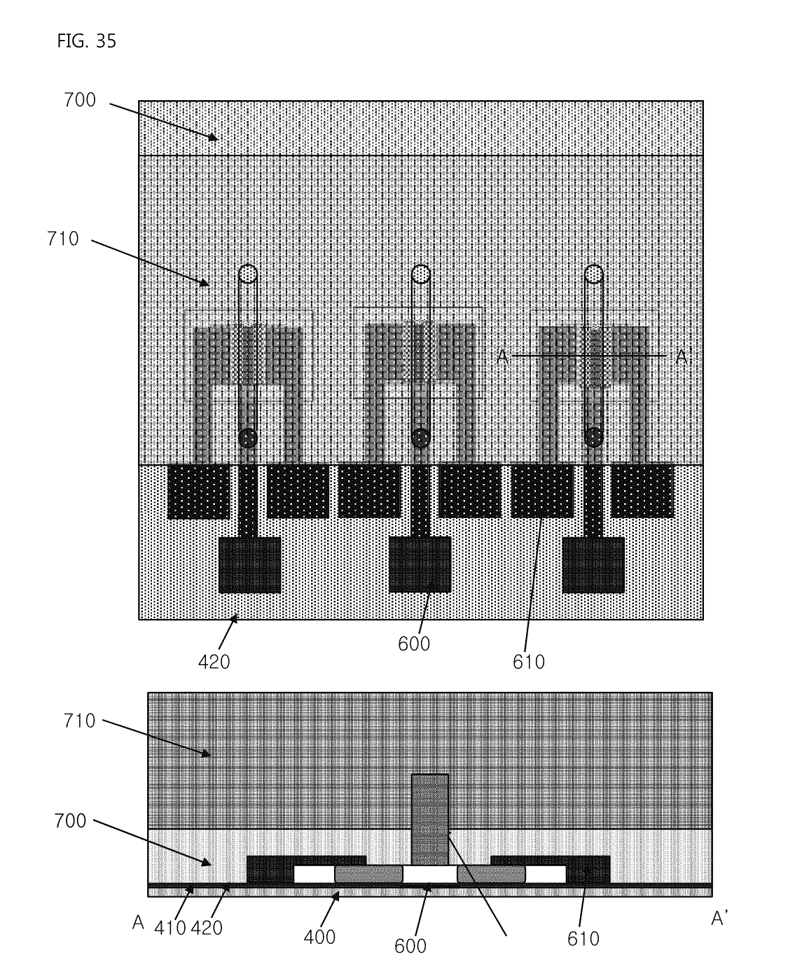

FIGS. 35 to 40 show an example of detecting an antigen using the flexible biosensor manufactured according to an embodiment of the present invention.

The base sequence and amino acid sequence of the SBP used in the experiment are as follows.

1. rplB1
5′-GCTATCGTTAAATGTAAGCCGACCTCCGCTGGTCGTCGTCACGTTGT
TAAAATCGTGAACCCTGAATTACATAAGGGTAAACCTTACGCACCTTTAT
TAGATACTAAATCTAAAACTGGTGGTCGTAATAATTTAGGACGTATCACT
ACTCGTCATATCGGTGGTGGTCATAAACAA-3′
RplB1
H₂N-AIVKCKPTSAGRRHVVKIVNPELHKGKPYAPLLDTKSKTGGRNNLG
RITTRHIGGGHKQ-COOH
2. rplB2
5′-GTACTTGGTAAAGCCGGTGCCAACCGCTGGAGAGGCGTTCGCCCTAC
AGTTCGCGGTACTGCGATGAACCCGGTAGATCACCCGCACGGTGGTGGTG
AAGGTCGTAACTTTGGTAAACACCCGGTATCACCTTGGGGCGTTCAAACC
AAAGGTAAGAAAACTCGTCACAACAAACGTACCGATAAATATATCGTACG
TCGTCGTGGCAAA-3′
RplB2
H₂N-VLGKAGANRWRGVRPTVRGTAMNPVDHPHGGGEGRNFGKHPVSPWG
VQTKGKKTRHNKRTDKYIVRRRGK-COOH
3. rplB12
5′-ATGGCTATCGTTAAATGTAAGCCGACCTCCGCTGGTCGTCGTCACGT
TGTTAAAATCGTGAACCCTGAATTACATAAGGGTAAACCTTACGCACCTT
TATTAGATACTAAATCTAAAACTGGTGGTCGTAATAATTTAGGACGTATC
ACTACTCGTCATATCGGTGGTGGTCATAAACAAgtcgacGTACTTGGTAA
AGCCGGTGCCAACCGCTGGAGAGGCGTTCGCCCTACAGTTCGCGGTACTG
CGATGAACCCGGTAGATCACCCGCACGGTGGTGGTGAAGGTCGTAACTTT
GGTAAACACCCGGTATCACCTTGGGGCGTTCAAACCAAAGGTAAGAAAAC
TCGTCACAACAAACGTACCGATAAATATATCGTACGTCGTCGTGGCAAA-
3′
RplB12
H₂N-MAIVKCKPTSAGRRHVVKIVNPELHKGKPYAPLLDTKSKTGGRNNL
GRITTRHIGGGHKQVDVLGKAGANRWRGVRPTVRGTAMNPVDHPHGGGEG
RNFGKHPVSPWGVQTKGKKTRHNKRTDKYIVRRRGK-COOH

In another embodiment of the present invention, SBP having the following base sequence and amino acid sequence is used.

SBP1-coding gene
5′-ATGAGCCCACACCCGCACCCACGTCACCATCACACC-3′
SBP1
H₂N-MSPHPHPRHHHT-COOH
SBP5-coding gene
5′-AAACCGAGCCACCACCACCACCACACCGGCGCGAAC-3′
SBP5
H₂N-KPSHHHHHTGAN-COOH
SBP10-coding gene
5′-CGTGGCCGTCGTCGTCGTCTGTCTTGCCGTCTGCTG-3′
SBP10
H₂N-RGRRRRLSCRLL-COOH

In the present invention, a fused protein of the SBP protein and Protein A or G is used as a biologically active substance. The fused protein is formed by fusion of the SBP, which binds specifically to silica, and the two proteins, which bind specifically to the antibody. First, the fused protein is immobilized on the gate region of the silicon substrate by the SBP.

The amino acid sequences of Protein A and G, which are used as SpA and SpG respectively, are as follows.

Protein A
H₂N-AQHDEAQQNAFYQVLNMPNLNADQRNGFIQSLKDDPSQSANVLGEA
QKLNDSQAPKADAQQNNFNKDQQSAFYEILNMPNLNEAQRNGFIQSLKDD
PSQSTNVLGEAKKLNESQAPKADNNFNKEQQNAFYEILNMPNLNEEQRNG
FIQSLKDDPSQSANLLSEAKKLNESQAPKADNKFNKEQQNAFYEILHLPN
LNEEQRNGFIQSLKDDPSVSKEILAEAKKLNDAQAPKEEDNKKPGKEDGN
KPGKEDGNKPGKEDNKKPGKEDGNKPGKEDNNKPGKEDGNKPGKEDNNKP
GKEDGNKPGKEDGNKPGKEDGNGVHVVKPGDTVNDIAKANGTTADKIAAD
NKLADKNMIKPGQELVVDKKQPANHADANKAQALPETGEENPFIGTTVFG
GLSLALGAALLAGRRREL-COOH
Protein G
H₂N-LKGETTTEAVDAATAEKVFKQYANDNGVDGEWTYDDATKTFTVTEK
PEVIDASELTPAVTTYKLVINGKTLKGETTTEAVDAATAEKVFKQYANDN
GVDGEWTYDDATKTFTVTEKPEVIDASELTPAVTTYKLVINGKTLKGETT
TKAVDAETAEKAFKQYANDNGVDGVWTYDDATKTFTVTE-COOH

The fused protein is synthesized as follows. A recombinant vector including a gene that encodes the SBP and a gene that encodes Protein G (or A) and designed such that the two genes are expressed in fused form is inserted into E. coli to transform them. The transformed microorganisms are cultured to express the fused protein of SBP and Protein G (SBP-SpG). Then, the cells in which the fused protein is expressed are recovered and pulverized. The aqueous fraction containing the fusedprotein is isolated. Asa result, the biologically active substance that binds specifically to the silicon substrate is obtained.

Referring to FIG. 35, the microfluidic channel of the biosensor of FIG. 33 is washed by flowing PBS through the channel. Then, the biologically active substance comprising SBP is flown. As a result, the biologically active substance binds specifically to the gate region of the silicon substrate and is immobilized.

Then, by flowing PBS again through the microfluidic channel, all residual byproducts are removed from the microfluidic channel and the silicon substrate. As described above, the introduction and discharge of PBS or other fluid are carried out using the holes provided at the cover layer 710.

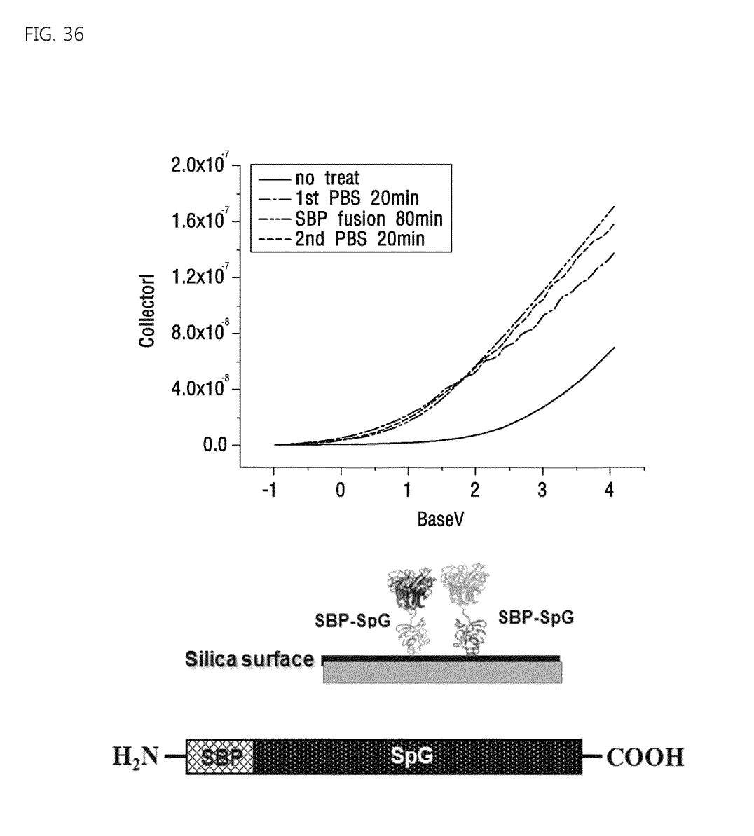

FIG. 36 shows the change of collector current caused by binding with SBP.

Referring to FIG. 36, at the same base voltage, collector current increases by the SBP binding.

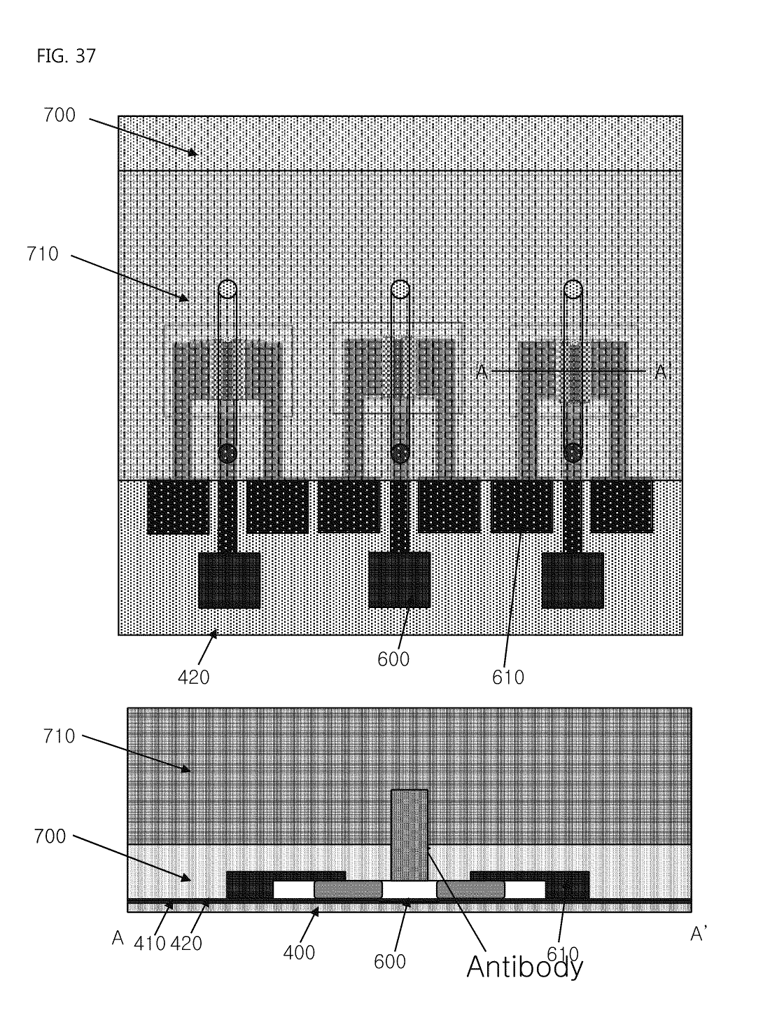

Referring to FIG. 37, antibody is flown through the microfluidic channel. The antibody binds specifically to the SpG of the fused protein immobilized on the silicon substrate (gate region).

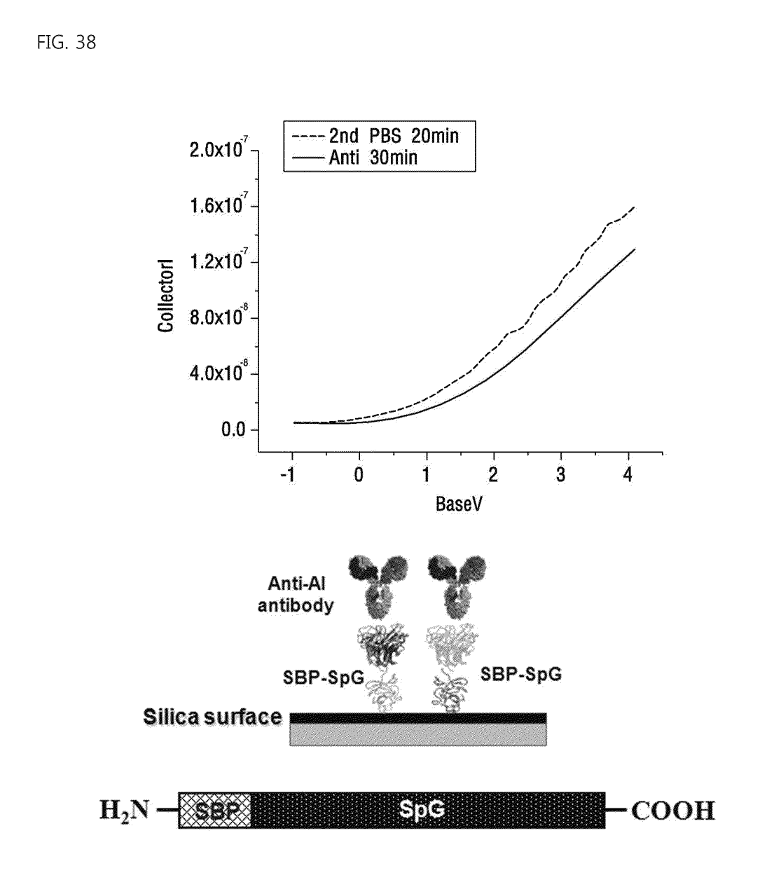

In FIG. 38, the schematic diagram below shows the antibody (anti-AI antibody) bound to SBP-SpG, and the graph above reveals that collector current changes noticeably before and after flowing the antibody.

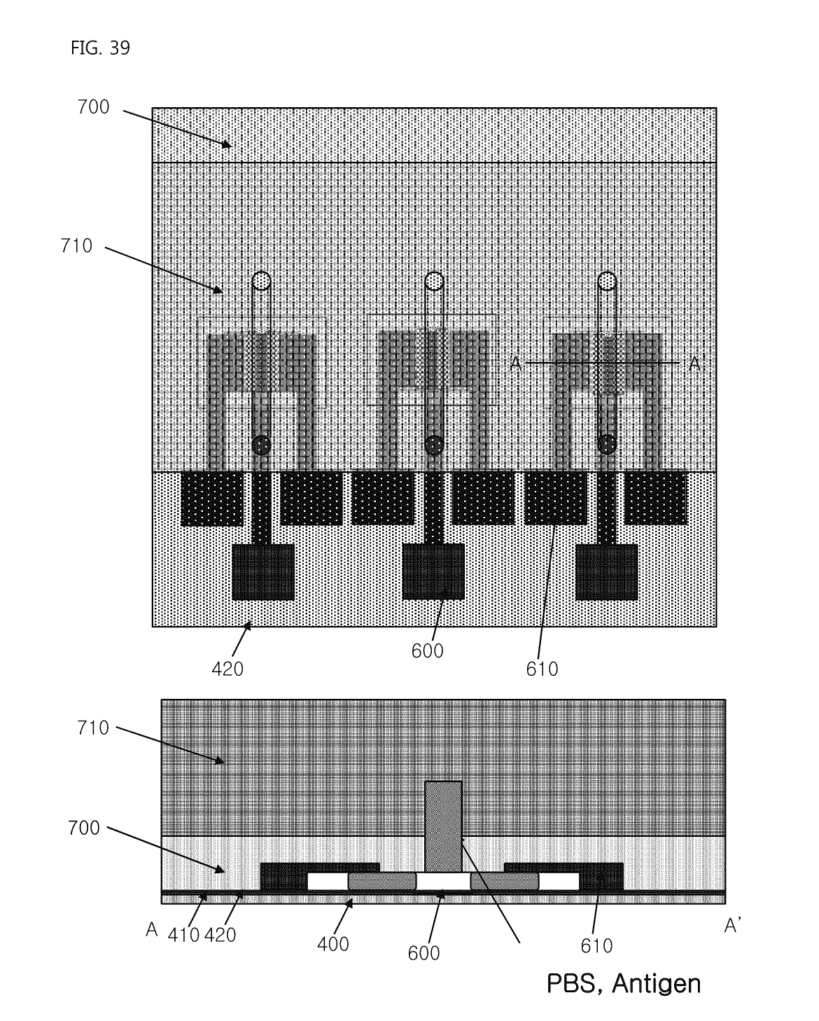

Referring to FIG. 39, the microfluidic channel is washed again with PBS, and the antigen is flown through the microfluidic channel. As a result, the antibody bound to the gate region of the silica substrate binds specifically to the antigen, and current changes.

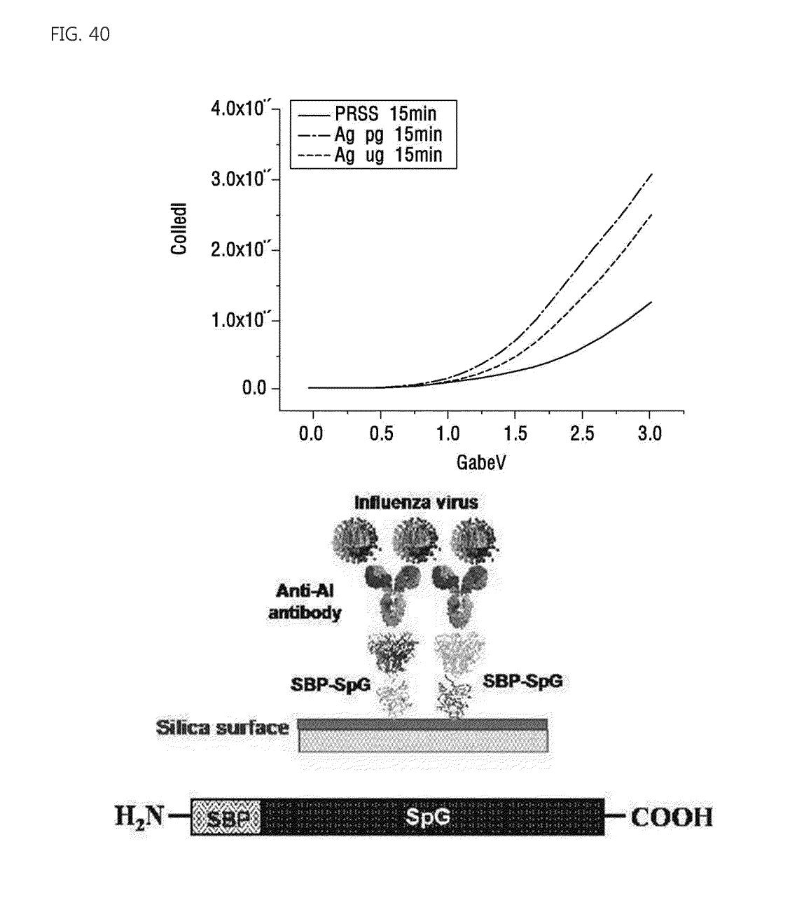

In FIG. 40, the schematic diagram below shows the specific binding of the antibody immobilized on the silicon substrate and the antigen, and the graph above reveals that collector current changes noticeably due to the antibody-antigen binding.

In another embodiment of the present invention, there are provided a method for manufacturing a flexible biosensor using laser, a flexible biosensor manufactured thereby, and a detection method using the same. The biosensor according to the present invention can effectively overcome the limitation of the existing biosensor embodied on a silicon substrate and can be manufactured by an economical method. Hereinafter, the method for manufacturing a biosensor according to the present invention will be described in detail referring to the attached drawings.

### Example 5

Manufacture of Biosensor Using Laser

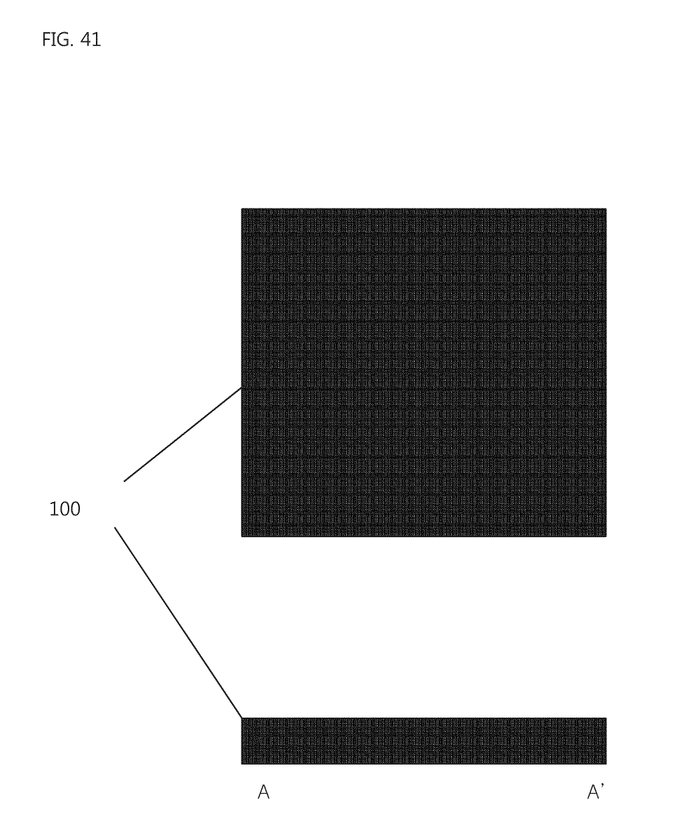

FIGS. 41 to 52 show aprocess of manufacturing a biosensor according to an embodiment of the present invention.

Referring to FIG. 41, a flexible substrate 100, e.g. a plastic substrate, not a hard substrate such as a silicon substrate, is provided. That is to say, according to this embodiment of the present invention, a biosensor is manufactured directly on the flexible substrate, e.g. a plastic substrate, differently from the existing art whereby all or part of a biosensor is manufactured on a silicon substrate.

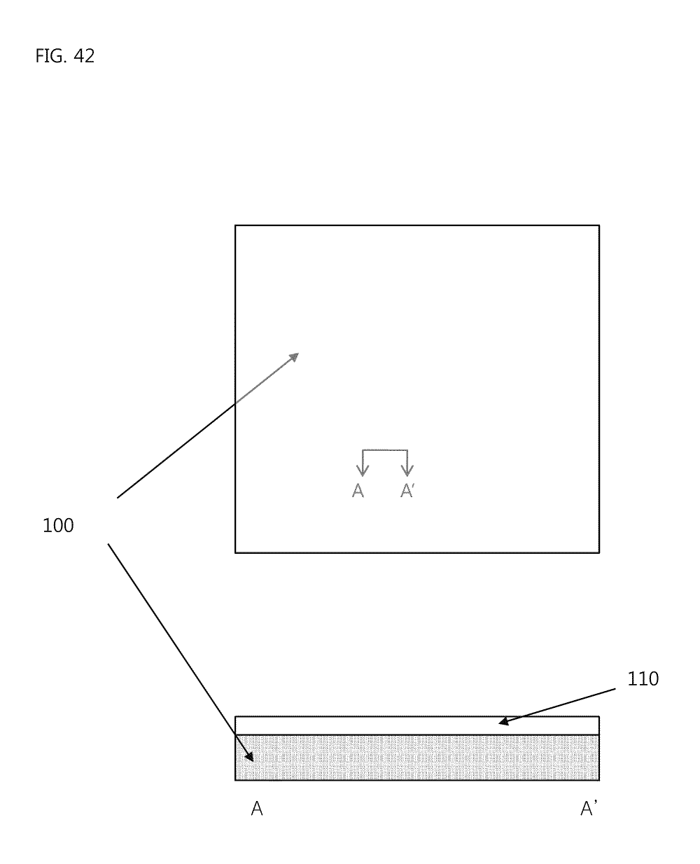

Referring to FIG. 42, a silicon oxide layer 110 is formed on the flexible substrate 100 with a predetermined thickness, for example, by plasma-enhanced chemical vapor deposition (PECVD). The oxide layer 110 functions as a kind of buffer layer.

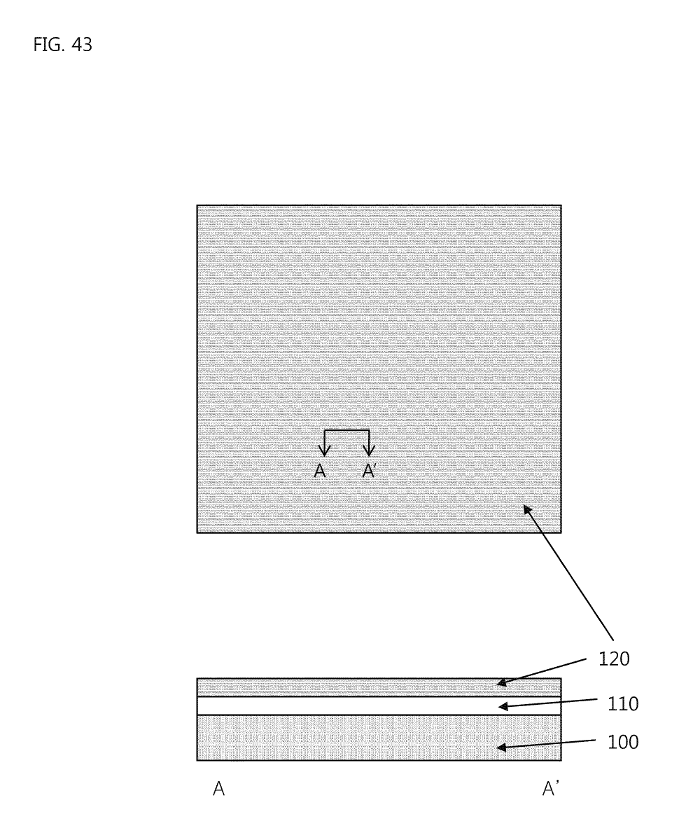

Referring to FIG. 43, a first silicon layer 120 of amorphous silicon (a-Si) is formed on the oxide layer 110. In an embodiment of the present invention, the amorphous first silicon layer is formed by PECVD.

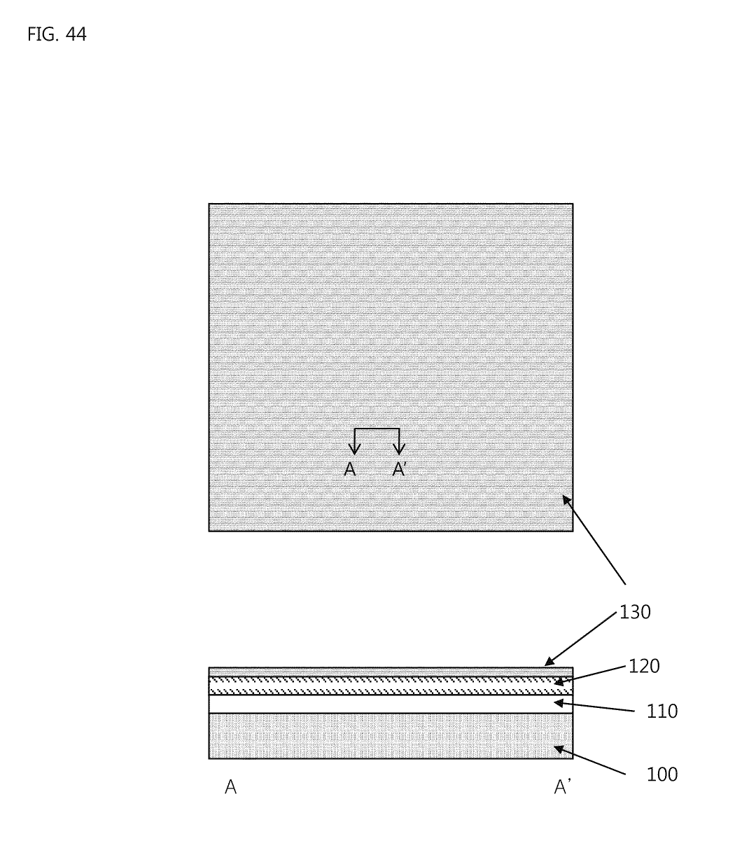

Referring to FIG. 44, a silicon doping layer 130 doped with a first type impurity is formed on the amorphous first silicon layer 120. In an embodiment of the present invention, the first type impurity may be an n-type doping layer doped with an n-type impurity, for example, phosphine (PH₃) or the like. The impurity doping may be performed by ion implantation or the like, but the present invention is not limited thereto. In an embodiment of the present invention, phosphine gas is flown while forming the amorphous silicon layer on the first silicon layer 120 by PECVD. As a result, a doping layer 130 doped with phosphine is formed on the first silicon layer 120.

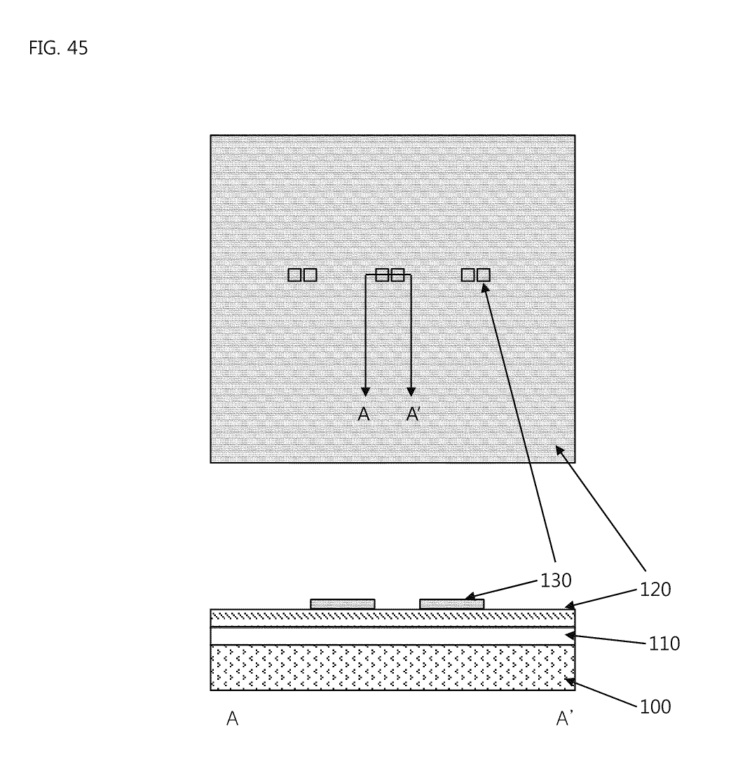

Referring to FIG. 45, the doping layer 130 is selectively etched to remain only the doping layer 130a, 130b corresponding to source and drain regions on the amorphous silicon layer 120. In an embodiment of the present invention, the doping layer may be removed by a wet etching process after patterning a mask via a photolithographic process.

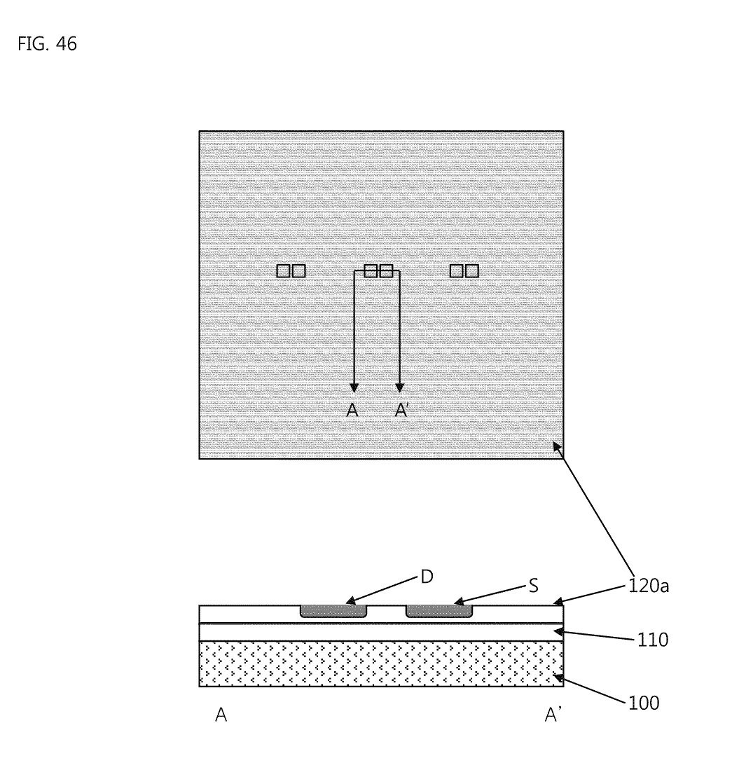

Referring to FIG. 46, the amorphous first silicon layer 120 is crystallized using laser. In an embodiment of the present invention, excimer laser, which is created when an unstable excited dimer resulting from a mixture of two gases sealed in a vacuum container produces high-power ultraviolet (UV) beam as it is decomposed, is used for the crystallization of the amorphous silicon. The excimer laser is highly compatible with semiconductor materials since it gives high and uniform output, uniquely as a UV light source, shows little diffraction, and interaction with material occurs by a chemical process, without thermal process. Especially, when heat treatment and crystallization are carried out using laser, instead of RTP, thermal load becomes almost zero (0). Since a laser pulse is irradiated for a duration of time shorter by about 108 nanoseconds than RTP, crystallization may be attained even on the plastic substrate if a thermal block layer is provided. In the present invention, a semiconductor-based biosensor is manufactured directly on the flexible substrate, which is susceptible to heat, based on the fact. The laser treatment according to the present invention is advantageous in that thermal treatment is possible in a local and selective region. That is to say, when compared with RTP whereby the whole wafer is thermally treated under the same condition, the laser technique enables high-temperature thermal treatment in a local and selective region, thereby avoiding ineffective crystallization in the unwanted region.

In the present invention, excimer laser is directly irradiated onto the silicon substrate formed on the flexible substrate. As a result, the amorphous first silicon layer 120 is crystallized, and the first type impurity (n-type impurity) of the doping layer with the source and drain regions formed is diffused into the amorphous silicon layer 120 therebelow, thereby forming source and drain regions S, D in a first silicon layer 120a. Then, the doping layer is removed by a photolithographic process, a dry etching process, or the like. As a result, source and drain regions doped with the n-type impurity are formed in predetermined regions of the crystallized first silicon layer 120a.

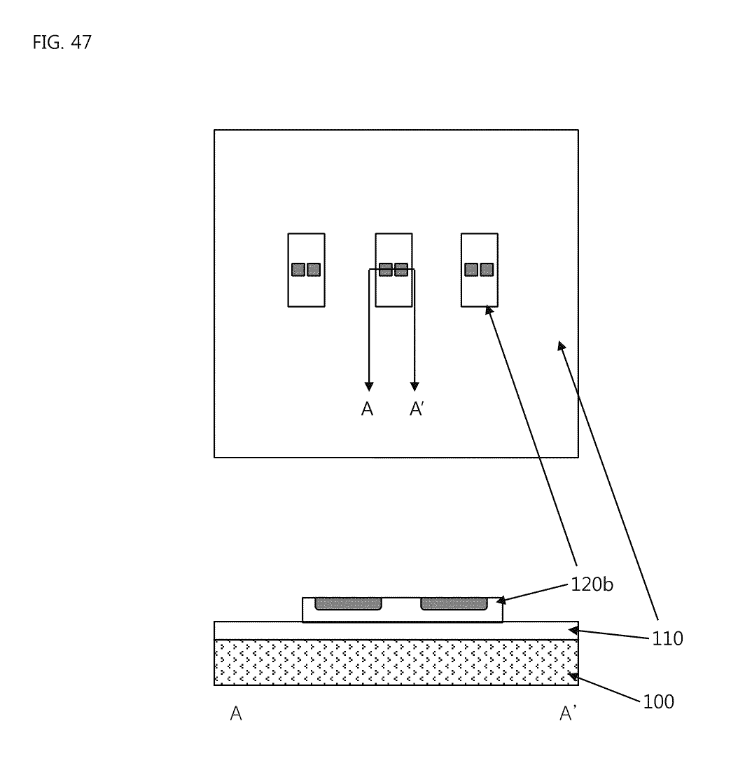

Referring to FIG. 47, the crystallized first silicon layer 120a is patterned to form a device substrate of a biosensor transistor (hereinafter, biodevice substrate 120b) including the source and drain regions.

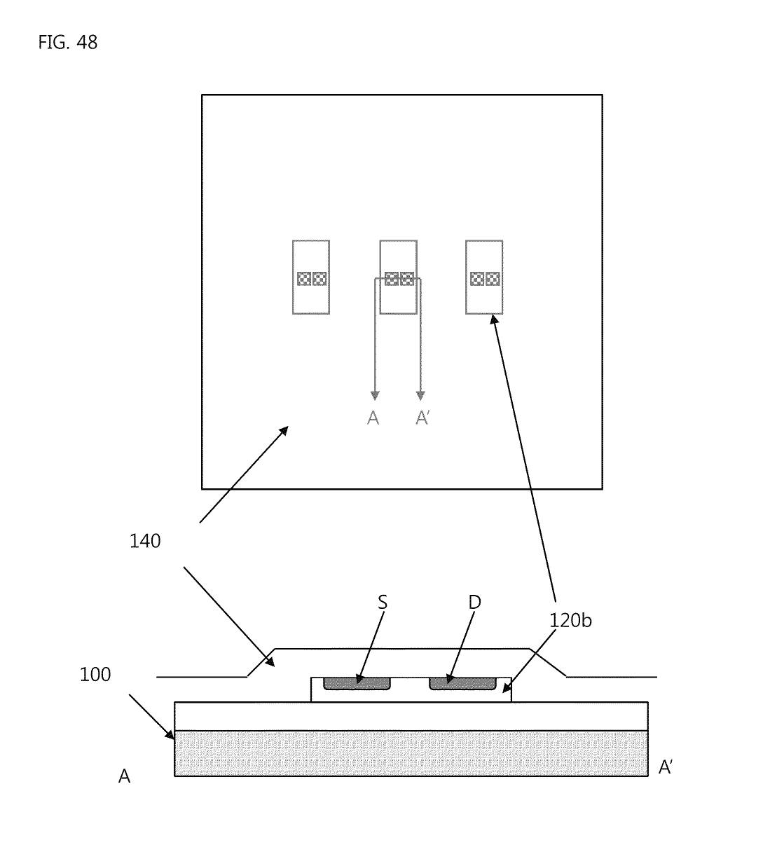

Referring to FIG. 48, an insulating layer 140 of, for example, silicon oxide is formed on the biodevice substrate 120b. The insulating layer 140 may be formed by CVD, and the insulating layer 140 functions as a gate oxide film of the silicon substrate between the source and drain S, D.

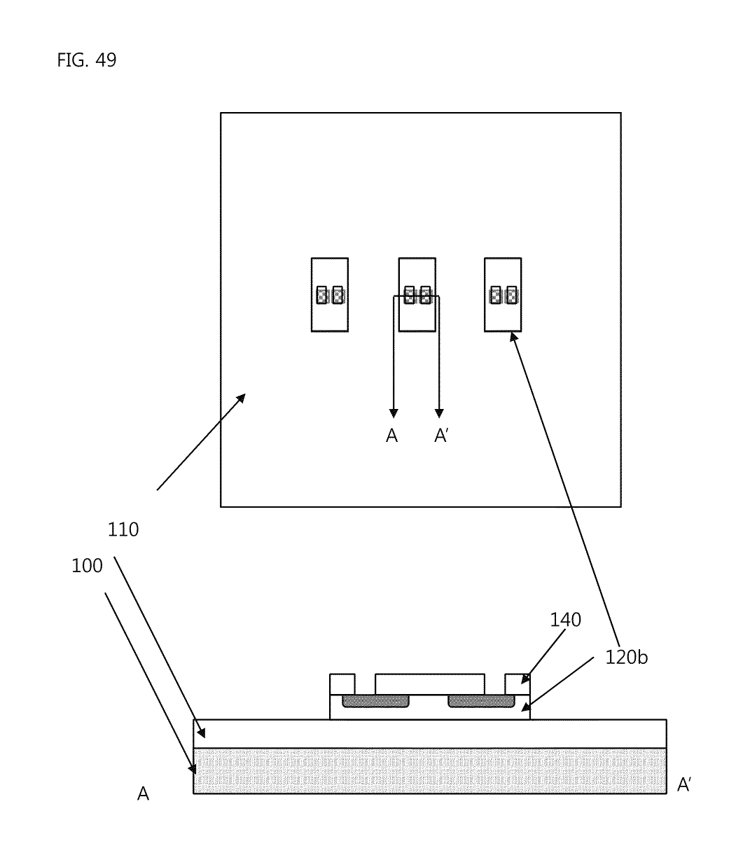

Referring to FIG. 49, the insulating layer 140 is patterned and the source and drain S, D regions of the biodevice substrate 120b are exposed. The insulating layer 140 remains on a gate region therebetween. Later, the insulating layer 140 on the gate region functions as a gate oxide film.

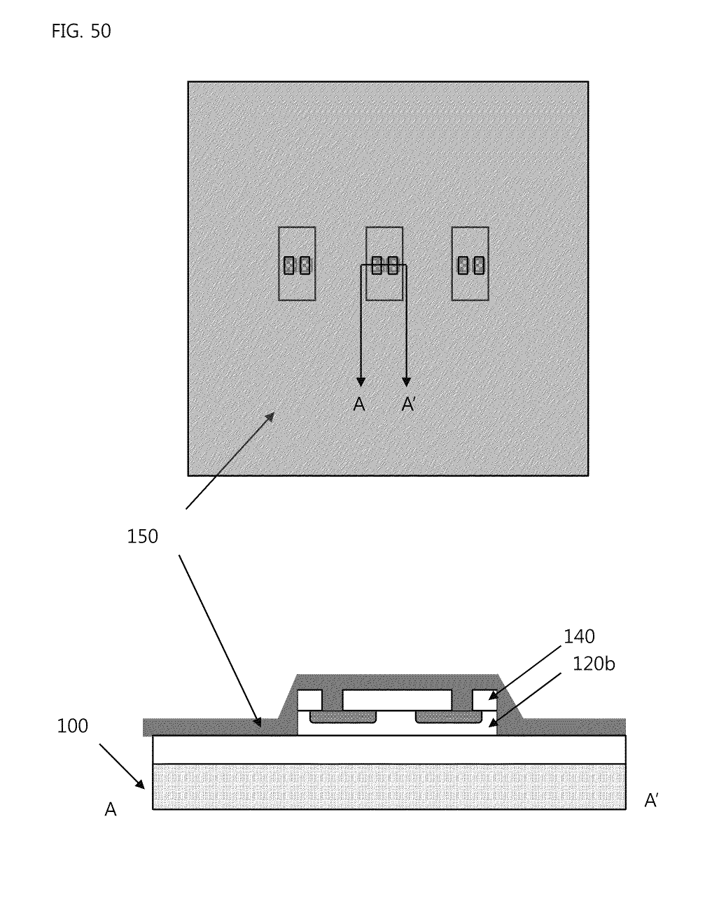

Referring to FIG. 50, a metal layer 150 is formed on the insulating layer 140. As a result, source and drain electrodes that are in direct contact with the source and drain regions are formed. Further, a gate electrode is formed on the biodevice substrate with the insulating layer therebetween.

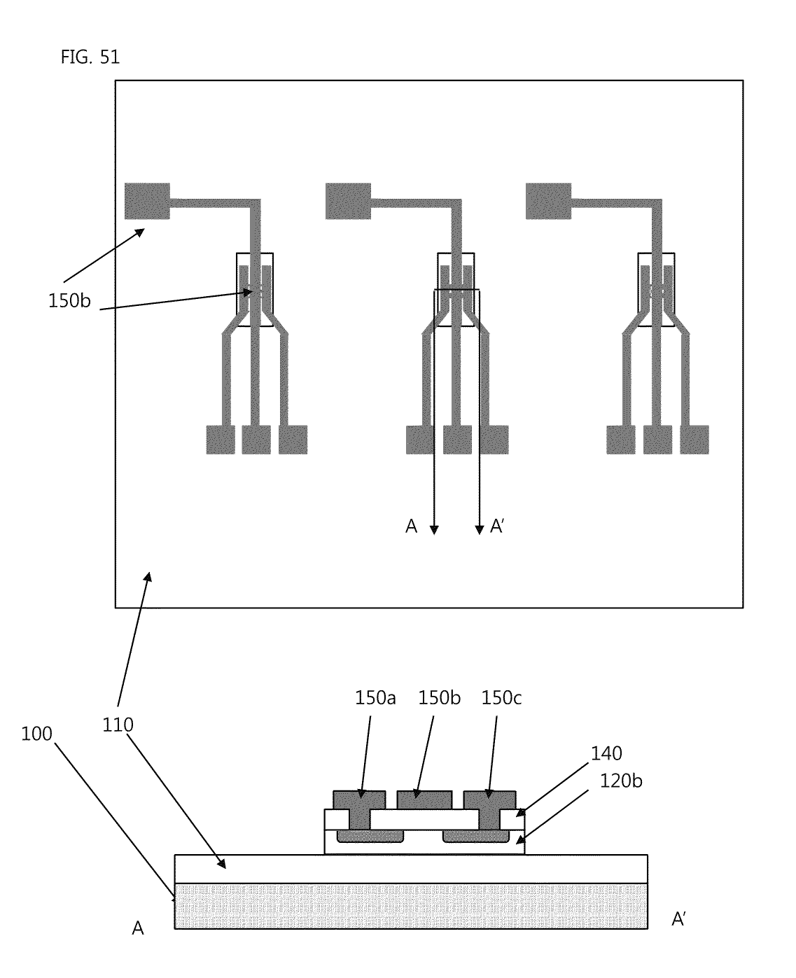

Referring to FIG. 51, the metal layer 150 is patterned, and the source and drain electrodes and the gate electrode 150a, 150c, 150b are formed. Further, the source, drain and gate electrodes extend to a predetermined length and are provided with pads at the end portions. Especially, the gate electrode 150b is provided at the substrate region spaced apart from the device substrate region, and a microfluidic channel through which a biologically active substance flows is formed in the gate electrode pad region.

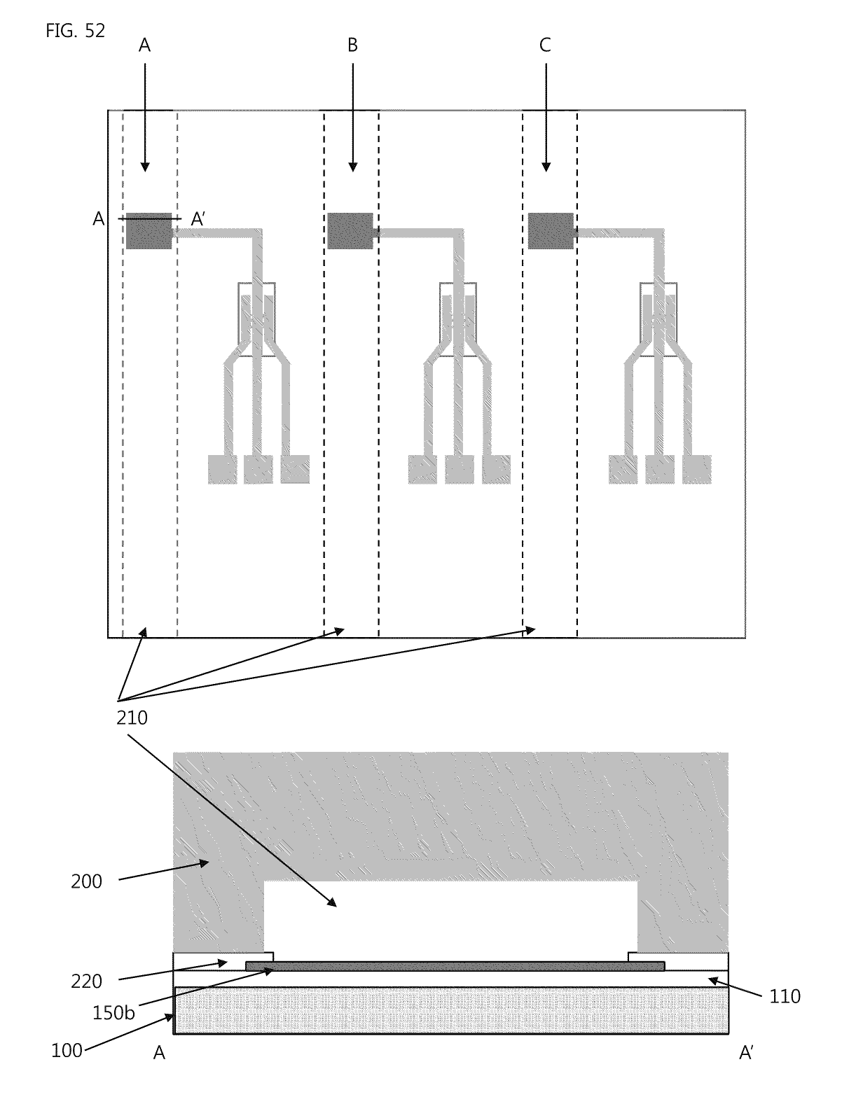

In the present invention, PDMS having a trench with a predetermined depth is used to prepare the microfluidic channel (see FIG. 52). Referring to FIG. 52, PDMS 200 having a trench 210 with a predetermined depth is brought into contact to face a gate electrode pad 150b. As the trench 210 forms a microfluidic channel 210 which passes through the gate electrode pad 150b. In an embodiment of the present invention, the electrode material is gold, and a polymer layer 220 of, for example, SU-8 may be formed between the PDMS 200 and the silicon oxide layer 110 for sealing between the PDMS and the flexible substrate. As a result, a flexible transistor type biosensor capable of detecting change in current caused by voltage change due to reaction with a biomaterial on the gate electrode pad is manufactured.

Hereinafter, an example of detecting a biologically active substance using a flexible biosensor according to an embodiment of the present invention will be described in detail.

### Experimental Example 1

Detection of Protein using Gold Binding Substance

### Experimental Example 1-1

Immobilization of Antigen

A fused protein (GBP-fused protein) formed from fusion of GBP and a wanted target protein is flown through the microfluidic channel to immobilize the fused protein on the gate electrode pad 150b.

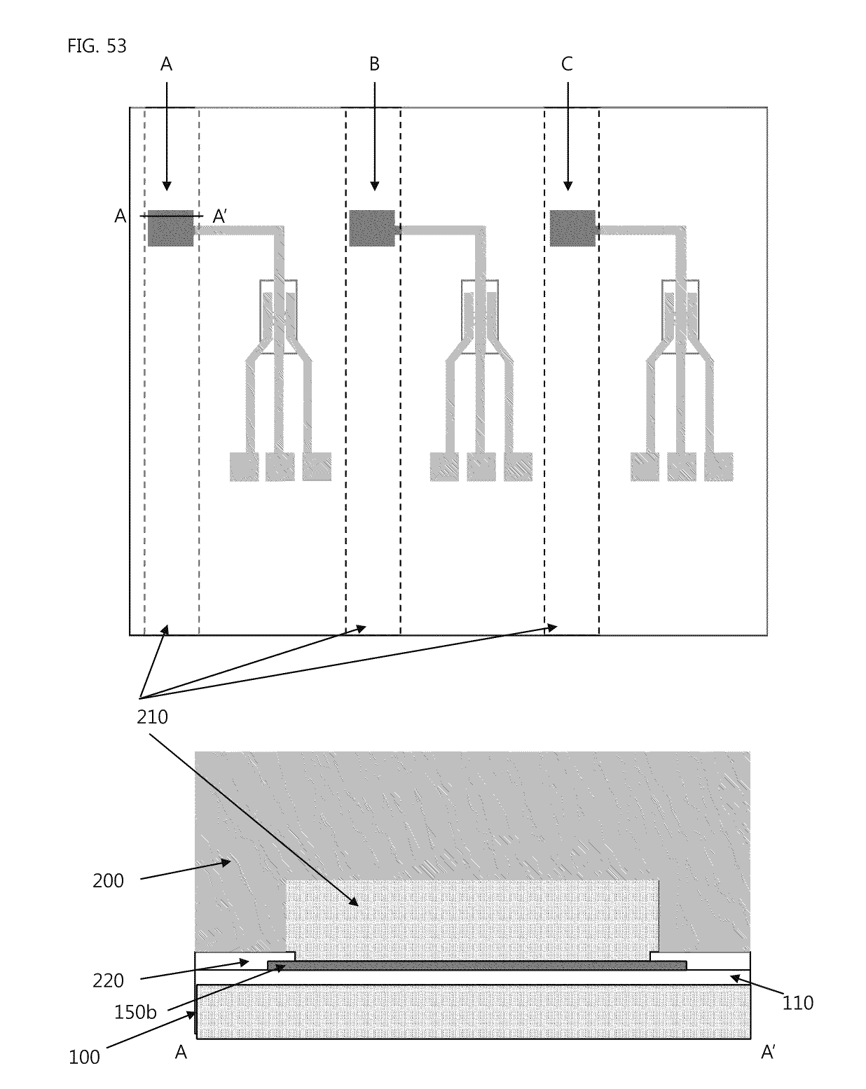

FIGS. 53 to 56 show an example of detecting protein using the biosensor according to an embodiment of the present invention.

Referring to FIG. 53, the GBP-fused protein is flown through the microfluidic channel 210 of the biosensor according to the present invention. The GBP-fused protein specifically binds to and is immobilized on the gate electrode pad 150b. In this example, the target protein is an avian influenza viral surface antigen (Korea specific H5N1 & H9N2 AIa) fused with GBP. The GBP used in this example has the same base sequence and amino acid sequence as those of Example 1.

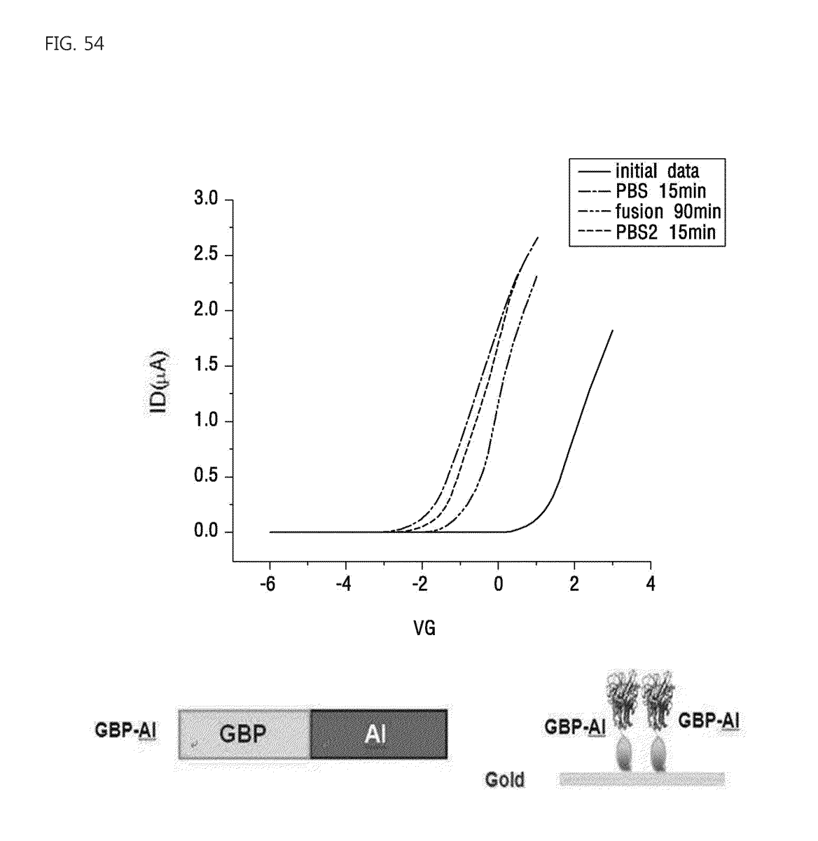

Referring to FIG. 54 reveals that that the GBP-antigen fused protein (GBP-AIa) is bound to and immobilized on the gold electrode pad 150b. Thus, current change resulting from the voltage change of the gate electrode is detected (see the graph above).

### Experimental Example 1-2

Antibody Detection

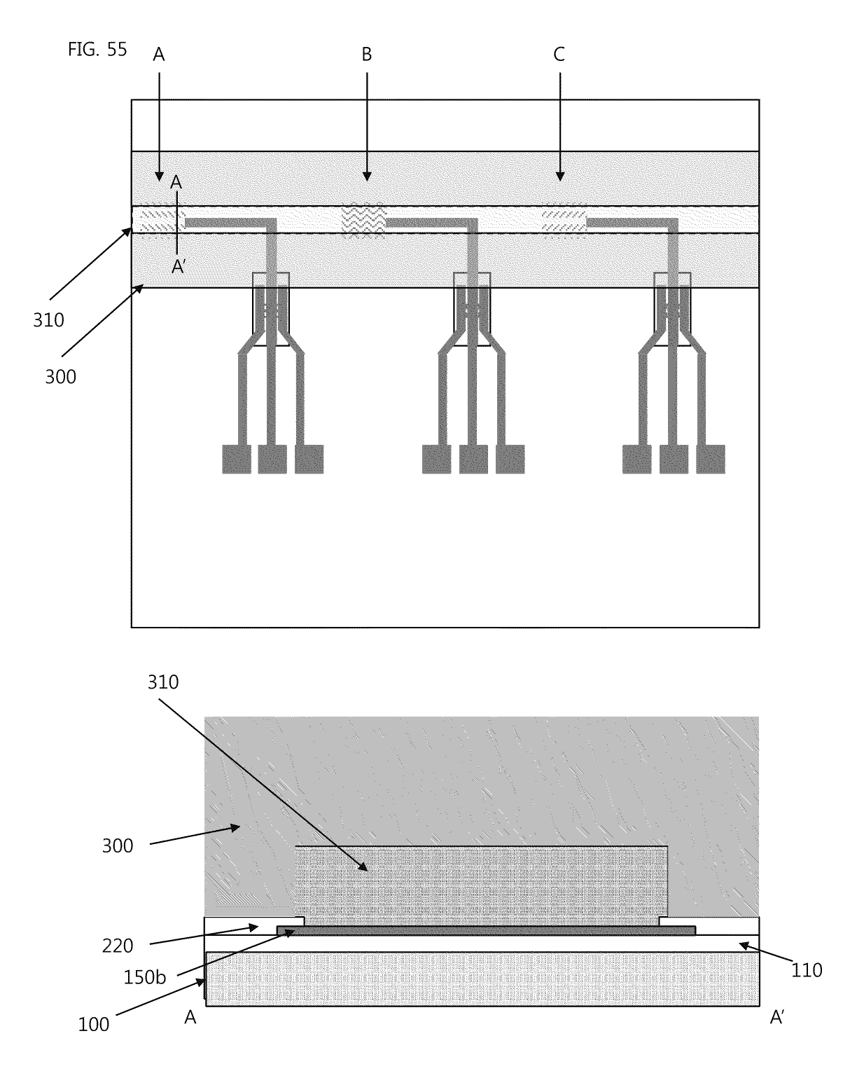

Referring to FIG. 55, the same or different microfluidic channel 310 which passes through the gate electrode pad 150b on which the GBP-antigen fused protein is bound is provided. A target substance comprising an antibody is flown through the microfluidic channel 310. If the target substance includes an antibody specifically binding to the antigen, a specific binding occurs between the antigen and the antibody and, as a result, the voltage of the gate electrode 150b changes. As described above, the microfluidic channel 310 may be formed by contacting a trench having predetermined depth and width to face the gate electrode pad 150b.

In an embodiment of the present invention, the target substance flows through another microfluidic channel which passes through a plurality of gate electrode pads A, B, C. Thus, a plurality of antigens for the same antibody may be detected at the same time. However, the scope of the present invention is not limited thereto.

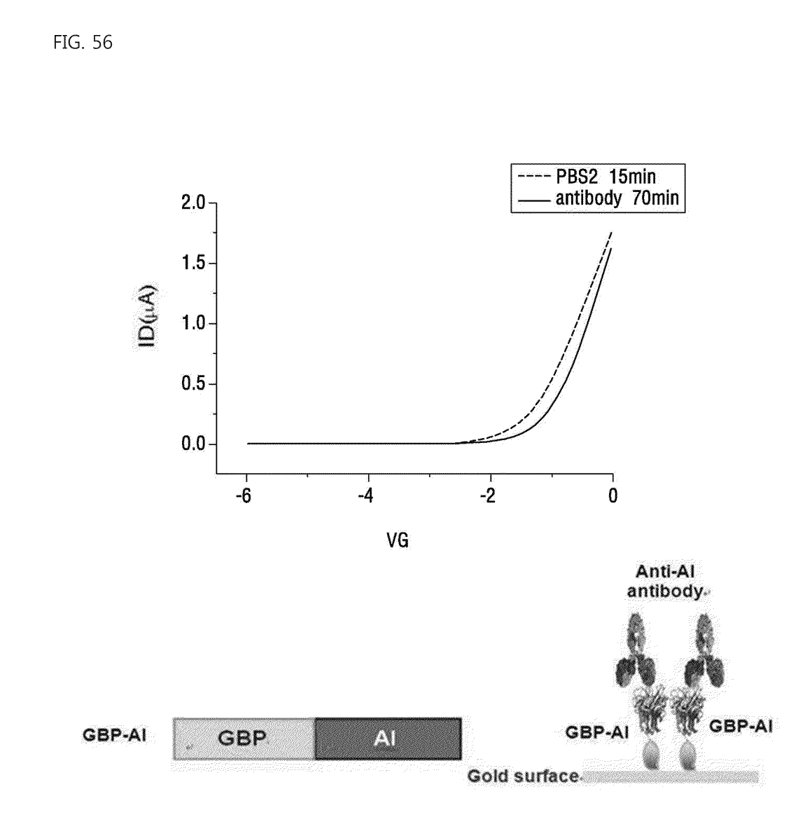

FIG. 56 shows a schematic diagram of antigen-antibody binding and change in current resulting therefrom. In this example, the antibody is an avian influenza antibody which specifically binds to the AIa antigen. Referring to FIG. 56, a noticeable change in gate voltage and current is detected due to the antigen-antibody binding.

Hereinafter, an example of detecting a biologically active substance using a flexible biosensor according to another embodiment of the present invention will be described in detail.

### Experimental Example 2

DNA Detection

The biosensor according to the present invention is capable of detecting DNA as well as protein. It detects DNA based on specific hybridization of target DNA and detecting DNA.

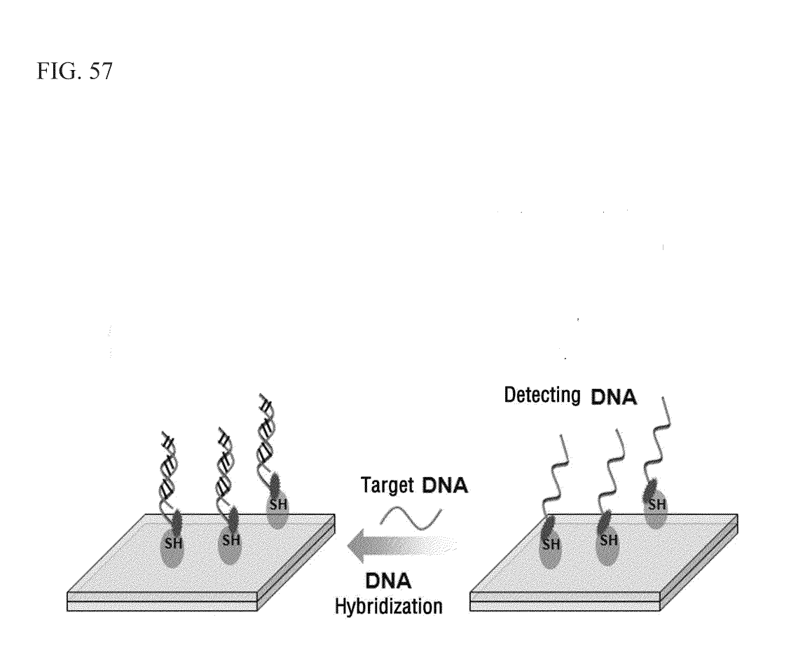

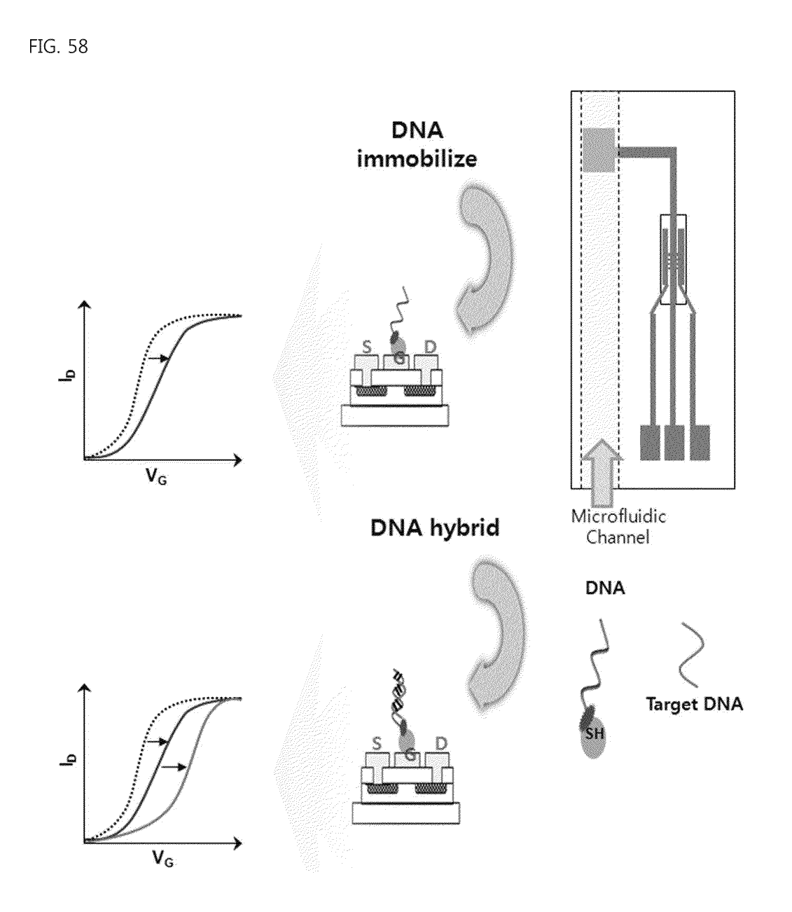

FIGS. 57 and 58 shows an example of detecting DNA using a biosensor according to another embodiment of the present invention. FIG. 57 schematically shows a process of detecting DNA according to an embodiment of the present invention.

Referring to FIG. 57, a single-stranded DNA having a terminal thiol group (—SH) is bound to the gate electrode pad (gold electrode pad). As a result, the single-stranded DNA having a terminal thiol group is immobilized on the gate electrode pad as a detecting DNA (probe DNA). Thereafter, a target DNA is flown through the microfluidic channel. If the target DNA has a base sequence complementary to that of the detecting DNA, hybridization occurs between the target DNA and the detecting DNA. As a result of the hybridization, the voltage of the gate electrode changes, and change in current is detected.

FIG. 58 schematically shows the change in current resulting from the DNA hybridization.

Referring to FIG. 58, change in current occurs as the detecting DNA having a terminal thiol group is immobilized on the gate electrode pad (upper portion of the figure). Also, change in current occurs as a result of hybridization with the target DNA (lower portion of the figure).

### Example 2

Manufacture of Biosensor using Silicon Binding Substance

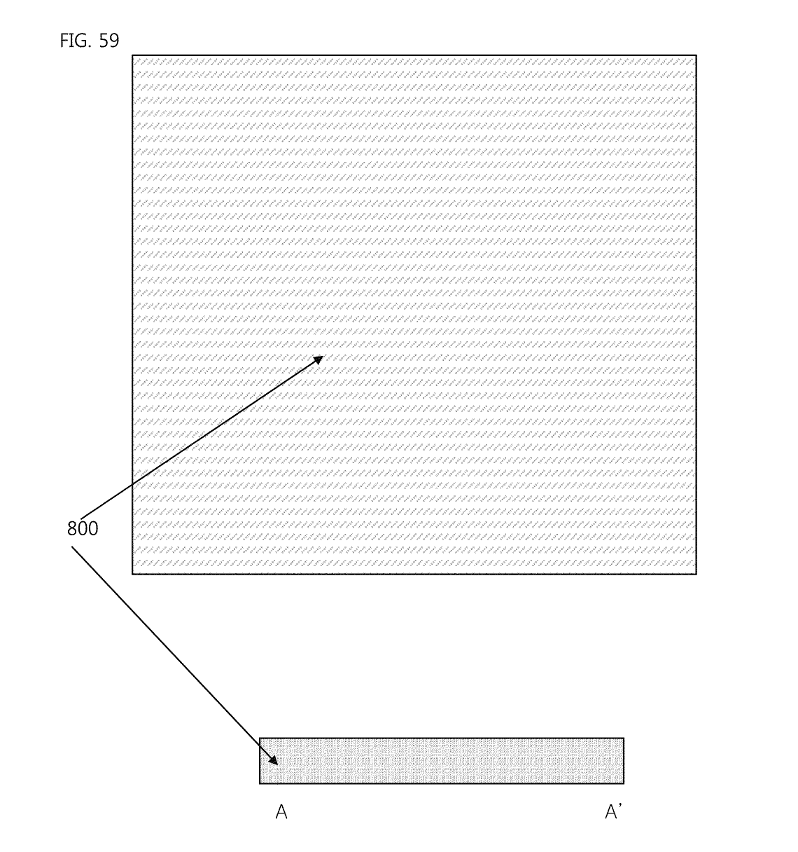

FIGS. 59 to 70 show a process of manufacturing a biosensor using a silicon binding substance.

Referring to FIG. 59, a flexible substrate 800, e.g. a plastic substrate, is provided.

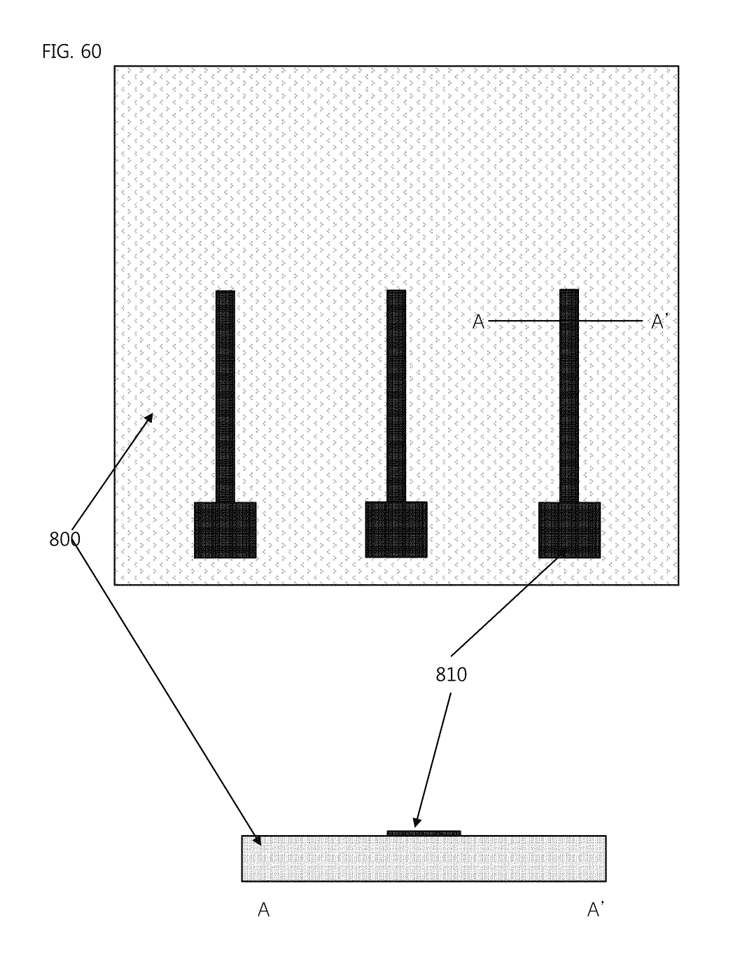

Referring to FIG. 60, a lower gate electrode 810 is formed on the plastic substrate 800.

In an embodiment of the present invention, the lower gate electrode 810 may comprise chromium (Cr) and gold (Au), but the present invention is not limited thereto.

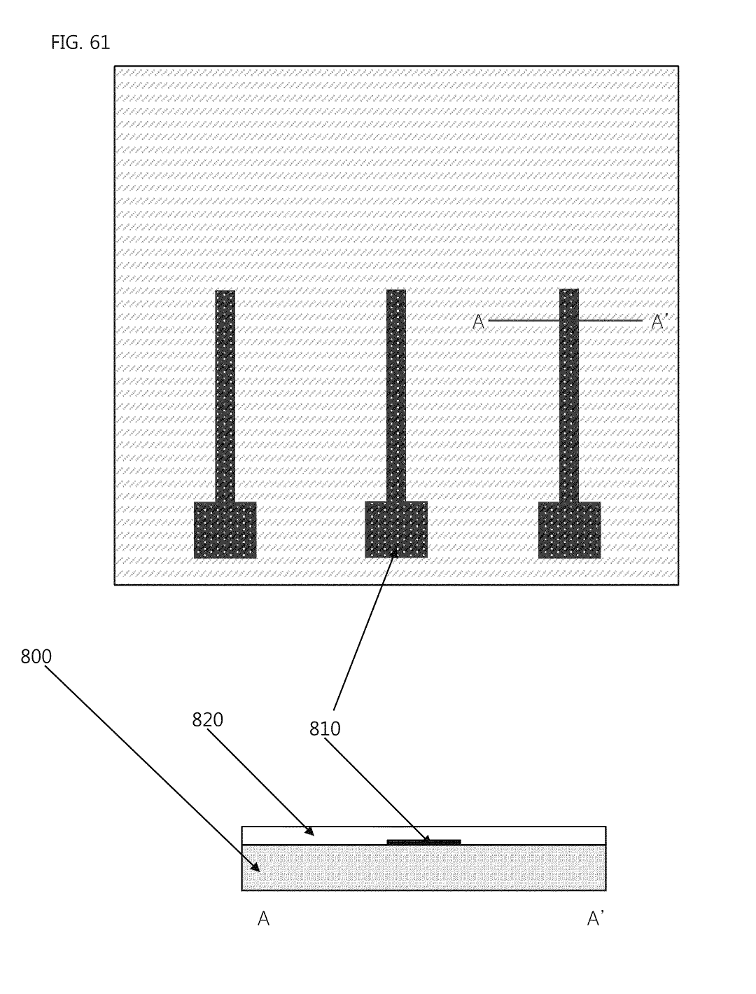

Referring to FIG. 61, a gate insulating layer 820 with a predetermined height is formed on the lower gate electrode 810 and the plastic substrate 800. As a result, the gate electrode 810 is electrically insulated from a device thereabove. The gate insulating layer 820 may comprise, for example, silicon oxide (SiO₂) and may be formed, for example, by PECVD.

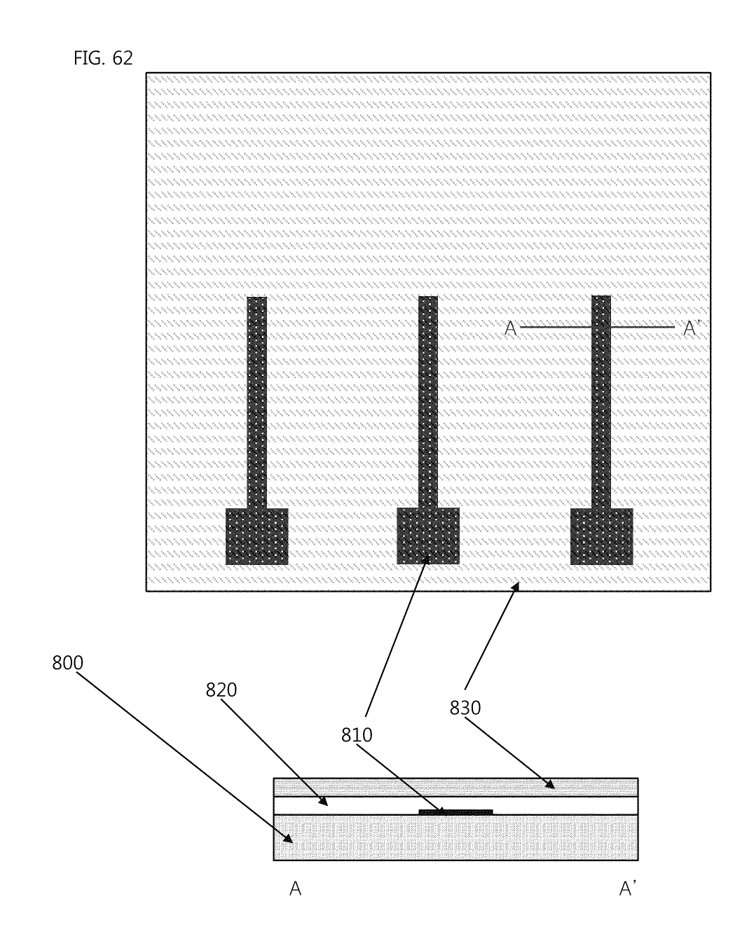

Referring to FIG. 62, an amorphous first silicon layer 830 is formed on the insulating layer 820. The amorphous first silicon layer may be formed, for example, by PECVD.

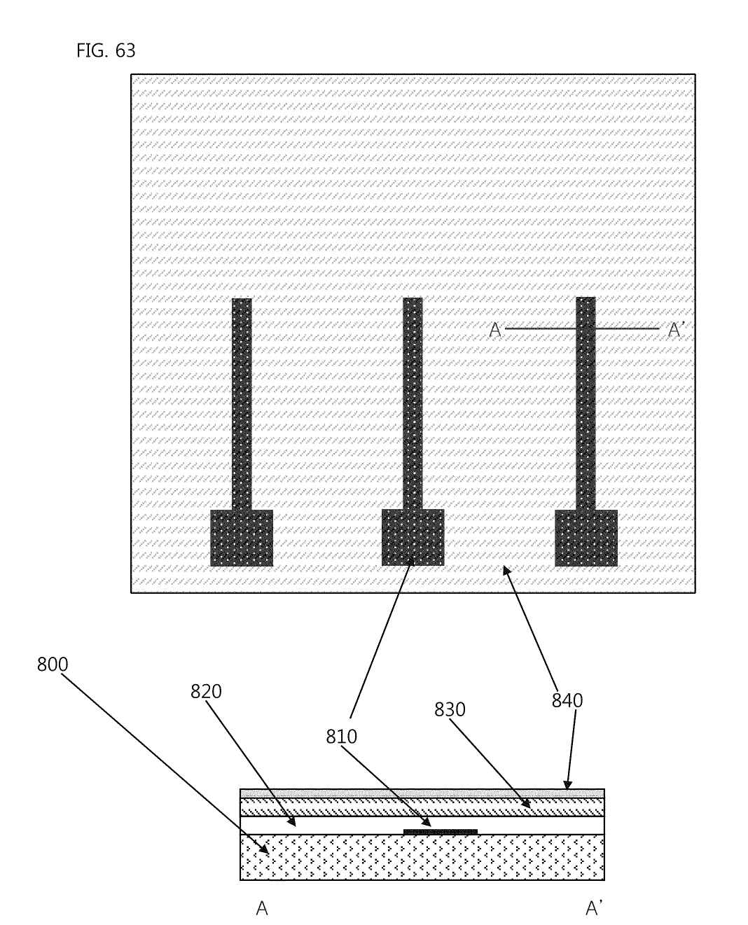

Referring to FIG. 63, a doping layer 840 doped with an n-type impurity as a first type impurity is formed on the first silicon layer 830. The doping layer 840 may be formed in the same manner as Example 1.

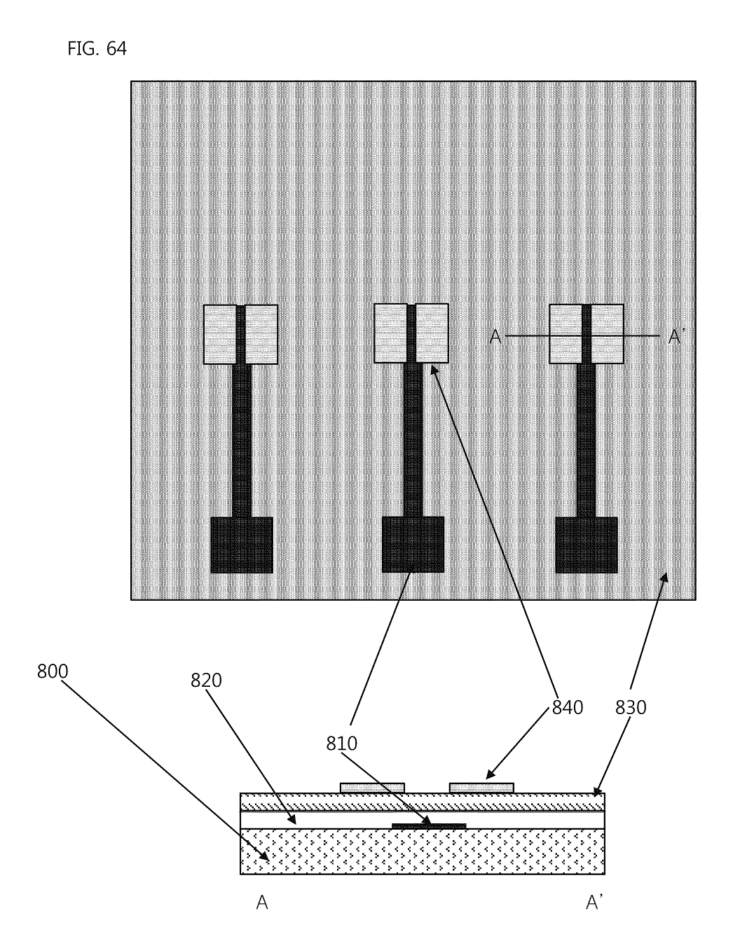

Referring to FIG. 64, the doping layer 840 is patterned to mach source and drain regions spaced with a predetermined gap. Here, the source and drain regions refer to the substrate regions of a transistor where source and drain electrodes are formed. In particular, in the present invention, the source and drain regions of the transistor are formed by diffusing the impurity of the doping layer 840 to a silicon substrate diffusion therebelow. As described above, the diffusion may be accomplished by laser treatment.

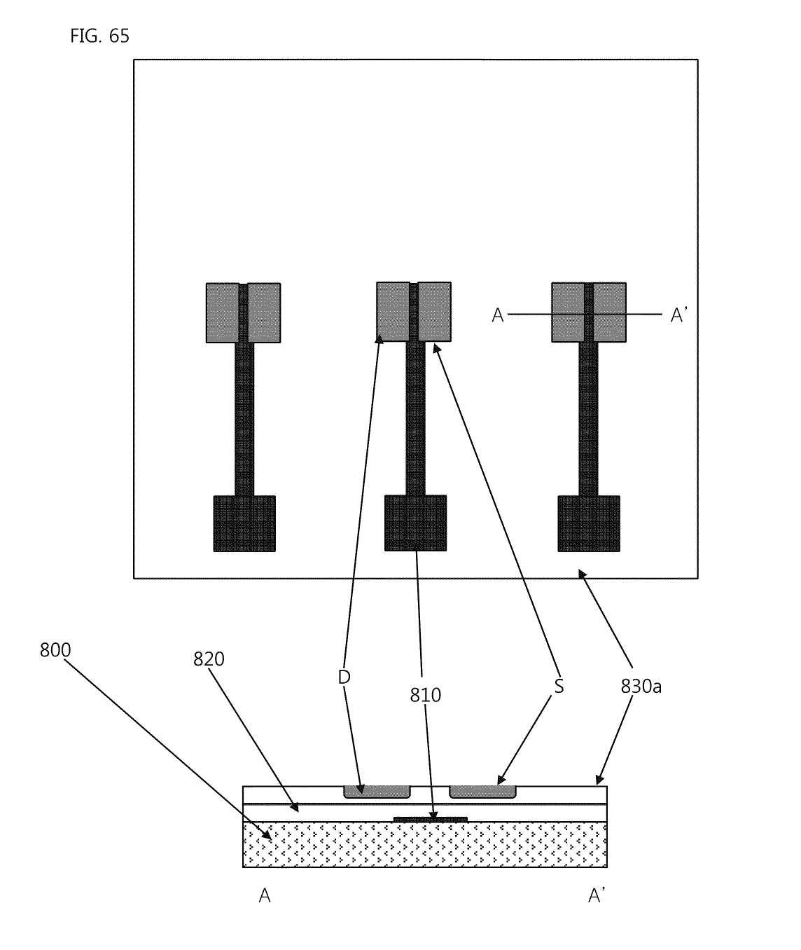

Referring to FIG. 65, the amorphous first silicon layer 830 and the patterned doping layer 840 are treated with laser. As a result, the amorphous silicon is crystallized and the first type impurity of the doping layer is diffused to a first silicon layer therebelow, thereby forming the source and drain regions S, D of the silicon substrate. Accordingly, the crystallized first silicon layer 830a and the source and drain regions S, D formed on the first silicon layer 830a are prepared. As such, a semiconductor device is manufactured directly on the plastic substrate using laser, without a transfer process.

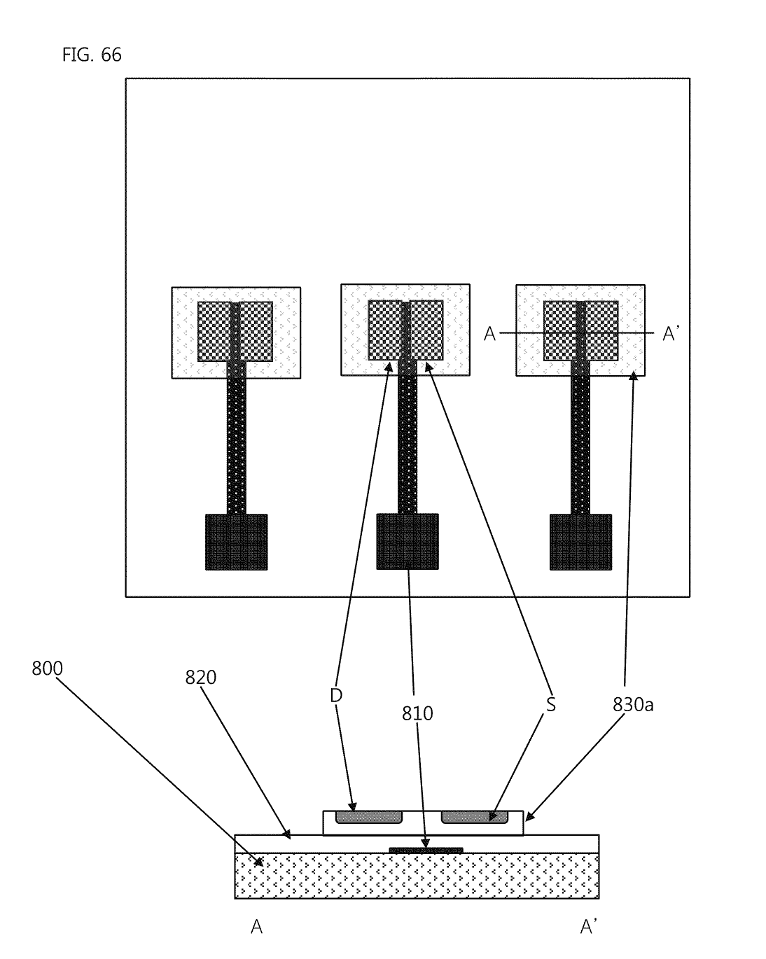

Referring to FIG. 66, the crystallized first silicon layer 830a is patterned and a transistor substrate of a biosensor including the source and drain regions is formed.

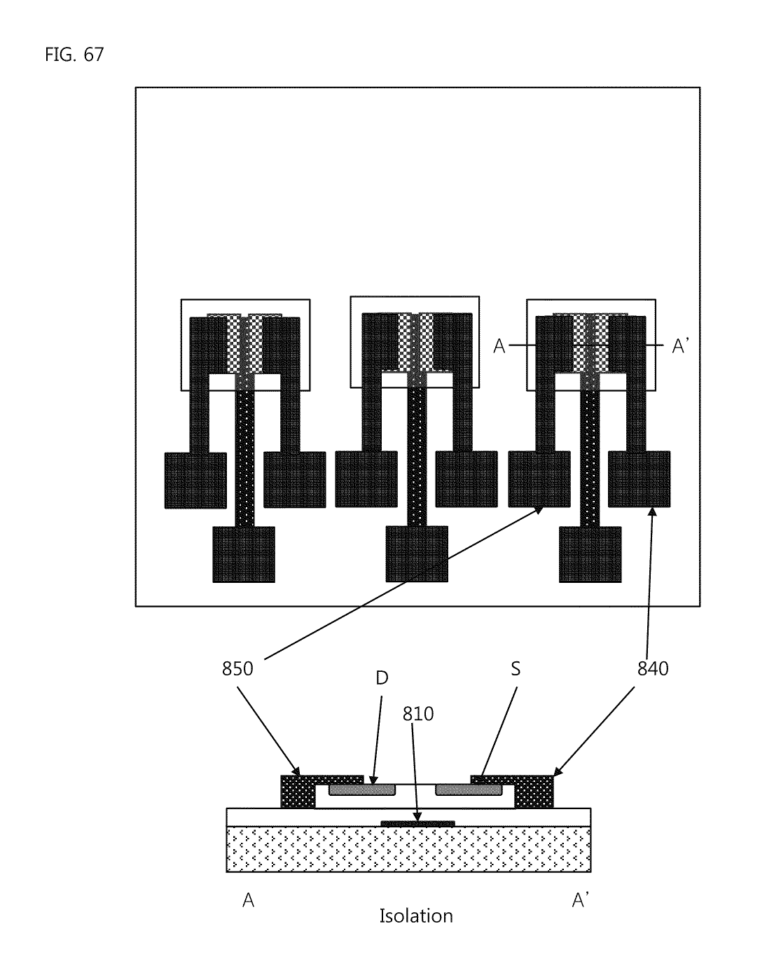

Referring to FIG. 67, source and drain electrodes 840, 850 are formed on the source and drain regions S, D of the first silicon layer 830a. As a result, a transistor device comprising the lower gate electrode and the source and drain electrodes thereabove is completed.

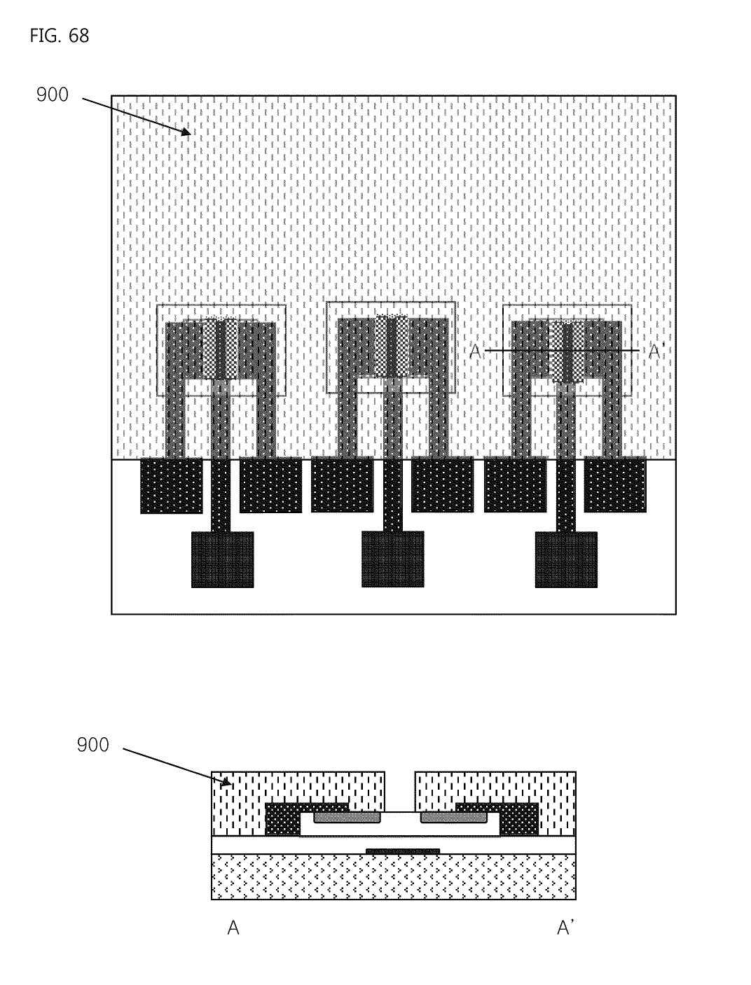

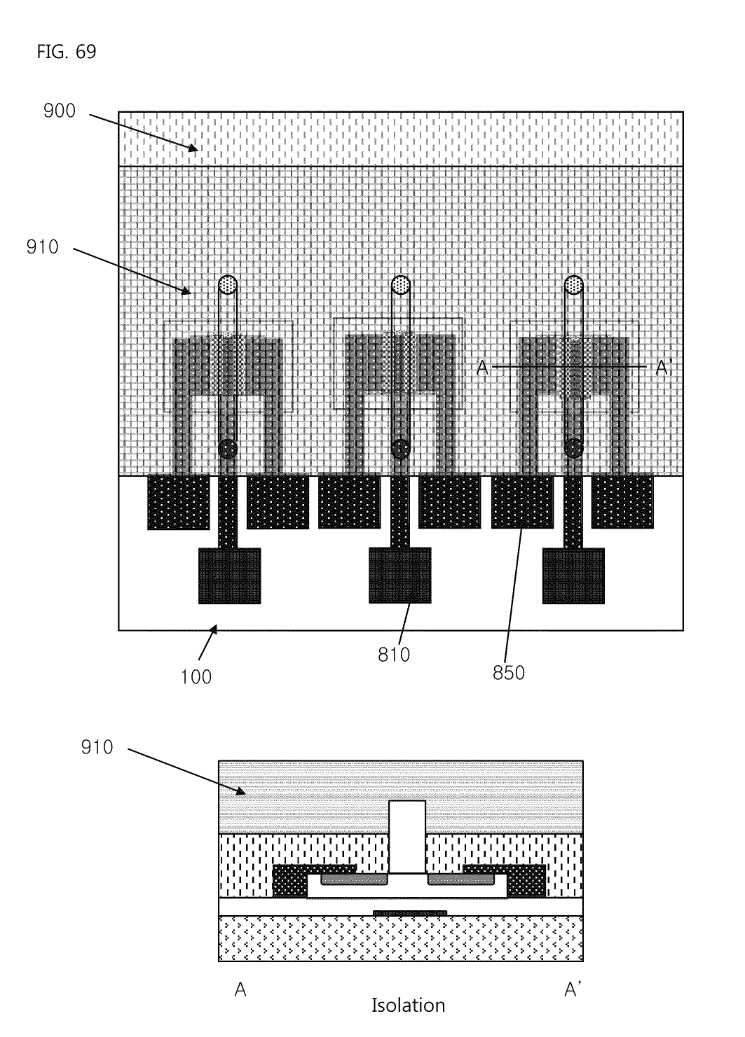

Referring to FIGS. 68 and 69, in order to form a microfluidic channel at the gate region of the silicon substrate of the transistor device, a passivation layer 900 comprising, for example, SU-8 is formed on the silicon substrate. The passivation layer 900 has a trench structure partly exposing only the gate substrate (see FIG. 68). Thereafter, a cover layer 910 comprising a flexible material such as PDMS is formed on the passivation layer 900. As a result, a microfluidic channel which passes through only the gate substrate is prepared. Especially, by forming the passivation layer of, for example, SU-8 first on the silicon substrate, sample leakage from the microfluidic channel may be prevented. The cover layer 910 may be provided with holes to allow introduction and discharge of a sample. According to the present invention, a biologically active substance which binds specifically to the gate region is flown through the microfluidic channel that passes through the gate region of the silicon substrate, such that the detecting substance binds to the gate substrate. To this end, a fused protein formed from fusion of SBP, which binds specifically to silicon, and a target substance is used.

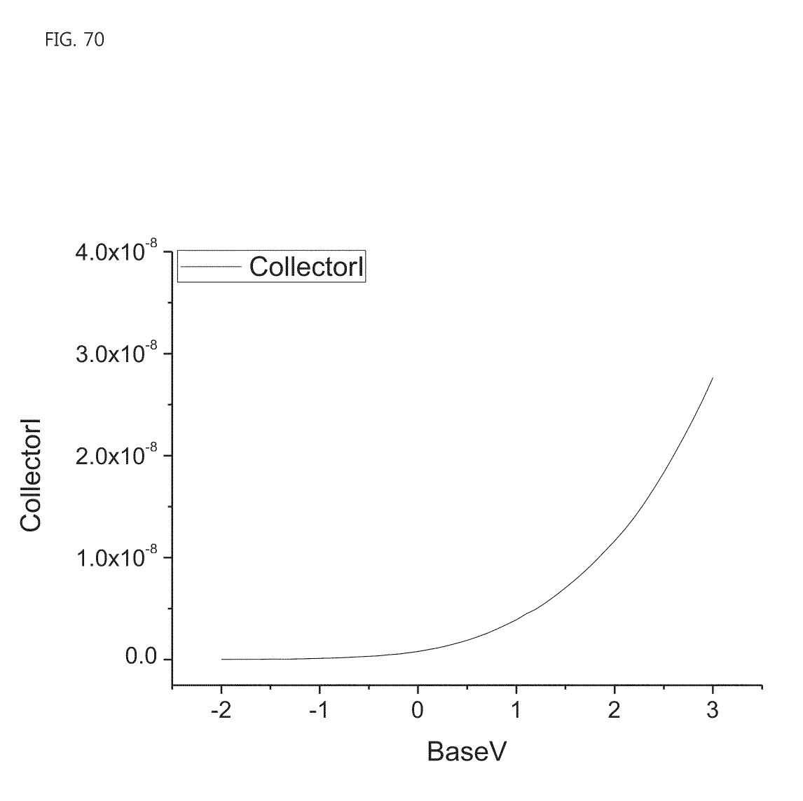

FIG. 70 is a graph showing transistor effect of the biosensor according to the present invention illustrated in FIG. 69.

Referring to FIG. 70, collector current increases as base voltage increases. This reveals that the biosensor manufactured on the plastic substrate according to the present invention exhibits a typical transistor characteristic.

Hereinafter, a method of using the biosensor manufactured according to the present invention will be described in detail.

### Experimental Example 3

Antigen Detection

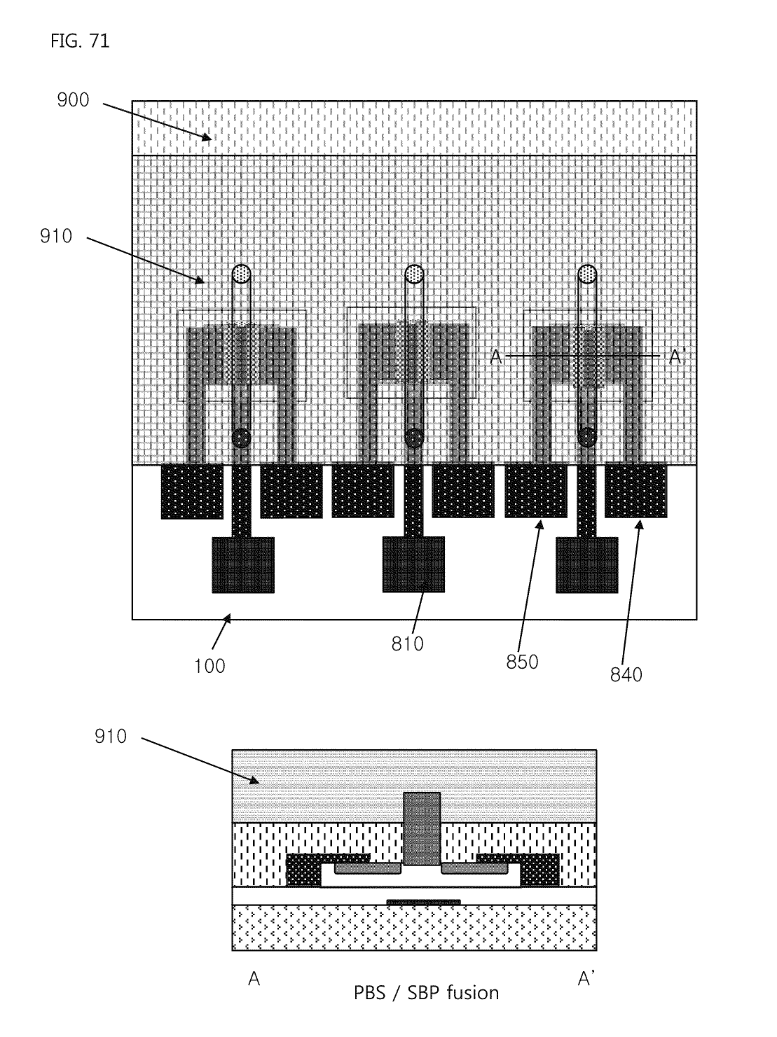

A detecting protein is immobilized by flowing a fused protein of SBP and the detecting protein through the microfluidic channel of the biosensor shown in FIG. 71.

The SBP used in this experiment has the same base sequence and amino acid sequence as in Example 2.

After washing the microfluidic channel by flowing PBS, a fused protein of SBP and antigen (SBP-AIa) is flown. The antigen is H5N1 & H9N2 Avian influenza viral surface antigen and has a sequence H₂N-CRDNWKGSNRPI-COOH. The SBP-antigen fused protein (SBP-AIa) is prepared as follows. A recombinant vector including a gene that encodes SBP and a gene that encodes AIa and designed such that the two genes are expressed in fused form is inserted into E. coli to transform them. The transformed microorganisms are cultured to express the fused protein of SBP andAIa (SBP-AIa). The fusedprotein binds specifically to the gate region of the silicon substrate.

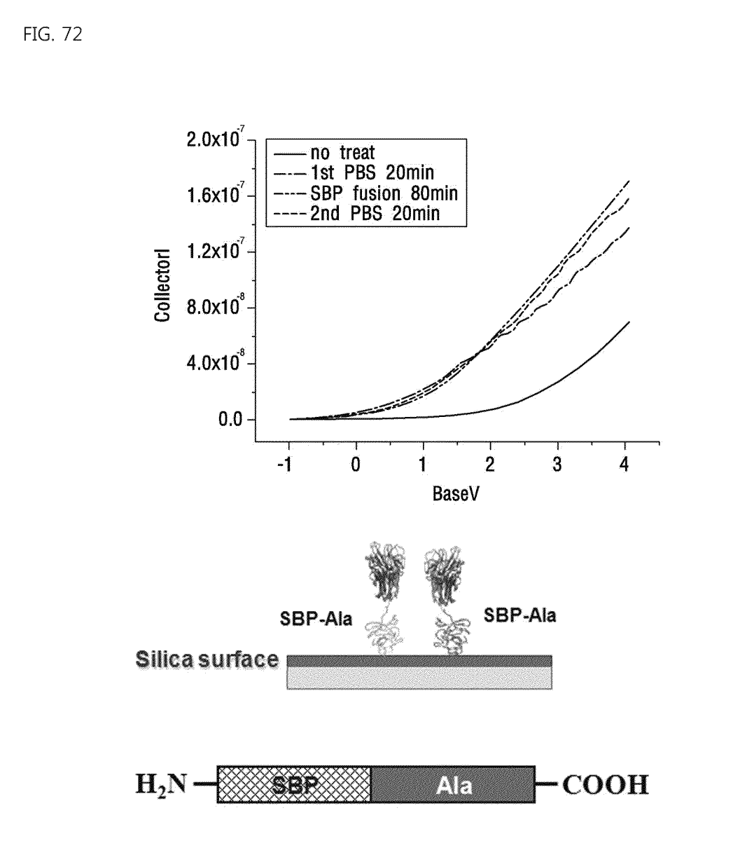

Referring to FIG. 72, current change of the biosensor according to the present invention resulting from the antigen binding is detected.

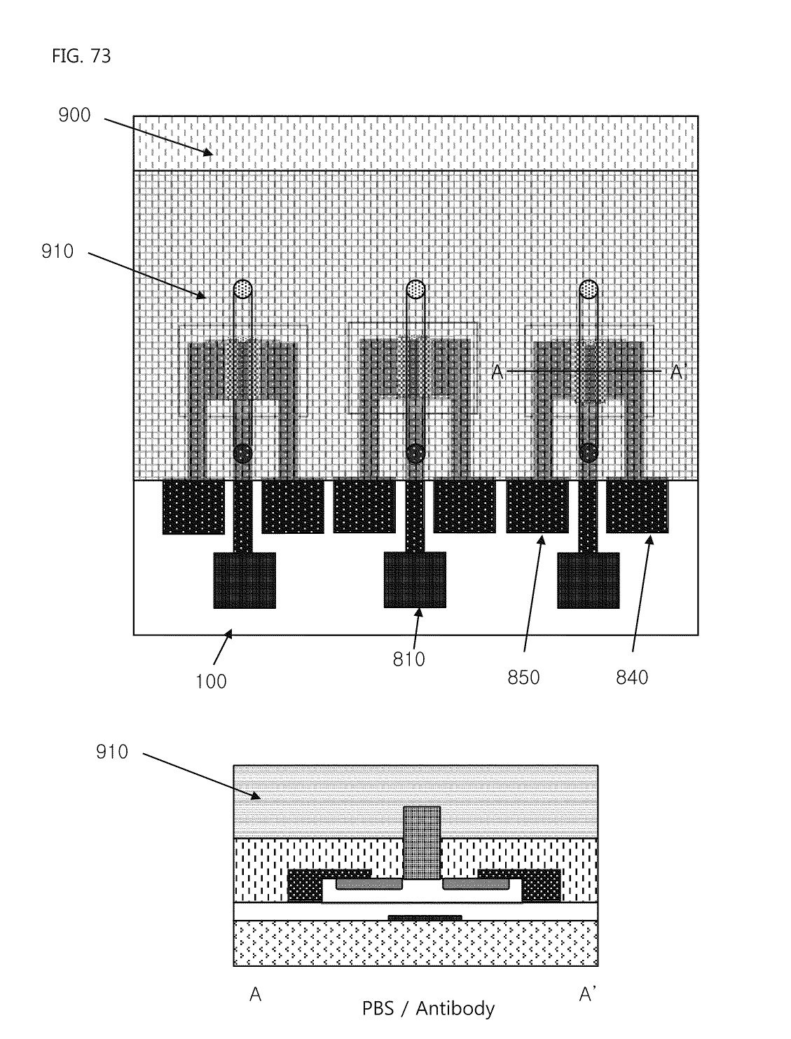

Referring to FIG. 73, when an antibody is flown to the silicon substrate region (gate region) of the biosensor where the antigen is bound, another specific binding occurs between the antigen and the antibody.

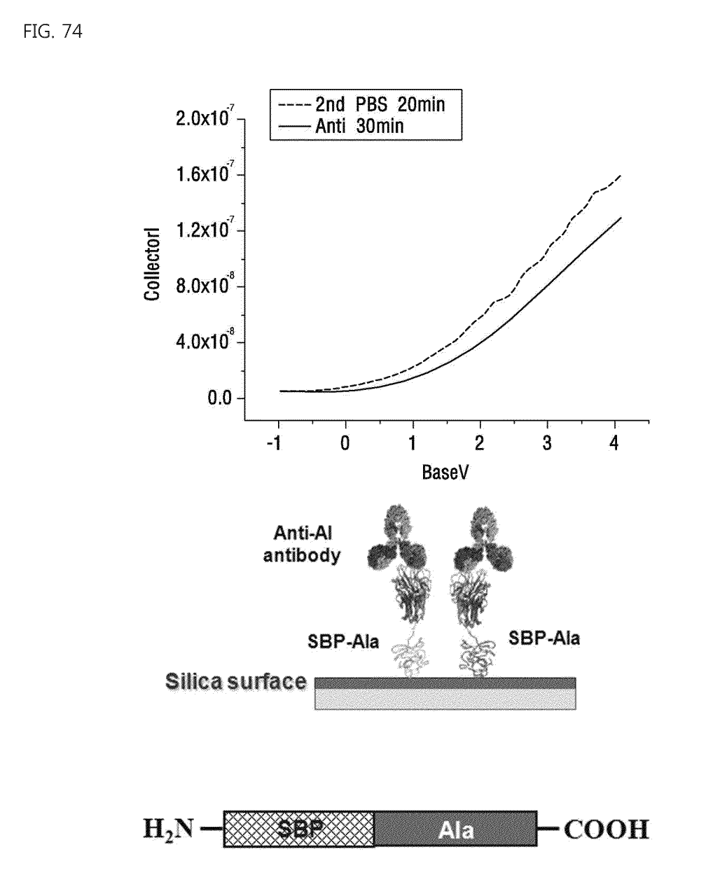

Referring to FIG. 74, change in collector current occurs due to the antigen-antibody binding.

While the present invention has been described with respect to the specific embodiments, it will be apparent to those skilled in the art that various changes and modifications may be made without departing from the spirit and scope of the invention as defined in the following claims.

What is claimed is:

1. A flexible biosensor comprising:
a flexible substrate; and
a biosensor which is provided on the flexible substrate and on which a biologically active substance is immobilized,
wherein the biosensor comprises source, gate and drain electrodes and the biologically active substance is immobilized on the gate electrode.

2. The flexible biosensor according to claim 1, wherein the biosensor comprises:
a flexible substrate;
a silicon substrate formed on the flexible substrate;
source, gate and drain electrodes formed on the silicon substrate; and
a biologically active substance immobilized on the gate electrode,
wherein the silicon substrate is transferred onto the flexible substrate, after source and drain regions corresponding to the source and drain electrodes are formed, and then the source and gate electrodes are formed on the transferred silicon substrate, and the biologically active substance is immobilized on the gate electrode.

3. The flexible biosensor according to claim 1, wherein the biosensor comprises:
a flexible substrate; and
a biosensor pad provided on the flexible substrate,
wherein the biosensor pad comprises a silicon substrate provided on the flexible substrate; source and drain regions which are formed by injecting a p-type or n-type impurity to the silicon substrate and are spaced with a predetermined gap; source and drain electrodes which are respectively connected to the source and drain regions; a gate oxide film and a gate electrode which are formed sequentially on the silicon substrate between the source and drain regions; and a current detecting pad which extends from the source and drain electrodes and detects change of electrical current.

4. The flexible biosensor according to claim 1, which further comprises a flexible polymer layer formed on one or more of the biosensor, wherein the flexible polymer layer is provided with a microfluidic channel, so that a substance to be detected flows to the gate electrode through the microfluidic channel.

5. The flexible biosensor according to claim 4, wherein the flexible polymer layer comprises polydimethylsiloxane (PDMS).

6. The flexible biosensor according to claim 1, wherein the biosensor comprises:
a flexible substrate;
a silicon substrate which is formed on the flexible substrate and on which source and drain regions doped with a first type impurity are formed with a predetermined gap; and
source, drain and gate electrodes which are formed on the silicon substrate and comprise gold,
wherein, on the gate electrode, a fused protein which is formed by fusion with a gold binding substance specifically binding to gold is immobilized.

7. The flexible biosensor according to claim 6, wherein the biosensor comprises:
a flexible substrate;
a silicon substrate which is formed on the flexible substrate;
source, gate and drain electrodes formed on the silicon substrate; and
a biologically active substance immobilized on the gate electrode,
wherein the silicon substrate is transferred onto the flexible substrate, after source and drain regions corresponding to the source and drain electrodes are formed, and then the source, gate and drain electrodes are formed on the transferred silicon substrate, and the biologically active substance is immobilized on the gate electrode which comprises gold, wherein the biologically active substance is a fused protein which is formed by fusion with a gold binding substance specifically binding to gold.

8. The flexible biosensor according to claim 6, wherein the gold binding substance is gold binding protein (GBP).

9. The flexible biosensor according to claim 6, wherein the fused protein is pulverized and then isolated after being expressed in a transformed cell.

10. The flexible biosensor according to claim 6, wherein the biologically active substance is an antibody or an antigen.

11. The flexible biosensor according to claim 6, which further comprises a flexible polymer layer formed on one or more of the biosensor, wherein the flexible polymer layer is provided with a microfluidic channel, so that a substance to be detected flows to the gate electrode through the microfluidic channel.

12. A flexible biosensor comprising:
a flexible lower substrate;
a silicon substrate which is formed on the flexible lower substrate and on which source and drain regions doped with a first type impurity are formed with a predetermined gap; and
source, drain and gate electrodes which are formed on the silicon substrate,
wherein, on the gate electrode, a detecting substance which detects a biologically active substance is immobilized, and the silicon substrate is crystallized with laser.

13. A flexible biosensor comprising:
a flexible lower substrate;
a silicon upper substrate which is in contact with the upper portion of the flexible lower substrate and on which source and drain regions are formed with a predetermined gap; and
a microfluidic channel which passes through the silicon substrate between the source and drain regions,
wherein, on the silicon substrate between the source and drain regions, a detecting substance which detects a biologically active substance is immobilized, and the silicon substrate is crystallized with laser.

14. A method for manufacturing a biosensor using laser, comprising:
forming an amorphous first silicon layer on a flexible substrate;
forming a doping layer doped with a first type impurity on the amorphous first silicon layer;
forming a source and drain region doping layer spaced with a predetermined gap by patterning the doping layer;
crystallizing the first silicon layer by irradiating laser to the first silicon layer and the source and drain region doping layer, and, at the same time, forming source and drain regions on the first silicon layer by diffusing an impurity of the doping layer to the first silicon layer threbelow;
forming a silicon device substrate comprising the source and drain regions by patterning the first silicon layer;
forming a gate oxide layer on the device substrate and exposing the source and drain regions by patterning;
forming a metal layer on the gate oxide layer and forming source, gate and drain electrodes by patterning; and
forming a microfluidic channel which passes through a gate electrode pad that extends from the gate electrode.

15. A method for manufacturing a biosensor using laser, comprising:
forming a lower gate electrode on a flexible substrate;
forming an insulating layer on the lower gate electrode and the flexible substrate;
forming an amorphous first silicon layer on the insulating layer;
forming a doping layer doped with a first type impurity on the amorphous first silicon layer;
forming a source and drain region doping layer spaced with a predetermined gap by patterning the doping layer;
crystallizing the first silicon layer by irradiating laser to the first silicon layer and the source and drain region doping layer, and, at the same time, forming source and drain regions on the first silicon layer by diffusing an impurity of the doping layer to the first silicon layer threbelow;
forming source and drain electrodes on the source and drain regions; and
forming a microfluidic channel which passes through a silicon substrate between the source and drain regions.

16. The method for manufacturing a biosensor using laser according to claim 14, which further comprises: immobilizing a biologically active substance capable of specifically binding to the gate electrode on the gate electrode pad by flowing the biologically active substance through the microfluidic channel that passes through the gate electrode pad.

17. The method for manufacturing a biosensor using laser according to claim 15, which further comprises: immobilizing a biologically active substance capable of specifically binding to the silicon substrate on the silicon substrate by flowing the biologically active substance through the microfluidic channel that passes through the silicon substrate between the source and drain regions.


SEQUENCE LISTING (18 sequences)

SEQ ID NO: 1 - protein, 414 aa, Artificial Sequence
  Description of Artificial Sequence Synthetic polypeptide
AQHDEAQQNAFYQVLNMPNLNADQRNGFIQSLKDDPSQSANVLGEAQKLNDSQAPKADAQQNNFNKDQQSAFYEILNMPNLNEAQRNGFIQSLKDDPSQSTNVLGEAKKLNESQAPKADNNFNKEQQNAFYEILNMPNLNEEQRNGFIQSLKDDPSQSANLLSEAKKLNESQAPKADNKFNKEQQNAFYEILHLPNLNEEQRNGFIQSLKDDPSVSKEILAEAKKLNDAQAPKEEDNKKPGKEDGNKPGKEDGNKPGKEDNKKPGKEDGNKPGKEDNNKPGKEDGNKPGKEDNNKPGKEDGNKPGKEDGNKPGKEDGNGVHVVKPGDTVNDIAKANGTTADKIAADNKLADKNMIKPGQELVVDKKQPANHADANKAQALPETGEENPFIGTTVFGGLSLALGAALLAGRRREL

SEQ ID NO: 2 - protein, 185 aa, Artificial Sequence
  Description of Artificial Sequence Synthetic polypeptide
LKGETTTEAVDAATAEKVFKQYANDNGVDGEWTYDDATKTFTVTEKPEVIDASELTPAVTTYKLVINGKTLKGETTTEAVDAATAEKVFKQYANDNGVDGEWTYDDATKTFTVTEKPEVIDASELTPAVTTYKLVINGKTLKGETTTKAVDAETAEKAFKQYANDNGVDGVWTYDDATKTFTVTE

SEQ ID NO: 3 - protein, 13 aa, Influenza A virus
CRDNWKGSNRPIA

SEQ ID NO: 4 - protein, 14 aa, Artificial Sequence
  Description of Artificial Sequence Synthetic peptide
MHGKTQATSGTIQS

SEQ ID NO: 5 - protein, 41 aa, Artificial Sequence
  Description of Artificial Sequence Synthetic polypeptide
MGKTQATSGTIQSMHGKTQATSGTIQSMHGKTQATSGTIQS

SEQ ID NO: 6 - protein, 21 aa, Artificial Sequence
  Description of Artificial Sequence Synthetic peptide
SKTSLGQSGASLQGSEKLTNG

SEQ ID NO: 7 - DNA, 177 bp, Artificial Sequence
  Description of Artificial Sequence Synthetic polynucleotide
gctatcgttaaatgtaagccgacctccgctggtcgtcgtcacgttgttaaaatcgtgaaccctgaattacataagggtaaaccttacgcacctttattagatactaaatctaaaactggtggtcgtaataatttaggacgtatcactactcgtcatatcggtggtggtcataaacaa

SEQ ID NO: 8 - protein, 59 aa, Artificial Sequence
  Description of Artificial Sequence Synthetic polypeptide
AIVKCKPTSAGRRHVVKIVNPELHKGKPYAPLLDTKSKTGGRNNLGRITTRHIGGGHKQ

SEQ ID NO: 9 - DNA, 210 bp, Artificial Sequence
  Description of Artificial Sequence Synthetic polynucleotide
gtacttggtaaagccggtgccaaccgctggagaggcgttcgccctacagttcgcggtactgcgatgaacccggtagatcacccgcacggtggtggtgaaggtcgtaactttggtaaacacccggtatcaccttggggcgttcaaaccaaaggtaagaaaactcgtcacaacaaacgtaccgataaatatatcgtacgtcgtcgtggcaaa

SEQ ID NO: 10 - protein, 70 aa, Artificial Sequence
  Description of Artificial Sequence Synthetic polypeptide
VLGKAGANRWRGVRPTVRGTAMNPVDHPHGGGEGRNFGKHPVSPWGVQTKGKKTRHNKRTDKYIVRRRGK

SEQ ID NO: 11 - DNA, 396 bp, Artificial Sequence
  Description of Artificial Sequence Synthetic polynucleotide
atggctatcgttaaatgtaagccgacctccgctggtcgtcgtcacgttgttaaaatcgtgaaccctgaattacataagggtaaaccttacgcacctttattagatactaaatctaaaactggtggtcgtaataatttaggacgtatcactactcgtcatatcggtggtggtcataaacaagtcgacgtacttggtaaagccggtgccaaccgctggagaggcgttcgccctacagttcgcggtactgcgatgaacccggtagatcacccgcacggtggtggtgaaggtcgtaactttggtaaacacccggtatcaccttggggcgttcaaaccaaaggtaagaaaactcgtcacaacaaacgtaccgataaatatatcgtacgtcgtcgtggcaaa

SEQ ID NO: 12 - protein, 132 aa, Artificial Sequence
  Description of Artificial Sequence Synthetic polypeptide
MAIVKCKPTSAGRRHVVKIVNPELHKGKPYAPLLDTKSKTGGRNNLGRITTRHIGGGHKQVDVLGKAGANRWRGVRPTVRGTAMNPVDHPHGGGEGRNFGKHPVSPWGVQTKGKKTRHNKRTDKYIVRRRGK

SEQ ID NO: 13 - DNA, 36 bp, Artificial Sequence
  Description of Artificial Sequence Synthetic oligonucleotide
atgagcccacacccgcacccacgtcaccatcacacc

SEQ ID NO: 14 - protein, 12 aa, Artificial Sequence
  Description of Artificial Sequence Synthetic peptide
MSPHPHPRHHHT

SEQ ID NO: 15 - DNA, 36 bp, Artificial Sequence
  Description of Artificial Sequence Synthetic oligonucleotide
aaaccgagccaccaccaccaccacaccggcgcgaac

SEQ ID NO: 16 - protein, 12 aa, Artificial Sequence
  Description of Artificial Sequence Synthetic peptide
KPSHHHHHTGAN

SEQ ID NO: 17 - DNA, 36 bp, Artificial Sequence
  Description of Artificial Sequence Synthetic oligonucleotide
cgtggccgtcgtcgtcgtctgtcttgccgtctgctg

SEQ ID NO: 18 - protein, 12 aa, Artificial Sequence
  Description of Artificial Sequence Synthetic peptide
RGRRRRLSCRLL